(19) United States
(12) Patent Application Publication
(10) Pub. No.: US 2025/0118041 A1
(43) Pub. Date: Apr. 10, 2025

(54) METHODS, SYSTEMS, APPARATUSES, AND DEVICES FOR FACILITATING TAILORING EXPERIENCES OF USERS

(71) Applicant: Mamadou Mande Gueye, Crofton, MD (US)

(72) Inventor: Mamadou Mande Gueye, Crofton, MD (US)

(21) Appl. No.: 18/951,405

(22) Filed: Nov. 18, 2024

Related U.S. Application Data
(63) Continuation-in-part of application No. 17/569,427, filed on Jan. 5, 2022, now Pat. No. 12,169,590.
Application No. 17/569,427 is a continuation-in-part of application No. 15/938,945, filed on Mar. 28, 2018, now abandoned.
Application No. 15/938,945 is a continuation-in-part of application No. 15/713,357, filed on Sep. 22, 2017, now Pat. No. 9,953,091.
(60) Provisional application No. 62/402,401, filed on Sep. 30, 2016.

(51) Int. Cl. G06T 19/20; G06F 3/01

(52) U.S. Cl. CPC G06T 19/20; G06F 3/011

(57) ABSTRACT

Disclosed herein is a method for facilitating tailoring experiences of users, in accordance with some embodiments. Accordingly, the method includes receiving, using a communication device, a data from a device. Further, the method includes analyzing, using a processing device, the data. Further, the method includes determining, using the processing device, a context associated with a user based on the analyzing of the data. Further, the method includes adjusting, using the processing device, at least one of a plurality of reality layers of an artificial environment based on the context. Further, the method includes provisioning, using the processing device, a content corresponding to at least one of the plurality of reality layers of the artificial environment based on the adjusting. Further, the method includes storing, using a storage device, the data and the context.

### FIELD OF THE INVENTION

Generally, the present disclosure relates to the field of data processing. More specifically, the present disclosure relates to methods, systems, apparatuses, and devices for facilitating tailoring experiences of users.

### BACKGROUND OF THE INVENTION

Digital experiences have become predictable and impersonal, offering users little more than static interactions across isolated layers. Despite the rise of AR, VR, and mixed reality, users remain tethered to their devices, engaging with environments that fail to reflect their unique preferences, behaviors, or needs. The lack of real-time adaptation means content is delivered in a one-size-fits-all manner, leaving users disconnected from their digital surroundings.

Further, digital experiences such as targeted advertisements (ads), are the most interpersonal of social media interactions as end users struggle to remain engaged in the static slush of information, and likes have become less rewarding. There's a dearth of dynamic, interactive, personalized content connected to analog reality. This digital stagnation needs to be rendered, lest users find themselves looking forward to targeted advertisements in their timeline.

Despite advances, user connection and content have stagnated to a limited variety of digitally static options. Limited to basic feeds and messaging systems, bots mining users' data, etc. There are technologically limited instances of user interaction with analog reality via AR, all the whilst keeping the end user handcuffed to their mobile device, or other hardware. Thereby stagnating the user experience, and keeping people from interfacing with the system in a manner that is conducive to natural human interaction and physical control. By restricting the user's ability to maneuver around the matrix of internal operations, where the end user is attached to a hardware device, and therefore isolated, simply interacting with a social media program and not networking on an analog and digitally socially interconnected physically dynamic reality based platform.

The many inhibiting factors of current system designs and approaches are keeping people from bridging the space between their technology device and anything else-whether physical, digital, or virtual, therefore they're confined to device-oriented relationships.

Having a relationship with a hardware device is not the same as leveraging the technology to connect the end user to the real world with enhanced augmentations via technology. To better optimize the users' experience, in the real world and the digital world, in real time, a simple invention is required, building in reverse (Analog first digital second Wetware to Software to Hardware).

Existing techniques for facilitating tailoring experiences of users are deficient with regard to several aspects. For instance, current technologies provide experiences that are predictable and impersonal to users. As a result, different technologies are needed to personalize the experiences of the users. Furthermore, current technologies provide content that remains stagnated to users. As a result, different technologies are needed that adapt the content provided to the users.

Therefore, there is a need for improved methods, systems, apparatuses, and devices for facilitating tailoring experiences of users that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating tailoring experiences of users, in accordance with some embodiments. Accordingly, the method may include a step of receiving, using a communication device, at least one data from at least one device. Further, the method may include a step of analyzing, using a processing device, the at least one data. Further, the method may include a step of determining, using the processing device, at least one context associated with at least one user based on the analyzing of the at least one data. Further, the method may include a step of adjusting, using the processing device, at least one of a plurality of reality layers of an artificial environment based on the at least one context. Further, the method may include a step of provisioning, using the processing device, at least one content corresponding to at least one of the plurality of reality layers of the artificial environment based on the adjusting. Further, the method may include a step of storing, using a storage device, the at least one data and the at least one context.

Further disclosed herein is a system for facilitating tailoring experiences of users, in accordance with some embodiments. Accordingly, the system may include a communication device, a processing device, and a storage device. Further, the communication device may be configured for receiving at least one data from at least one device. Further, the processing device may be communicatively coupled with the communication device. Further, the processing device may be configured for analyzing the at least one data. Further, the processing device may be configured for determining at least one context associated with at least one user based on the analyzing of the at least one data. Further, the processing device may be configured for adjusting at least one of a plurality of reality layers of an artificial environment based on the at least one context. Further, the processing device may be configured for provisioning at least one content corresponding to at least one of the plurality of reality layers of the artificial environment based on the adjusting. Further, the storage device may be communicatively coupled with the processing device. Further, the storage device may be configured for storing the at least one data and the at least one context

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a block diagram of a system 300 for facilitating modifying experiential environments based on user preferences, in accordance with some embodiments.

FIG. 4 is a flowchart of a computer implemented method 400 for facilitating modifying environments based on user preferences, in accordance with some embodiments.

FIG. 5 is a flowchart of a computer implemented method 500 for facilitating modifying experiential environments based on user preferences, in accordance with some embodiments.

FIG. 6 is a flowchart of a computer implemented method 600 for facilitating modifying experiential environments based on user preferences, in accordance with some embodiments.

FIG. 7 is a flowchart of a computer implemented method 700 for facilitating modifying experiential environments based on user preferences, in accordance with some embodiments.

FIG. 8 is a flowchart of a computer implemented method 800 for facilitating modifying experiential environments based on user preferences, in accordance with some embodiments.

FIG. 9 is a flowchart of a computer implemented method 900 for facilitating modifying experiential environments based on user preferences, in accordance with some embodiments.

FIG. 10 is a flowchart of a method 1000 for facilitating tailoring experiences of users, in accordance with some embodiments.

FIG. 11 is a flowchart of a method 1100 for facilitating tailoring experiences of users, in accordance with some embodiments.

FIG. 12 is a flowchart of a method 1200 for facilitating tailoring experiences of users, in accordance with some embodiments.

FIG. 13 is a flowchart of a method 1300 for facilitating tailoring experiences of users, in accordance with some embodiments.

FIG. 14 is a block diagram of a system 1400 for facilitating tailoring experiences of users, in accordance with some embodiments.

FIG. 15 is a block diagram of the system 1400, in accordance with some embodiments.

FIG. 16 is a block diagram of the at least one device 1502, in accordance with some embodiments.

FIG. 17 is a block diagram of the at least one device 1502, in accordance with some embodiments.

FIG. 18 is a block diagram of the system 1400, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating tailoring experiences of users, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods, systems, apparatuses, and devices for facilitating tailoring experiences of users.

Further, the facilitating of the tailoring experiences of users may include creating dynamic multi-plane realities.

Further, the present disclosure describes a Celeste Opera for facilitating tailoring experiences of users. Further, the Celeste Opera includes methods and systems for creating dynamic multi-plane realities.

The Celeste Opera system is a comprehensive, adaptive framework designed to create highly personalized and immersive digital experiences by integrating multiple layers of reality: Augmented Reality (AR), Mixed Reality (MR), Virtual Reality (VR), Simulated Reality (SR), and Digital Reality (DR). It leverages real-time data collection, processing, and analysis to align digital interactions with user behavior, preferences, and environmental context. The system's core components include the Behavioral Intelligence (BI), Environmental Intelligence (EI), and Operational Intelligence (OI) subsystems, which collectively analyze biometric, environmental, and physical interaction data. These subsystems are powered by a Neural Processing Unit (NPU) that processes complex, multi dimensional data and a DNA Rating System (DNA-RS) that customizes user experiences based on skill level, engagement, and historical interaction patterns.

The system operates with advanced AI and machine learning (ML) models to adapt and refine user interactions dynamically. Generative AI plays a pivotal role within this adaptive framework, enabling the system to create new, contextually relevant experiences by simulating potential user interactions and predicting outcomes. This capability enhances the personalization process, allowing Celeste Opera to generate tailored content and recommendations that anticipate user needs and maintain engagement. The Layer Synchronization Module (LSM) coordinates these reality layers, ensuring smooth transitions and context-aware adjustments based on real-time feedback and predictive modeling.

The DNA-RS enhances personalization by analyzing user data and applying collaborative filtering and clustering algorithms, supported by generative AI for dynamic content creation, to optimize content and experience complexity. This enables the system to anticipate user needs and provide tailored digital experiences that remain engaging and relevant across various scenarios.

To support real-time adaptability and sustained operations, Celeste Opera integrates with specialized hardware like YAmaker wearables for biometric data collection and Skowl DS drones for environmental scanning, while remaining flexible enough to incorporate existing IoT devices. Network versatility, provided by decentralized nodes such as hypernet and extranet orbs, ensures secure, off grid connectivity and data transfer, allowing the system to function effectively regardless of location. This combination of intelligence subsystems, predictive modeling, generative AI, and hardware flexibility positions Celeste Opera as a robust solution for delivering personalized, multi-layered digital realities that respond seamlessly to user states and environmental conditions.

The Celeste Opera system operates through a six-step method:

Collect Data: The system gathers user and environmental data using biometric sensors, drones, and external inputs. YAmaker captures neural activity, while Skowl DS drones collect environmental metrics.

Analyze the Data: Data is processed by the BI, EI, and OI subsystems connected to the NPU, analyzing cognitive states, emotional feedback, and environmental conditions.

Allocate Data to Machine Learning Layers: Collected and analyzed data are allocated to different ML layers for further processing and adaptation.

Synchronize Layers Based on Input Data: The LSM adjusts reality layers in real-time, creating an adaptive, multi-planed reality tailored to the user's context.

Manage Resources: The system ensures efficient use of energy and processing power, supported by energy harvesting from user movement and robust data handling through decentralized networks (hypernet and extranet).

Refine Experiences: Continuous feedback and user interaction data refine the experience, supported by predictive models and dynamic content adjustments based on the DNA-RS.

A multi-planed reality involves integrating AR, MR, VR, SR, and DR layers to create a seamless, dynamic user experience. Each plane provides a different level of interaction and immersion, managed by the LSM. They can be activated individually, in succession, or simultaneously.

YAmaker is an integrated wearable system that captures real-time biometric data, including brainwave activity, using non-invasive sensors. While it is an ideal hardware integration in the system, existing biometric devices with neural data collection can be used.

Skowl DS drones are equipped with sensors like LIDAR and cameras for environmental scanning. They support EI by providing real-time environmental data, essential for adapting reality layers. However, the system can integrate with any drone that can provide EI data and support feedback loops.

Further, the behavioral intelligence, environmental intelligence, and operational intelligence subsystems are NPU subsystems that are components. Further, BI processes emotional and cognitive data using inputs like EEG, HRV, and GSR. Further, EI uses external sensors and data feeds to understand and adapt to environmental conditions. Further, OI monitors user physical interactions. All these are connected to the NPU, facilitating real-time data processing and feedback.

Further, the BI subsystem conducts:
EEG signal analysis for cognitive load and emotional states, using frequency pattern analysis to assess focus and stress.
HRV analysis for stress detection, calculating heartbeat interval variations to gauge autonomic responses.
GSR and facial recognition to gauge emotional arousal, with GSR measuring skin conductance and facial recognition interpreting micro-expressions.
Voice analysis for tonal shifts, using NLP and modulation algorithms to detect mood changes through speech patterns.

The DNA-RS customizes user experiences by evaluating:
Skill levels (e.g., belt rankings) to match content difficulty with user proficiency.
User engagement (e.g., RYG feedback scores) to assess interaction quality and satisfaction.
The DNA-RS applies collaborative filtering and clustering algorithms to analyze user behavior, predict preferences, and adjust content complexity for an optimal experience. The BI collects real-time emotional and cognitive data, while the DNA-RS aggregates it with interaction history, creating profiles that include behavior trends, performance metrics, and preferences.

The Celeste Opera system incorporates existing collaborative filtering and clustering algorithms but enhances them with proprietary adaptations. These modifications align with the system's multi-planed reality operations and real-time user interaction data processing. The integration of generative AI within these algorithms enables the system to create new, adaptive content experiences dynamically. By using generative models, the system simulates potential user preferences and interactions, allowing for real-time adjustments to user experiences. This provides a layer of personalization that extends beyond traditional collaborative filtering.

A reality layer is a distinct digital environment or overlay, such as Augmented Reality (AR), Mixed Reality (MR), Virtual Reality (VR), Simulated Reality (SR), or Digital Reality (DR), that interacts with the user. Each layer offers different levels of immersion and interaction.

Adjustment Mechanism for the reality layer: Adjustments to these layers are managed by the Layer Synchronization Module (LSM). This module leverages inputs from the BI, EI, and OI subsystems, as well as predictive outputs from machine learning (ML) layers and generative AI models. The LSM integrates a multi-dimensional feedback loop that incorporates real-time biometric, environmental, and behavioral data. It uses generative AI to project potential outcomes and adjust the reality layers accordingly. This allows the system to create adaptive, predictive environments that align with user behavior, preferences, and environmental factors. It coordinates the activation, overlap, and intensity of AR, MR, VR, SR, and DR layers, ensuring that each plane aligns seamlessly with the user's current environment and cognitive-emotional state. The LSM uses dynamic context-switching logic to shi between layers as needed, enhancing the user experience through real-time adaptability. The LSM integrates a multi-threaded processing architecture, enabling the Celeste Opera system to make simultaneous adjustments to multiple layers without latency. This ensures a synchronized, fluid transition between digital realities.

Energy harvesting in the Celeste Opera system involves collecting electrical energy generated by physical movement or body heat, which is then stored in specialized wearables like HiSS. These wearables utilize piezoelectric materials or thermoelectric generators that convert kine c or thermal energy into electrical energy. The Energy Harvesting Module in the Celeste Opera system utilizes adaptive power distribution algorithms to manage collected energy. These algorithms optimize energy usage across wearable devices like HiSS by priori zing power allocation based on real-time processing needs and data transmission requirements. The system can intelligently balance energy reserves to maintain continuous biometric monitoring and data feedback without interruption. This ensures that the wearables can sustain power during extended periods of use, even in low-energy environments. It is designed to seamlessly integrate with real-time data collection and processing. The system ensures that wearable devices remain powered and capable of transmitting data to support continuous interaction with the NPU, BI, EI, and OI subsystems. The use of adaptive power distribution algorithms that balance energy consumption across the network and wearables adds to the technical uniqueness of the system. This ensures sustained operation even in energy-limited environments, enhancing the reliability of the multi-planed reality experience.

Quantum Flash employs quantum entanglement principles to enable ultra-fast data exchange across different nodes of the system.

Transmission method associated with the Quantum Flash:
The method works by encoding data onto a set of entangled particles. When a change is made to one particle, its entangled counterpart instantaneously reflects the change, allowing for low-latency communication across the system's network, including OrbTech nodes like Extranet and Intranet Orbs.
The integration of Quantum Flash ensures that data can be transmitted and processed without the typical latency found in classical data networks. This supports real-time adjustments and synchronization across multiple reality layers, which is essential for maintaining the seamless operation of adaptive user experiences.
The ability to handle vast amounts of data with quantum-level speed enables the system to deliver complex, generative AI-driven experiences efficiently. This adds a significant technical edge to the Celeste Opera system, ensuring smooth, synchronized interactions even during high data transfer demands.

Quantum Cloud:
Data Handling: The Quantum Cloud within the Celeste Opera system acts as a large-scale data processing unit that leverages quantum computation for fast data scraping and aggregation. It processes extensive amounts of user and environmental data, applying quantum algorithms to analyze and format this data efficiently. The results are then relayed back to the classical internet infrastructure, where they can be transmitted to users over standard connections.
Integration with Classical Systems: The Quantum Cloud acts as an intermediary, handling complex data calculations and ensuring that information is formatted appropriately before it reaches traditional network channels. This process minimizes data transfer times and optimizes the system's ability to deliver personalized content and interactions promptly.

Data Allocation and Processing: initial analysis prepares data for deeper ML layer processing. User objectives are derived from continuous profiling by BI and DNA-RS.

Synchronization: Simulated Reality (SR) replicates real-world scenarios for immersive training and interaction. The layers include AR, MR, VR, SR, and DR, which can be activated simultaneously, sequentially, or individually, and adjusted by the LSM. They are aligned using the EI subsystem and real-time inputs processed by the LSM.

Resource Management: Resource management supports real-time data flow and operational efficiency, vital for maintaining continuous and adaptive interactions. The hypernet and extranet are decentralized data nodes within the system that facilitate robust, off-grid connectivity and secure data transmission. The hypernet serves as a network infrastructure that supports seamless real-time data synchronization and communication, especially in remote or disconnected environments. The extranet, on the other hand, allows controlled access for external users or systems, enabling secure data exchange and collaboration between internal nodes and authorized external parties. Both components contribute to maintaining system functionality, enhancing data security, and ensuring efficient connectivity across diverse operational contexts.

Refinement:
User interactions and feedback refine experiences. The system leverages predictive models and the DNA-RS for necessary adjustments.
This refinement process involves adapting content, interaction complexity, and reality layer adjustments to align with the user's evolving needs and preferences.
The system utilizes predictive models to anticipate user behavior and the DNA-RS to analyze engagement data and skill levels. This combination allows the system to make informed, real-time adjustments, ensuring that the user experience remains personalized and relevant.
The system identifies what to adjust by monitoring biometric data, user input, and historical interaction patterns, using this information to tailor the experience accordingly.

The Celeste Opera system is a robust method for creating adaptable, immersive experiences across multiple planes of digital reality. The system's core functions rely on real-time data collection, processing by specialized intelligence subsystems, and dynamic adjustments facilitated by the Layer Synchronization Module. While YAmaker and Skowl DS drones are ideal integrations, similar technologies can replace them, provided they deliver real-time data transfer to support EI and OI.

The Celeste Opera system may be Imagined as a system that adjusts digital experiences, like VR and AR, to match how an individual feels, what the individual does, and where the individual is. It uses smart tech, like sensors and drones, to understand and react to the individual's needs in real-time, creating a highly personalized and engaging digital world. This system works seamlessly everywhere due to its network flexibility, allowing it to operate even in remote or disconnected environments through its robust decentralized data nodes.

Major System Components:
Celeste Opera System: An advanced framework designed to integrate and synchronize multiple reality layers (AR, MR, VR, SR, DR) to create dynamic, personalized user experiences.
Layer Synchronization Module (LSM): Coordinates and adjusts reality layers in real-time based on user feedback and environmental inputs.
Onyx Panther OS: Manages integration across hardware and software components within the system, utilizing both quantum and classical processing for resource management and data flow.
Neural Processing Unit (NPU): Specialized processing unit that handles neural, biometric, and environmental data, enabling real-time adjustments and machine learning operations for adaptive user interactions.
Behavioral Intelligence (BI): A subsystem that analyzes cognitive and emotional states using biometric data (e.g., EEG, HRV, GSR, facial recognition, and voice analysis) to adjust user experiences.
Environmental Intelligence (EI): Subsystem that collects and processes environmental data (e.g., temperature, lighting, terrain) to adapt reality layers to physical surroundings and enhance user interaction.
Operational Intelligence (OI): A subsystem that monitors and interprets physical interactions and biomechanical data to provide feedback and adjust user experiences, integrating data with BI and EI for a comprehensive feedback loop.
DNA Rating System (DNA-RS): Personalization component that evaluates user data to rate skill levels, preferences, and interaction history, using collaborative filtering and clustering algorithms for content customization.
Machine Learning (ML) Layers: Data processing layers that use predictive models to analyze and adapt user experiences, including algorithms like recurrent neural networks (RNNs) and long short-term memory (LSTM) networks.
Quantum Flash: Technology using quantum entanglement for instantaneous data transmission across system nodes, ensuring high-speed, low-latency data transfer. A data transmission technology that leverages quantum entanglement to enable ultra-fast data communication between system nodes; and transmits data instantaneously across different parts of the system using entangled particles. Changes in one particle reflect in its entangled counterpart, enabling low latency data transfer supported by the Quantum Cloud.
Quantum Cloud: The Quantum Flash mechanism is supported by the Quantum Cloud, which handles large-scale data aggregation and processing. This quantum-powered infrastructure performs massive data scrapes, processes the data, and then feeds it back into classical internet frameworks for user consumption via conventional internet connections.

Reality Layers:
Augmented Reality (AR): A reality layer that overlays digital elements onto the real world, enhancing the user's physical environment with computer-generated sensory input.
Mixed Reality (MR): A reality layer that blends AR and VR to allow physical and digital elements to coexist and interact seamlessly.
Virtual Reality (VR): A fully immersive reality layer that places users in a completely computer generated environment.
Simulated Reality (SR): A reality layer designed to replicate real-world scenarios with high fidelity for training, exploration, or interactive simulations using generative reality frameworks.
Digital Reality (DR): A digital environment that users interact with via screens, providing a non immersive experience without augmented or virtual elements.

Supporting Hardware Components:
YAmaker: Ideal hardware integration for capturing real-time neural and physiological data, such as brainwaves, heart rate variability, and muscle activity, through non-invasive wearables.
Skowl DS Drones: Aerial drones equipped with sensors like LIDAR and thermal imaging to collect real-time environmental data and provide geospatial mapping, contributing to the data flow for EI and OI.
HiSS Wearables: Energy-harvesting wearables that store energy generated from body movement, contributing to the sustainability of the system.
Vicci Wear: Advanced wearable technology designed to monitor and collect biometric data, including neural activity, heart rate, and muscle tension, integrating seamlessly with the Celeste Opera system to enhance BI, EI, and OI functionalities.

Connectivity and Data Components:
Hypernet: Decentralized network node that supports data synchronization and real-time data handling for off-grid operations.
Extranet Orbs: Components of the OrbTech system that facilitate remote data storage and secure communication between external users and system nodes, connecting off-site users and enabling data exchange beyond an internal network.
Intranet Orbs: Nodes within the OrbTech system that support internal data flow and communications, maintaining data within a controlled, private network, facilitating secure data handling and resource management within the system's local infrastructure.
OrbTech Nodes: Collective decentralized data nodes, including Extranet Orbs, Hypernet Orbs, and Intranet Orbs, providing connectivity and data management.

Minor and Subcomponents:
Contextual Predictive Modeling (CPM): Model that aids in predicting user behavior and adjusting experiences based on contextual data.
Dynamic Layer Adjustment (DLA): Subcomponent responsible for adjusting the intensity and interaction level of each reality layer in real-time.
Facial Recognition System: Part of the BI subsystem that reads micro-expressions to assess emotional state and influence the user experience.
Voice Analysis Module: Analyzes voice tone to detect changes in emotion, aiding in adaptive responses by the system.
Energy Harvesting Module: Collects kinetic energy from user movement and transfers it to wearables like HiSS for power sustainability.
Biometric Sensors: Embedded within wearables like YAmaker and Vicci Wear, these sensors capture neural, physiological, and biomechanical data for real-time analysis by BI, OI, and EI subsystems.
Galvanic Skin Response (GSR) Sensors: Used within the BI subsystem to measure skin conductance for assessing emotional arousal.
Heart Rate Variability (HRV) Analysis Module: Component within BI that interprets HRV data to infer stress levels and autonomic nervous system activity.
EEG Signal Processor: Processor within the BI subsystem that interprets brainwave activity to determine cognitive states like focus and relaxation.
Predictive Notification System: Part of the ML layers that provide anticipatory feedback and prompts to adjust the user's interaction based on predicted needs.
User Profile Database: Stores comprehensive user data, including preferences, skill levels, interaction history, and behavioral trends for personalization.
Feedback Loop Mechanism: Continuous feedback system that refines experiences based on user interaction data and environmental feedback, integrating BI, EI, and OI insights.
Adaptive AI Models: Advanced algorithms that utilize BI, EI, OI, and DNA-RS inputs to predict and adapt user interactions in real-time.
Training Scenario Module: Component for adapting training simulations based on user feedback, biometric data, Generative AI outputs, and environmental conditions to provide optimized learning and performance experiences.

Narrative and Interaction Components:
Dogon LARP Engine: A narrative engine that personalizes storylines in real-time, creating immersive and interactive storytelling experiences; Uses generative AI and Generative Adversarial Networks (GANs) to simulate and generate adaptive storylines and character interactions that respond to user behavior and choices, making the narrative dynamic and engaging.
Atomic Planner: Manages and sequences task trails (missions) and adapts them based on user progress and environmental changes; integrates generative AI for dynamic reconfiguration of tasks and objectives, ensuring personalized and context-aware mission planning.
VRAiT System: Real-time adaptive training module that tailors training or guidance scenarios based on user data, environmental context, and system feedback; incorporates generative AI to adjust exercises, tasks, or interactions for optimized user performance, making each training scenario unique and personalized.

Further, the present disclosure describes Celeste Opera method for creating dynamic multi-plane realities:
1. Data Collection (aka Gathering: Sensors, Wearables, User Activity): Real-time data collection from biometric, environmental, and physical activity sensors and wearables:
   Biometric data: Heart rate, neural activity (via YAmaker), skin conductivity.
   Environmental data: Temperature, light, location (via Skowl, Bots).
   Physical activity data: User movements (e.g., HiSS, Vicci Wear, Wristlet).
   The Neural Processing Unit (NPU) acts as the pre-processing hub, organizing data and sending it to Behavioral Intelligence (BI), Environmental Intelligence (EI), and Operational Intelligence (OI) subsystems based on data type.
2. Data Analysis and Bucketing (aka Considerations: User Preferences, Current Environment, Simulation Demands)
   Behavioral Intelligence (BI): Analyzes emotional and cognitive states through biometric feedback, supported by the DNA Rating System (DNA-RS) to create long-term user profiles. The system utilizes Collaborative Filtering and Clustering Algorithms (e.g., K-Means) for personalized content suggestions based on user behavior.
   Environmental Intelligence (EI): Adjusts reality layers based on real-time environmental inputs (e.g., temperature, light, location).
   Operational Intelligence (OI): Captures and processes physical movements for virtual actions and energy harvesting.
   Quantum Flash Transmission allows instant data retrieval from the Celeste Quantum Database (CQDB) for real-time adaptation.
3. Data Allocation to Machine Learning (ML) Layers for Processing (aka Calculating/Mapping: Objective, Situation, Persona/Preferences/Predictions):
   Objective Identification: ML layers process user objectives (e.g., trails, nodes, collaboration, training). The system leverages Recurrent Neural Networks (RNNs) and Long Short-Term Memory (LSTM) models to analyze and predict user behavior based on sequential data, improving experience adaptation.
   Predictive AI Modelling: Anticipates user needs based on real-time data and adjusts experiences preemptively (e.g., Atomic Planner). Reinforcement Learning (RL) is applied to continuously optimize predictions based on user feedback and behavior.
   The NPU coordinates the allocation of processed data, ensuring system responsiveness based on preferences and environmental conditions.
4. Layer Synchronization Based on Input Data (aka Multi-layered Reality):
   The Layer Synchronization Module (LSM) aligns reality layers (AR, MR, VR, DR, SR) with the user's environment in real time and predictively using Contextual Predictive Modelling (CPM).
   Cross-layer and Combined-layer Interaction: Ensures coherence and seamless transitions between layers, using Dynamic Layer Adjustment (DLA) powered by Convolutional Neural Networks (CNNs) and Graph Neural Networks (GNNs) to manage visual and relational data, such as AR influencing VR or SR.
5. Data Synchronization and Resource Management (aka Balancing Requirements: Data, Energy, Network Availability, Bandwidth, User Capacity/Biometric Indicators): The system manages data flow and energy consumption using Onyx Panther OS, dynamically switching between networks (e.g., Extranet to Hypernet) based on location and data requirements.
   Data Flow and Resource Allocation: The system manages data flow and energy consumption using Onyx Panther OS, optimizing for user needs while balancing network bandwidth, processing power, and user biometric capacity.
   Energy Harvesting: The Operational Intelligence (OI) subsystem optimizes energy harvested from kinetic activities, such as user movements (e.g., HiSS, Vicci Wear). Wearables equipped with energy-harvesting technologies contribute to sustaining prolonged operations.
   Network Adjustments: The system switches between different networks (e.g., Extranet to Hypernet) based on location, data requirements, and bandwidth availability, ensuring smooth transitions and efficient connectivity across environments.
6. Continuous Feedback and Refinement Loop (aka Refinement Based on Real-time Data):
   The system uses a real-time feedback loop, continuously adapting to user behavior, environmental changes, preferences, and simulation demands:
   Predictive AI and Refinement: The system anticipates future challenges and dynamically adjusts experiences based on real-time data using Reinforcement Learning (RL) and Bayesian Networks for probabilistic decision-making.
   Collaborative Refinement: In multi-user environments, the system synchronizes team based experiences, optimizing group performance through real-time adjustments using shared data.

Further, the present disclosure describes Celeste Opera, method and system for creating dynamic multi-plane realities. Further, the Celeste Opera system introduces a new era of personalized, Dynamic Multiplane Realities. Whereby, Celeste Opera seamlessly integrates physical and digital environments, adapting in real time to each user's actions, preferences, and biometric data. It delivers a deeply personalized experience, where every element-whether virtual, augmented, or physical—is customized to the individual; moreover, historical data personalization is not limited to the user's data or decisions but also utilizes persistent data tethering of location, topic, or group decisions to further educate the system's customization. Through advanced quantum processing and AI-driven modules, the system creates a reality that evolves with the user, offering a level of immersion and interaction that goes beyond anything current platforms can provide; whether the user is shopping in Paris, exploring Dogon Plateau, mapping new forest trails in the Appalachians, training for disaster response, etc., the Celeste Opera system can provide.

Furthermore, the OrbTech ensures that the system is always obtainable-unlike the connectivity we are currently allotted, allowing for system availability, hypernet access, and data sharing between extranet orbs and the rest of the network. With the Celeste Opera, the digital world becomes as unique as the user navigating it.
E.g.
Initializing . . .
A soft hum vibrated through the darkness. The Candidate's system stirred to life—Onyx Panther OS syncing. His body, still motionless, registered the connection. The VRAiT system audible in his ear: “Candidate 325: Vitals: Normal, Suit Integrity: 98%, Power Levels: Optimal”
The Candidate's eyes flickered open, met with a flood of digital overlays. The HUD coming online, flashing familiar symbols across his vision. Vitals, status, . . . He blinked once, and the feed expanded. XP: 10,987
Belt Level: Saphire
The desert stretched out before him-bleak, endless sand, littered with debris of the old junk yard. His HUD began parsing the landscape, feeding him real-time data.
Temperature: 44° C.
Wind Speed: 12 kph
Terrain: Unstable
The world came into sharper focus as the environmental recognition kicked in with icons and colourful indicia, visually mapping the wreckage of an old transport vehicle to his left and a high ridge beyond. As the Candidate looked around, the Celeste Opera System continued to tag possible points of interest, marking obstacles and potential paths.
A soft pulse appeared in his HUD—mission objective identified. The Candidate touched his ring to select the objective.
Objective Activated: Link up with Team Echo.
The trail blinked into view, a faint glowing line on the ground leading toward the horizon.
His body responded instinctively, the Vicci exosuit matching his movement with effortless precision as he began up the trail towards the iconic indicator for Echo's FOB.

Further, the Celeste Opera includes the Onyx Panther OS for Centralized Orchestration and Quantum Integration. The Onyx Panther OS is the command center of the Celeste Opera system, managing the seamless integration between hardware, software, and network elements; working as state management of the Celeste Opera system. It ensures that digital, augmented, mixed, virtual, and simulated reality layers—collectively forming the multi-plane reality—remain synchronized with the physical world, adapting in real-time to user actions and environmental changes. This system enables personalized experiences, adjusting digital layers based on user behavior, environmental feedback, and biometric data.
Onyx Panther Quantum-Enhanced Serverless Control
   The Onyx Panther OS dynamically shifts between classical and quantum processing modes to optimize resource allocation. For high-complexity tasks, such as collaborative VR training or live tactical simulations, it activates Hyper-net Orbs to leverage quantum entanglement for ultra-low latency communication. This ensures that VRAiT (Virtual Reality AI Trainer) modules and Dogon LARP Engine narratives remain smooth, even when multiple users engage simultaneously.
   By integrating quantum flash transmission with the Celeste Quantum DB, the OS allows for rapid retrieval of user-specific/specified data and formulation into actionable trails with the Atomic Planner, further advised by the persistent data tethering. This capability is crucial for adapting digital narratives and interaction layers for personalized experiences and tailored immersions, further advised by the DNA-RS (DNA Rating System) which indicates user preferences and parameters.
Onyx Panther Energy Optimization for Sustained Operations
   Energy efficiency is vital for maintaining the Celeste Opera system across various environments. The Onyx Panther OS oversees energy distribution as well as system commands. As users move through physical spaces, their activity generates power, which can be stored in the silver nitrate batteries in the wearables, and then allocated to key system functions like biometric data collection and haptic feedback.
   This management is particularly critical in off-grid scenarios where Extranet Orbs and autonomous bots need to maintain data continuity. By dynamically shifting power to sustain core data relays, the OS ensures that Skowl DS drones and Recon Bots remain functional, enabling ongoing environmental mapping and data synchronization with the ML Layer.
Onyx Panther Centralized Coordination Across Reality Layers
   The Onyx Panther OS functions as the central coordinator for the Layer Synchronization Module (LSM), which manages the transitions and alignment between AR, MR, VR, SR, and even Digital Reality (DR)—a mode that operates without external augmentation. DR ensures that users can still interact with digital content on conventional screens, maintaining access to mission-critical data and training modules when AR/MR/VR layers are unavailable.
   This versatility is key to achieving the system's overarching goal: providing users with uninterrupted, adaptive experiences that adjust to their needs. Whether through holographic overlays in AR, or data-rich simulations in VR, or even through standard digital interfaces in DR, the Onyx Panther OS ensures that users continue to progress toward their objectives.
Onyx Panther Systemic Intelligence and Real-Time Adaptation
   The Onyx Panther OS continuously processes input from AI Core and Behavioral Intelligence (BI), dynamically adjusting system responses. When YAmaker detects increased stress levels during a training session, the DLA (Dynamic Layer Adjustment) can be triggered by the OS to transition the user from a high-intensity VR mission to a strategic AR overview, optimizing the user experience while maintaining narrative engagement via the Dogon LARP Engine.
   This real-time adaptability is made possible through quantum-enhanced data flow facilitated by Hyper-net Orbs. By enabling instantaneous synchronization between user inputs and system adjustments, the Onyx Panther OS ensures that all elements of the Celeste Opera system work together seamlessly. This makes the Celeste Opera not just a network of advanced technologies but a cohesive ecosystem capable of delivering responsive, immersive multi-plane experiences.
E.g.
The Candidate followed the trail, the faint line on his HUD leading toward the FOB on the horizon. He could see the layers of data in his HUD as the Onyx Panther OS continued to manage the seamless integration between his Vicci exosuit, the network, and the environment. As he neared the FOB, the world around him adjusted-a fusion of physical and augmented layers flowing together, he was prompted to sync with the base's network.
Candidate 325 connecting with Echo's network, Onyx Panther OS ran the sync and a series of iconic and color indicia began appearing and disappearing from his HUD indicating success and sync.
Connection Established. Team Echo: Synced.
Objective: Status Check.
The Candidate activated the objective and the Onyx Panther OS retrieved and fed him real-time data from the FOB. Progress bars appeared on his HUD, tracking the completion of various tasks:
Solar Array Setup: 78% Complete
Water Recovery System: 65% Functional
Battery Reserves: Charging
Network: Local Active (10 mr) . . .
he scrolled through the full update of FOB status's.
As he entered the camp, two figures were bent over a solar panel, their exosuits adjusting as they worked. The HUD tagged them with identification markers—Private Dalton, silver and Sergeant Reyes, platinum. Their hands moved with mechanical precision, following a visual guide visible only to them through their HUDs, and haptic feedback guiding their hands as they secured the solar panels.
Dalton glanced up, nodding to the Candidate. “You made it. We're almost done here. That buggy, though . . . it's a mess. We're missing a few parts to get it moving. Nothing from HQ.”
The Candidate turned to his left, his HUD highlighted the buggy, parked at the edge of the FOB, its status displayed in a glaring red:
Buggy: Non-Operational.
He touched his ring again, selecting the buggy; sync: The Onyx Panther OS synced with the vehicle's diagnostics, pulling up a list of missing parts and damage reports, the Candidate tapped his wrist and the Onyx Panther OS pulled the reports from the diagnostics; displaying the visual hologram projected from the Candidates wristlet. Nodding slightly, the candidate navigated to the FOB's inventory and called a carrier bot; the Onyx Panther OS activated the selected bot and delivered the parts list, instructions, and the trail to navigate to the junk yard. Pushing a trail back to the Candidate's HUD, he activated it and turned to begin walking back to the junk yard with the bot to find the pieces.
But before he left, one of the Echo team tossed him a small object—a faintly glowing Extranet Orb.
“Found this locked at Amethyst level,” Dalton said. “None of us can open it.”
The Candidate caught it, the orb lighting up as it registered his belt level—Sapphire. He pressed his hand to the surface. The orb unlocked, quickly unloading a list of data to the Candidate's HUD: revealing a collection of documents and valuable data, in the list was a blueprint that he sent over to the two engineers through the Onyx Panther OS team sync.
Orb Unlocked: FEMA Pyrolysis, Blueprint for Franco Farris Gasifier System. His HUD pulsed again, the FOB progress bars now had a new objective to build a fuel pyrolysis system, he would be back with the parts—and the buggy would need the fuel, they all know HQ isn't sending a convoy out to this desert any time soon.
Mission parameters updated.
Objective: Restore Buggy and Distill Fuel.

Further, the present disclosure describes the Celeste Opera System for facilitating tailoring experiences of users. Further, the Celeste Opera serves as the centralized integration framework, coordinating interactions across multi-plane reality layers and seamlessly interfacing with quantum-enhanced processing, several dynamic data sources, and AI-driven modules. It acts as the core bridge between user inputs, environmental data, and the strategic AI-based control systems, ensuring an experience that is continuously tailored to each user's needs through several layers of ML and processing units for data feedback loops. This flexibility supports the seamless engagement with various reality layers; Celeste Opera excels in optimizing these transitions through real-time adjustments, which maintain user immersion while adapting dynamically to changes in user behavior and environmental conditions.

Celeste Opera OrbTech: Data Storage & Network Systems: The OrbTech Data Storage and Network Systems within the Celeste Opera framework play a vital role in ensuring that personalized experiences, seamless communication, and data security are maintained across all operational contexts. Through advanced quantum capabilities, these systems ensure rapid data access, efficient storage management, and uninterrupted connectivity, supporting the adaptive multi-plane reality experiences that are central to the Celeste Opera.

Celeste Quantum DB (CQDB): Personalized, Decentralized, and High-Speed Data Management: The Celeste Quantum DB serves as the central repository for user-specific and user-specified data, providing both high-speed data retrieval and decentralized data storage options for optimal user experiences. It combines the power of quantum data processing with a focus on personalized data (either user-specific or user-specified), enabling real-time adaptation of multi-plane realities according to each user's unique profile and preferences.
Personalized Data Management: The Celeste Quantum DB holds user-specific content such as training histories, DNA profiles, immersive experience records, and custom playlists, providing a rich and tailored database for each user. This allows the DNA Rating System (DNA-RS) to pull from stored interaction records and tailor future experiences according to the user's past interactions and preferences, thus continuously refining the user's digital and immersive interactions; this could be as simple as knowing that when the user is on an airplane, they like to watch a video playlist about historic discoveries and then calling that playlist from their CQDB when a flight is detected.
Quantum Flash Search for Instant Data Retrieval: The Quantum Flash Search capability enables the CQDB to quickly compile relevant user data, making it accessible for real-time adjustments to digital experiences. By leveraging entanglement between quantum data nodes, the system can conduct searches across vast data sets almost instantaneously, reducing lag in scenarios where rapid data access is critical—such as during live mission adjustments or training simulations.
Persistent Data Tether: The Celeste Quantum DB serves as a persistent data repository for long term data storage and recall, making it possible to create multiple layers of data over a period of time for analysis and insight. This allows users to interact with historical data in meaningful ways, providing deeper context and understanding. For example, a small mining town could be put under surveillance for security, this live data is stored; when something tragic happens to the town they are able to quantum flash the persistent data tether for analysis to see a layered reality of hot zones, and any other indicator that they are searching for to determine what happened. This persistent data tethering can be used for location, event, group, or another indicator specific need, whereby the persistent data tethered to said specification can be used to advise future decisions. Simpler use-cases include suggested activities for likeminded user-groups, crowd control of an event based on past event issues and successes, suggested travel itineraries for a new travel destination based on user's preferences from other previous locations, and compiling that with the new travel destination's historic tourism data.
Decentralized Data Access and Security: The CQDB's integration with Extranet Orbs allows it to store user data in a distributed manner, making it accessible even when users are off-grid. The use of (blockchain or quantum) encryption ensures that data remains secure during transfer between hubs, providing users with control over who can access their sensitive information through tokenized access permissions. This is particularly valuable for scenarios involving remote fieldwork or sensitive missions where data privacy and security are paramount.
Synchronizing Experiences and Knowledge Trails: The Celeste Quantum DB allows for seamless synchronization of data with Extranet Orbs, maintaining continuity even when internet access is unavailable. It stores recorded trails and experiences, making them available for future review or as part of user-generated content that others can mine, purchase, or unlock. This functionality supports both recreational and professional use cases, such as a historical augmented tour where visitors unlock narratives at each orb or a forestry worker logging their daily progress in a decentralized manner.

Extranet Orbs: Decentralized Knowledge Hubs, Zone Control, and Adaptive User Engagement. Extranet Orbs play a crucial role in creating decentralized OrbTech networks for the Celeste Opera System, enabling localized data access and immersive experiences in environments that lack classical internet infrastructure. These orbs function as dynamic data nodes that support user interactions, environmental adaptation, and seamless connectivity through quantum communication and localized power solutions.
Extranet Orbs: Decentralized Networking and Long-Term Storage: Extranet Orbs are critical components within the Celeste Opera System, providing decentralized, off grid networking and long-term data storage. These orbs enable entire zones to function autonomously without reliance on traditional internet infrastructure, making them ideal for remote areas or locations where secure, localized data access is essential.
Zone Control and Decentralized Network Availability: Extranet Orbs form self sustaining network hubs that can link entire zones, providing access to critical data and communication tools. These networks can operate in completely off-grid environments, using localized energy sources such as tree energy and optimized energy harvesting technologies. Depending on the operational needs, Extranet Orbs can be configured to allow open access for all users or limit connectivity to those with the appropriate clearance.
Dome Tech for Adaptive Zones and Optimized Power Use: Dome Tech enhances Extranet Orbs by creating virtual zones that activate AR/MR experiences, collaborative challenges, or tailored environmental adjustments as users move through them, creating location-based narratives that evolve dynamically or tailored digital interactions based on user proximity. These zones can guide users through immersive tours, provide event-specific content, or secure operational areas. Dome Tech also optimizes power usage by limiting activation to user specific zones, ensuring energy-efficient operation in long-term deployments.
Sustainable, Off-Grid Energy Solutions: Extranet Orbs leverages optimized solar panels, tree energy, electron pumps, kinetic energy harvesting, and zero-point energy to power continuous operation in even the most remote or resource-limited environments. This allows the orbs to provide reliable networking and storage solutions for extended periods without requiring external power grids, making them especially valuable in off-grid operations or disaster zones.
Adaptive User Engagement and Security: Extranet Orbs are equipped with dynamic security protocols that can restrict or grant access based on user credentials. Whether deployed for open community engagement or secure access, the orbs adapt their controls to ensure that data remains secure, while still allowing necessary users to tap into localized networks and connect their Beartooth Dongle mesh networking devices.
Beartooth-Enhanced Connectivity and Energy Efficiency: Beartooth Dongles create a decentralized mesh network that enables stable, low-latency communication between Extranet Orbs and devices, even in remote or off-grid environments. By dynamically routing data through the most reliable nodes, Beartooth ensures continuous connectivity while conserving energy through efficient short-range connections, making Extranet Orbs highly reliable and energy-efficient in demanding settings. Moreover, by integrating Beartooth Dongles, Extranet Orbs maintains mesh network stability, enabling low-latency communication between users, Skowl DS drones, and other autonomous units in off-grid areas.
Long-Term Data Storage and Access: Designed for robust, long-term deployments, Extranet Orbs serve as decentralized knowledge hubs, capable of storing large volumes of data locally. This feature is essential for situations where long-term data storage is required without a stable internet connection, enabling users to access critical data, AR overlays, or other information directly from the orb. Such as hiking trails or augmented historic tours where the information is unlikely to change for long durations, extranet orbs are used to provide a sustainable solution to on-site education.

Hyper-net Orbs: High-Speed Quantum Communication and Quantum-Assisted Synchronization. Hyper-net Orbs provide Celeste Opera with advanced quantum communication capabilities, facilitating ultra-responsive interactions and seamless data synchronization across vast distances. By leveraging quantum entanglement, these orbs ensure minimal latency and high data integrity, supporting complex multi-user environments and adaptive digital experiences.
Quantum-Assisted Data Synchronization and Real-Time Collaboration: Hyper-net Orbs use entangled quantum states to maintain secure, instantaneous data channels between remote users and central AI systems. This enables perfect synchronization in global collaborative events like eSports tournaments, where latency could disrupt the flow of competition. By providing consistent, real-time updates to all participants, Hyper-net Orbs ensures that digital interactions are smooth and immersive, whether users are engaging in a collaborative VR simulation or conducting a synchronized research project.
Supporting Quantum Serverless Capabilities in the Onyx Panther OS: The quantum processing power of Hyper-net Orbs allows the Onyx Panther OS to offload computationally intensive tasks to these distributed nodes. This is crucial for managing large-scale data processing needs, such as rendering complex VR environments or performing deep behavioral analysis in real-time. By tapping into Hyper-net Orbs, the Onyx Panther OS can balance workloads dynamically, ensuring that user experiences remain seamless even during resource-heavy operations.
Enhancing Extranet Connectivity and Data Security: Hyper-net Orbs also serve as quantum repeaters within the Extranet mesh, extending the reach and encryption capabilities of decentralized networks. They create secure communication bridges between Extranet Orbs in various locations, allowing critical data to be shared securely between isolated field teams and central command units. This makes them ideal for scenarios like scientific expeditions or wilderness survival training operations, where data security and integrity are paramount.

Intranet Orbs: Biometric Data Management and Localized Interaction. Intranet Orbs are designed to handle real-time biometric data processing, ensuring that user interactions with AR/MR layers are adaptive and responsive to their physical state. These orbs act as intermediaries between biometric sensors like YAmaker and the system's AI components, managing data at the edge to enable seamless, personalized user experiences.
Biometric Data Collection and Adaptive Feedback: Intranet Orbs process data from wearable devices like YAmaker, interpreting neural signals, heart rate, and other physiological metrics to inform real-time adjustments in digital content. By utilizing NPUs for rapid neural data interpretation, the orbs ensure that shifts in the user's physical state—such as stress, excitement, or relaxation—are instantly reflected in the digital environment. For example, during a high-energy concert or sporting event, Intranet Orbs can detect heightened excitement levels from the crowd and adjust AR overlays to enhance the atmosphere—perhaps by increasing interactive elements or triggering special visual effects. Alternatively, during a workout session in the park, the system might track user fatigue and adjust the difficulty or intensity of AR-guided exercises, ensuring that participants maintain a balanced and engaging workout experience.
Secure Data Handling through Quantum Encryption: Intranet Orbs utilizes quantum encryption protocols to ensure the secure transmission of sensitive biometric data. This is especially valuable for various medical applications or personalized training sessions, where user privacy must be maintained. By storing encrypted biometric data locally, Intranet Orbs ensures that user-specific feedback remains accessible even when external networks are unavailable, creating a seamless bridge between on-site and off-site data handling.
Energy Optimization through Wearable Integration: Intranet Orbs harness energy from devices like Vicci Wear and HiSS footwear, using thermoelectric generators to sustain biometric monitoring during extended use. This allows Intranet Orbs to remain active during long-duration physical activities, ensuring that real-time biofeedback remains uninterrupted. The Onyx Panther OS adjusts energy use based on user activity, optimizing power for intensive monitoring when needed while conserving resources during rest periods.
AMP Repeater Routing: For users who are able to act as AMP Repeaters, their connection can be synced with intranet orbs to boost network signals and relays. Thereby enabling mobile and dynamic networking capabilities anywhere that an AMP Repeater can go. Although OrbTech is encrypted, AMP Repeaters are not and therefore are primarily utilized for networking and not secure data storage.

Internet Orbs: Bridging Centralized Connectivity and Distributed Data Access. Internet Orbs provides the crucial interface between the Celeste Opera OrbTech and the current global internet infrastructure, enabling users to access cloud-based resources and centralized data stores. These orbs ensure that even when users transition between decentralized and centralized networks, their experiences remain consistent and uninterrupted.
Cloud Integration and Real-Time Data Synchronization: Internet Orbs enable direct access to cloud resources, ensuring that users can download and sync data such as AR guides, training updates, or educational modules in real-time. For instance, in a training scenario, Internet Orbs can provide real-time updates and live video feeds, ensuring that all participants have access to the latest information. This capability allows the system to adapt to changing conditions, providing a seamless transition between offline and online operations.
Photon-Based Quantum Communication for Secure Data Transfer: Internet Orbs use photon-based communication systems to achieve high-speed data transfer, making them ideal for latency-sensitive tasks like VR content delivery or global data sharing. Quantum encryption secures data during transmission between cloud servers and user devices, protecting sensitive information during operations. This is crucial for business or research applications where secure data sharing is essential and allows the OrbTech to operate as micro servers for accessible use.
Adaptive Hybrid Connectivity: Internet Orbs coordinate with Extranet Orbs via quantum networking/relays to cache critical content for offline access, ensuring continuity when users move into off-grid areas. This hybrid connectivity allows users to continue accessing vital data during field operations or travel, while the Onyx Panther OS dynamically manages data availability based on user needs. For example, during a remote work assignment, Internet Orbs can facilitate ongoing access to essential databases or communication tools, even as network availability fluctuates via extranet connections; off-grid no longer has to mean “completely disconnected from connected reality”.
Energy Optimization for Continuous Connectivity: Internet Orbs incorporate advanced energy management systems, including coherent module technology and advanced solar energy harvesting, to maintain long-term operations even in areas with limited access to expected power sources. By optimizing energy consumption during high-bandwidth activities, the Onyx Panther OS ensures that Internet Orbs can sustain continuous data transmission and real-time synchronization without unnecessary power drain. For example, during data-intensive simulations or training modules, the system prioritizes power allocation to maintain seamless connectivity, while reducing energy use during less demanding periods.
Supporting Quantum-Enhanced Communication Layers: Internet Orbs work in tandem with Hyper-net Orbs to leverage quantum communication channels, providing a bridge between centralized cloud resources and decentralized quantum networks. This combination allows for secure, high-speed data exchange between distributed users and cloud-based systems, enabling the Onyx Panther OS to manage quantum enhanced AI models and simulations efficiently. By maintaining a seamless link between cloud servers and quantum-powered Extranet and Hyper-net Orbs, Internet Orbs ensures that users experience consistent digital interactions, regardless of the complexity or scale of their activities.
E.g.
As the Candidate entered the junkyard, his HUD was already automatically scanning the chaotic landscape. A quick touch on his ring and the Onyx Panther OS tapped into the Hypernet, activating the extra pull for the Celeste Quantum DB. The HUD pulsed, overlaying the area with augmented markers as the Quantum Flash Search scanned for all historical data of the zone. Within seconds, points of interest appeared-iconic AR pins lighting up across the field of wreckage. Each marker indicated critical parts relevant to the buggy and the new Franco Farris Gasifier Pyrolysis System. The HUD displayed the icons clearly: an Axle Stabilizer here, an Engine Block there, scattered among the remnants of old tech; he red lit the engine block, it wasn't on his list.
Scanning Complete
Relevant Data Found: Buggy Parts (expand list), Pyrolysis Components (expand list) The Candidate moved smoothly toward the first pin, the carrier bot rolling beside him. With precision, he sifted through the debris, his synced Operational JustFit (OJ) gloves vibrating with confirmation as he placed his hand over the Axle Stabilizer. The HUD marked it as collected, and the bot extended its arm, taking the part and placing it in its cargo hold.
The Atomic Planner recalculated the path, adjusting the AR trail to guide him to the next target. More components—shock absorbers and a fuel injector—glowed faintly on his HUD as he approached, each one tagged by the system. He moved from one marker to the next, collecting parts for both objectives and dropping them into the bot's hold as they moved efficiently through the scrapyard.
As he neared the final pin, a soft glow caught his eye—an old Extranet Orb, half-buried beneath the wreckage of a collapsed transport vehicle. The orb's faint pulse indicated power, but its encryption was locked.
Unidentified Orb Detected, paired
Best not unlock this one, he thought; He stowed it with the rest of the parts, knowing the team at the FOB could decrypt it.
Orb Stored: Ready for Decryption
With the required parts secured, the HUD updated, marking the collection mission complete. The Onyx Panther OS synced the collected data back to the FOB, feeding real-time updates through the decentralized OrbTech network. The path back blinked into view, glowing softly as the system guided him out of the junkyard, with a flick of the wristlet, the bot began back up the trail.

Celeste Opera Core: Celeste Opera achieves the superior adaptability through its deep integration with the Layer Synchronization Module (LSM), ensuring smooth transitions between reality layers and constant alignment with the user's evolving context. The system is further empowered through interfaces with key subsystems like the AI Core, Dogon LARP Engine, Atomic Planner, and VRAiT (VR AI Trainer), each contributing unique capabilities that support synchronized, contextually aware experiences. By leveraging real-time feedback and biometric data from integrated devices such as the YAmaker and Recon Bots, Celeste Opera adapts digital content and interaction strategies to suit the user's needs. This ensures that users remain engaged, whether they are immersed in a VR training session, navigating AR overlays in a work environment, or participating in a narrative-driven Dogon LARP event.

Layer Synchronization Module (LSM): Real-Time Adjustment of Reality Layers. Further, the LSM is for layer synchronization and user-centric adaptation. The Layer Synchronization Module (LSM) is a crucial subsystem within Celeste Opera, responsible for orchestrating the real-time adjustments between AR, MR, VR, SR, and DR layers. Acting as the control hub for these transitions, the LSM enables the Celeste Opera to tailor experiences to user preferences and external stimuli, ensuring that reality layers blend seamlessly to maintain immersion.
Interfaces with Contextual Predictive Modeling (CPM): The LSM integrates closely with Contextual Predictive Modeling (CPM), a subcomponent of the ML Layer designed to forecast user behaviors and adjust reality layers in advance. When the CPM detects variations in user stress levels-derived from biometric data captured by the YAmaker or changes in environmental conditions reported by Skowl DS or other EI synced sensors—the LSM adjusts reality layers to either amplify or case the intensity of digital interactions. For instance, In a shopping context, CPM could analyze a user's biometric feedback as they navigate a store. If stress levels rise, perhaps due to decision fatigue, the LSM could simplify product displays in AR, highlight personalized recommendations, or activate an AI assistant to guide the shopper toward items that match their preferences. This creates a more comfortable and efficient shopping experience, ensuring the user remains engaged without feeling overwhelmed.
Strategic Adaptation with the AI Core: Celeste Opera's connection to the AI Core facilitates the balance between immediate layer adjustments and long-term strategic adaptation. While the LSM handles real-time changes, the AI Core provides Celeste Opera with deeper insights into user behavior trends, guiding more strategic adaptations. For example, when the AI Core identifies a user's sustained engagement with a specific MR scenario, it can suggest adjustments to extend or evolve that scenario, keeping the experience fresh and challenging. The LSM then implements these strategic insights, transitioning the user between reality layers as needed. This dynamic interplay between the LSM's immediate responsiveness and the AI Core's strategic foresight ensures a holistic and adaptive user experience.

Multiple Realities for Seamless Integration: As part of Celeste Opera's core objective of delivering adaptable, multi-plane reality experiences, the LSM ensures uninterrupted access to the system's capabilities across varying operational conditions. In addition to advanced realities like AR, MR, VR, and SR, Celeste Opera also supports Digital Reality (DR)—a more classical form of digital engagement that relies primarily on interaction through screens or static digital environments. This inclusion guarantees that users can access and engage with digital content even when higher forms of reality augmentation are unavailable or unnecessary and the LSM ensures that the transition and/or parallel use of one or more of these layers is managed effectively. For example, in scenarios where AR or MR layers may be restricted due to safety considerations or hardware limitations, users can still interact with mission-critical data or simulations through a DR interface, maintaining continuity in their trails for workflow, training, etc. By managing these DR interactions through the Layer Synchronization Module (LSM), Celeste Opera ensures that transitions back to simpler digital interfaces remain fluid and connected to the overall experience. This capability helps maintain Celeste Opera's mission of creating seamless and dynamic user experiences, ensuring that users always have a fallback mode for accessing system capabilities, and enabling uninterrupted engagement in diverse operational contexts.

Celeste Opera Quantum Processing for Adaptive Synchronization. Further, the Celeste Opera Quantum Processing is associated with quantum processing for enhanced system coordination. Quantum processing capabilities are integral to Celeste Opera, ensuring high-speed synchronization between distributed components and enabling the system to handle complex reality adjustments with minimal latency. By leveraging Hyper-net Orbs and Quantum Repeater Networks, Celeste Opera coordinates data exchanges and manages computational demands across various decentralized nodes, ensuring that even remote users receive responsive and accurate adjustments.
Quantum-Assisted Data Flow: The use of quantum entanglement between Hyper-net Orbs and central AI modules allows Celeste Opera to manage data flow seamlessly across the decentralized infrastructure. This capability is critical for scenarios where users are interacting with data from multiple sources, such as in field operations where Skowl DS and Recon Bots provide real-time environmental data. For instance, during a search and rescue mission, data from a Skowl DS drone mapping the terrain and Recon Bots scanning for heat signatures must be processed quickly to update AR overlays. Quantum entanglement helps synchronize this data, allowing the LSM to synchronize AR, MR, and VR layers rapidly reducing latency and ensuring that users receive precise, up-to-date information about their surroundings, even when operating in areas with limited classical network connectivity.
Quantum Flash Transmission for Load Balancing: Through the use of quantum flash transmission, Celeste Opera dynamically distributes computational loads between the centralized Onyx Panther OS functions and decentralized AI modules. This ensures that resource-intensive tasks, such as real-time scenario adjustments or deep analysis of user behavior through the AI Core, can be offloaded to distributed processing nodes when necessary. This load balancing allows Celeste Opera to maintain a high level of responsiveness during complex simulations or multi-user VR sessions, ensuring that users experience smooth interactions and immediate feedback regardless of system load. The result is a system that remains agile and capable of adapting to fluctuations in user demand or changes in environmental data, making it ideal for diverse applications from immersive gaming to professional training.

Integrating Strategic Insights from the AI Core: The AI Core is a pivotal part of the Celeste Opera system, enabling a seamless integration of long-term strategic insights into real-time adjustments for dynamic multi-plane realities. This layer operates in synergy with the ML Layer, Atomic Planner, VRAiT, and Dogon LARP Engine, serving as a strategic advisor that interprets complex data patterns to guide real-time decisions across various reality layers of perception.
AI Core Contextual Analysis and Long-Term Adaptation: The AI Core uses advanced neural network architectures like Generative Adversarial Networks (GANs) and Long Short-Term Memory (LSTM) models to conduct deep pattern analysis across user interactions, trail data, and environmental inputs. This allows the AI Core to anticipate user needs, dynamically adjusting the complexity of AR, MR, VR, and SR layers based on real-time performance data and long-term user behavior. For example, during an extended VRAiT session, the AI Core detects that a user is struggling with high cognitive load. In response, it communicates with the LSM (Layer Synchronization Module) to simplify the current training scenario, reducing virtual distractions and adjusting the AR overlays to a more focused state, allowing the VRAiT to better guide the user and thus ensuring user engagement without overwhelming them.
AI-Driven Predictive Models in Celeste Opera: Incorporating predictive models, the AI Core enhances Celeste Opera by continuously analyzing environmental changes (EI—Environmental Intelligence) and user behavior (BI—Behavioral Intelligence, OI—Operational Intelligence). This helps to educate the DNA-RS and optimize the timing of reality transitions. For instance, in Dogon LARP missions, if the AI Core identifies a shift in team dynamics—such as a participant showing signs of stress through YAmaker metrics—it instructs Celeste Opera to alter the AR narrative to provide more supportive guidance for that user, adapting to the team's needs. These strategic adaptations ensure that all digital layers are contextually aligned, including AR within an SR experience, maintaining a high level of immersion and engagement in a multi-layer environment.
Quantum Data Flow Management for Strategic Insights: Quantum Processing Units (QPUs) within Celeste Opera enable rapid processing of large datasets, such as DNA-RS user profiles and VRAiT performance histories stored in the Celeste Quantum DB. This empowers the AI Core to perform quantum flash searches through the Celeste Quantum DB, allowing it to retrieve historical and persistent tethered data instantly. When a user faces a complex tactical simulation, the AI Core can pull relevant past performance data, cross-referencing it with ML Layer predictions to adjust SR challenges on the fly.

VRAiT System: Adaptive AI-Based Coaching for Multi-Plane Realities in Celeste Opera. The Virtual Reality AI Trainer (VRAiT-Virtual Reality Adaptive Integration Training) operates as a sophisticated AI-driven coaching module within the Celeste Opera system, designed to provide personalized, real-time training and guidance across multiple learning scenarios, physical training trails, and immersive simulations. The VRAiT system's integration with the Onyx Panther OS and other intelligent layers within Celeste Opera allows it to adjust dynamically to user feedback, biometric data, and environmental factors, ensuring that each session is optimized for the user's cognitive and physical state.
Adaptive Multi-Reality Integration: VRAiT (Virtual Reality Adaptive Integration Training) functions across all reality layers (AR, MR, VR, SR, and DR) by leveraging the Layer Synchronization Module (LSM). It adjusts the complexity and depth of the training scenarios based on user behavior, biometric feedback from BI (Behavioral Intelligence) and OI (Operational Intelligence), environmental conditions monitored by EI (Environmental Intelligence), and wearables like Vicci Wear and YAmaker. The ML Layer continually refines the AI's adaptive strategies, ensuring a responsive, personalized training experience.
Real-Time Monitoring and Data Processing:
   Wearable Sensor Integration: VRAiT uses edge-based processing through wearable devices such as YAmaker, Vicci Wear, and smart (Operational Justfit—OJ) gloves equipped with biometric sensors (EEG headsets, GSR sensors, IMU units). This system reduces latency by allowing preliminary data analysis directly on the wearables before sending refined data to the central Onyx Panther OS for further computation. Biometric data related to stress, heart rate, and physical exertion informs real-time adjustments in virtual environments.
   Neural Feedback Integration: Data collected from YAmaker's non-invasive neural sensors is processed by the Neural Processing Unit (NPU), enabling cognitive load detection. For instance, VRAiT monitors mental fatigue and reduces the complexity of a task if the system detects elevated cognitive strain, reducing burnout.
   Environmental and Contextual Data Processing: By interfacing with Skowl DS for real-time geospatial data and environmental monitoring, VRAiT adapts training based on the user's location, weather conditions, and ambient factors. Contextual adjustments are made through OrbTech, ensuring real-time data transmission through EI (Environmental Intelligence) to Onyx Panther OS, where terrain, temperature, or humidity changes are used to adjust difficulty or modify user pacing.
   Dynamic Training Adjustments: VRAiT leverages Contextual Predictive Modeling (CPM) algorithms to modify task difficulty and pacing. During outdoor physical training, for example, if the system detects increased altitude or harsh weather, VRAiT will provide more frequent rest prompts, altering pace recommendations, and identifying potential rest points and shelters from the elements for user safety.
Skill Acquisition and Precision Feedback:
   Real-Time Training Correction: Using AR-based corrective feedback projected through heads-up displays (HUDs) or smart glasses, VRAiT provides real-time guidance. Object recognition algorithms identify incorrect movements during physical exercises, and virtual alignment markers help users correct posture or technique instantly if wearing Vicci electro-vibration will prompt alignment. In VR combat training, incorrect stance or weapon handling will prompt visual cues that guide users toward the proper form. In Simulated Reality (SR) scenarios, focused ultrasound and hard hologram technology create tangible virtual objects, allowing users to practice physical tasks with realistic resistance. For instance, handling virtual tools in medical training would feel as if they are real, enhancing muscle memory.
   Continuous Performance Analysis: VRAiT tracks user performance metrics such as speed, accuracy, and efficiency, providing real-time feedback through wearables or HUD systems. This system dynamically adjusts instructional methods based on the user's progress, enhancing the learning experience. Integrated with the DNA Rating System (DNA-RS), VRAiT evaluates long-term biometric data trends to fine-tune training plans.
VRAiT AI and ML-Driven Adaptation:
   AI Core Decision-Making: VRAiT integrates deeply with the AI Core and Atomic Planner to process complex situational data and adjust training strategies on the fly. Predictive analytics guide VRAiT's strategic coaching during high-stakes scenarios such as virtual tactical missions, where situational awareness and timely feedback are critical.
   Quantum Processing and Rapid Data Relay: Leveraging the Quantum Processing Unit (QPU) within Hyper-net Orbs, VRAiT operates with minimal latency, ensuring that the time between data input (from wearables or environmental sensors) and system feedback remains nearly instantaneous. This enables high-speed synchronization across multi-user environments, allowing VRAiT to provide real-time team-based coaching or collaborative feedback during group training exercises.
VRAiT Feedback Systems and Immersive Coaching Motivational and Corrective Feedback:
   Using adaptive personalized algorithms, VRAiT (Virtual Reality AI Trainer) assesses user sentiment in real-time. Voice sentiment analysis or facial recognition detects signs of user fatigue, enthusiasm, or stress, prompting VRAiT to adjust its coaching style. For instance, it may provide motivational support during a challenging hike or suggest recovery breaks during intensive cognitive tasks.
   Haptic and Visual Reinforcement: VRAiT integrates with Vicci Wear to deliver haptic feedback, enhancing user immersion by guiding physical actions or providing rewards through vibrational cues. In a worksite safety training module, vibrations signal when a user approaches hazardous zones or needs to adjust equipment handling techniques, while AR visual cues overlay proper safety protocols. This synchronized feedback ensures users stay aware of their environment, reducing the risk of errors or accidents.
   Dynamic Reality Layer Integration: VRAiT coordinates with the Layer Synchronization Module (LSM) to determine when to shift between AR-based overlays and more immersive VR or SR environments based on task complexity or user fatigue. For instance, during high-focus cognitive tasks, VRAiT may reduce external environmental distractions by transitioning to full VR, while AR layers are used for tasks requiring physical interaction with real-world objects.
E.g.
The Candidate returned to the FOB just as the sun began its descent. His HUD flashed with updates—progress on the base had accelerated while he'd been out scavenging. The buggy repairs were well underway, and the Franco Farris Gasifier Pyrolysis System installation had begun. He reviewed the progress bars ticking upward on his HUD, syncing his steps to the activity around him.
He sent the carrier bot to the buggy, where Dalton and two others were already working. The bot opened its cargo, extending its arm to deliver the parts collected from the junkyard.
As Dalton inspected the pieces, the Candidate walked over, tapping a few commands on his wristlet. “I grabbed an extra fuel injector from the yard. It wasn't on the list, but I had this in mind.” He shared the blueprint for the Salter Hydrocell Fuel Injection System to Dalton's Celeste DB.
Dalton raised an eyebrow. “Efficiency boost?”
The Candidate nodded. “The injector will optimize the fuel utilization. It's a good upgrade for the buggy, especially given the conditions out here.”
Dalton smiled, looking down at the schematic on his HUD. “Good call. I'll make sure we get this integrated.” He turned to the others, motioning them to work on the modifications. The Candidate watched as they dove into the task, their HUDs filling with 3D-modelled guided assembly instructions.
Satisfied, the Candidate walked over to Sergeant Reyes, who stood near a few engineers prepping the installation of the Franco Farris Gasifier Pyrolysis System. The Atomic Planner had already synced to his HUD, projecting a detailed 3D schematic of the system's assembly process in layered AR over VR. The assembly was complex—each layer of the blueprint highlighted critical components and how they would interlock.
He selected the instructions panel, the VRAiT system began issuing assembly instructions directly through his HUD, offering guidance for each step. Diagrams, arrows, and animated sequences played out in front of him, showing how the system would convert waste into energy, a key solution for keeping the FOB fully operational.
“Looking good,” the Candidate said, viewing their progress bars populating as the assembly was about to get underway. “The system seems solid.”
Reyes nodded, adjusting a part on his exosuit and syncing with the Atomic Plan.
“This should keep us running smoothly. Waste-to-energy conversion will give us the fuel we need for longer operations out here.”
The Candidate looked at the last object remaining in the carrier bot—the Extranet Orb he had found in the junkyard. He grabbed it and made his way over to the command tent.

Orchestrating Trails and Sequential Events with The Atomic Planner. The Atomic Planner is a central coordination tool within Celeste Opera, responsible for managing and sequencing events (i.e. trails) across diverse user scenarios. It is designed to handle more than just training modules; it manages any series of sequential events, including collaborative missions, complex simulations, and even gamified experiences that require precise timing and coordination. By adapting event sequences based on real-time data, the Atomic Planner ensures that each scenario remains aligned with user needs and environmental conditions.
Atomic Planner Dynamic Trail Management for Real-Time Adaptation. The Atomic Planner creates and manages trails, which are sequences of logic-based steps that users follow to achieve specific objectives or complete missions. These trails are a multi-functional tool within the Celeste Opera system, used for training, exploration, or even narrative-driven objectives. For instance, during a Dogon LARP mission, a trail consists of a series of orbs that users must access to unlock new plot points or collaborative tasks. The Atomic Planner ensures that these trails adapt dynamically, adjusting the sequence of tasks based on user progress, environmental changes, or insights from the AI Core. If a user struggles with a particular challenge, the Atomic Planner can adjust the trail to introduce an easier alternative or provide additional guidance.
   Atomic Planner Collaboration Models: The Atomic Planner manages collaboration through different models of group dynamics, ensuring that the system adapts to the specific structure of the group involved, for example:
      a. “Direct” Collaboration: In this model, the Atomic Planner treats the group as a single entity where individual roles are defined by each participant's preference persona (DNA-RS). These personas fold into a unified “group persona,” requiring the system to calculate and balance multiple needs within one collaborative trajectory. For example, during a family vacation, the Atomic Planner adjusts the travel itinerary to accommodate each family member's preferences. If one member prefers adventurous outdoor activities while another enjoys cultural tours, the system balances these preferences by suggesting a trail that offers a mix of both, ensuring everyone is engaged and satisfied. The system might also tailor specific challenges or experiences to individuals—such as recommending a challenging hike for the more active participants while offering historical information via AR for those interested in local culture-all while maintaining the overall cohesion of the family's travel experience.
      b. “Networked” Collaboration: Here, the Atomic Planner coordinates trails based on the available team members, where the overall trajectory is contributed to by multiple personas (eg. skillset), but the core mission does not depend on satisfying all personas equally. Instead, the Atomic Planner adapts to the available team members, altering deliverability and task assignments as needed, without shifting the overall mission goal. For instance, in a workplace project, if certain team members are unavailable or experiencing fatigue, the Atomic Planner recalibrates responsibilities to ensure the project stays on track. If one team member with strong analytical skills is absent, the system may assign simpler data tasks to others while still keeping the project moving forward. The system focuses on leveraging the strengths of available team members, ensuring that progress continues even if the optimal skill mix isn't present.
      c. “Co-op” Collaboration: In the co-op model, the Atomic Planner enables decision-making and achievements by individual users to directly influence what is available to the rest of the group. For example, in an exploratory mission, one user's success in overcoming a specific challenge (such as solving a puzzle or unlocking an area) impacts what resources or tasks are available to other group members, promoting interdependence within the co-op structure. This approach ensures that users' contributions dynamically reshape the experience for the entire team without relying on user personal preferences directly.
Atomic Planner Integrating Trail Data into the Multi-Layered System. Trails managed by the Atomic Planner are deeply integrated with the ML Layer and AI Core, enabling adaptive decision-making based on real-time user input. As users progress through a trail, the AI Core analyzes their interactions, providing insights that the Atomic Planner uses to adjust the sequence of upcoming events. This ensures that each trail evolves in response to user behavior, keeping the experience engaging and contextually relevant. For example, in a collaborative project management environment, the Atomic Planner adjusts the order of tasks based on the team's progress and individual user metrics, such as workload or productivity levels. If biometric data from YAmaker sensors indicates user fatigue, the system could prioritize lower-intensity administrative tasks over more cognitively demanding activities, optimizing team efficiency. The Onyx Panther OS ensures that data flows smoothly between the various layers using the LSM (Layer synchronization Module) and DLA (Dynamic Layer Adjustment) to maintain synchronization between user actions and system responses in real time.
Atomic Planner Energy Management and Quantum Optimization. The Atomic Planner also plays a role in managing energy resources within the Celeste Opera framework, particularly when executing complex trails or scenarios that involve high-intensity interactions. It works with the Onyx Panther OS to allocate power to ensure that critical systems remain operational during peak demand periods. This is especially valuable during large-scale simulations or multi-user missions, where the Atomic Planner must coordinate energy/connection use to maintain system stability. For example, during a collaborative rescue mission, the Atomic Planner prioritizes power for Skowl DS drones providing real-time environmental mapping, ensuring that data from the drones is available to all team members.
Atomic Planner Seamless Integration with VRAiT and DNA-RS. In training and mission planning scenarios, the Atomic Planner works closely with VRAiT to align training paths with user needs and performance. It adjusts the complexity of trails and tasks based on DNA-RS data, ensuring that each user's experience is tailored to their learning style and skill level. For example, if the DNA-RS indicates that a user excels in strategic problem-solving but struggles with endurance challenges, the Atomic Planner can adjust the focus of a VR trail to emphasize tactical decision-making, while gradually introducing more physically demanding tasks as the user builds stamina. This ability to fine-tune the progression of trails ensures that Celeste Opera can provide truly personalized experiences, making each training or mission scenario more effective and engaging.

Following Narrative Trails of The Dogon LARP Engine. The Dogon LARP Engine serves as the narrative engine of Celeste Opera, creating dynamic, interactive storylines that adjust in real-time to user actions, environmental data, and the strategic guidance of the AI Core. While it plays a crucial role in gamified experiences, the Dogon LARP Engine is equally adept at crafting rich narratives across a spectrum of immersive scenarios, including simulations, collaborative missions, and even narrative-driven training sessions.
Adaptive Storyline Dynamics: At its core, the Dogon LARP Engine functions as a real-time story adaptation system, managing the flow of narrative elements across AR, MR, VR, SR, and DR layers. As users interact with their environments, the engine continuously evaluates their choices and performance data. By leveraging inputs from VRAiT, YAmaker, and CPM, the Dogon LARP Engine ensures that every user's experience remains personalized, with narratives that evolve based on their actions. For example, in a search-and-rescue mission, if a user demonstrates hesitation in high-pressure scenarios, the Dogon LARP Engine adjusts the storyline to introduce an ally character (via VRAiT) for support, providing subtle guidance and creating a more immersive and supportive narrative arc.
Gamified Feedback Loops and Immersive Engagement: The Dogon LARP Engine integrates gamified feedback mechanisms into its storytelling, making each narrative decision impactful. It uses AI Core insights and DNA-RS data to offer feedback tailored to the user's preferences and learning style. This could manifest as in-game achievements, XP rewards, or adaptive difficulty adjustments. For example, in a collaborative MR environment, the engine introduces new mission objectives or hidden challenges when it detects that a team is excelling. These elements keep the experience engaging and prevent narrative stagnation, allowing for a sense of progression that feels natural and rewarding.
Real-Time Narrative Adjustments with Quantum Insights: By incorporating quantum-enhanced AI through Celeste Opera, the Dogon LARP Engine can assess a wide array of narrative branches and select those that best match user behavior and preferences in real time. The Quantum Processing Units (QPUs) facilitate rapid retrieval of story elements and user data from the Celeste Quantum DB, allowing the engine to adapt story arcs instantly. Working with AI Core enables the Dogon LARP Engine to offer a seamless narrative flow even in complex, branching storylines where multiple outcomes are possible. For instance, during a historical AR reenactment or strategic simulation, the Dogon LARP Engine uses quantum insights to ensure that user decisions are reflected immediately in the environment, such as triggering alternative dialogues or unfolding new plot threads based on previous choices.
Synergy with the Atomic Planner and AI Core: The Dogon LARP Engine works closely with the Atomic Planner to structure narrative sequences that align with mission goals or training objectives. While the Atomic Planner orchestrates the sequence of events and scenario pacing, the Dogon LARP Engine breathes life into these events, providing the narrative context that gives meaning to each user action. For example, in a tactical SR mission, the Atomic Planner defines the sequence of checkpoints to be completed, while the Dogon LARP Engine integrates these checkpoints into a coherent storyline, introducing elements like narrative tension, character interactions, or unexpected plot twists that deepen the user's engagement with the mission. The AI Core supports this integration by analyzing user preferences (DNA-RS) and performance metrics (EI, BI, and OI), ensuring that narrative adjustments remain contextually appropriate and aligned with user expectations.
E.g.
As the Candidate entered the tent, Captain Stone was reviewing reports.
“Sir,” the Candidate greeted, holding up the orb.
Stone raised an eyebrow. “You've got clearance, son. Why are you bringing it to me?”
The Candidate held the orb up so that Stone would be in range for the paired status to appear on his HUD, a glowing link between the orb and something distant.
“It has an entanglement, sir.”
Stone's expression shifted. “Entanglement, huh? Well . . . we're about as isolated as we can be out here in the wasteland, go ahead.”
The Candidate pressed his hand to the orb, and his HUD displayed the decryption process. After a few moments, the orb unlocked, revealing a trove of old FEMA documents and an advanced water capture from air blueprint. His HUD tagged the blueprint as compatible with the Echo FOB list-another boost for the desert base's operational needs. Though, it was the final piece of data that caught his attention. A geopin appeared in the HUD, highlighting a location on the other side of the nearby hills. The area was marked with an unknown signature, and the Candidate's clearance level didn't give him more details.
“Well, that changes things,” said Captain Stone, who had been synced to the Candidates display for the unlock. “I was going to have you guys set up network nodes on those hills next week, but if someone's holding a geopin out there, we can't wait.”
He paused, then opened the Atomic Planner interface, sharing the mission parameters with the Candidate. “We'll move up the operation. Get those boots ready to move out.” data and mission ops were streaming across the display, Atomic Planner analyzing options and finding best fit scenarios “We need those nodes up, and I want intel on what's out there.”
The Candidate nodded, his HUD already syncing to the updated mission timeline, his VRAiT pinging in the upper corner, with tailored advice for him that he would review later.
The AR trail lit up in front of him, marking the points across the hills where the network relays would go, and a fourth point from the other side of the hill indicating the unknown pin. The real mission had just begun.

Celeste Opera Processing Systems Layer: Adaptive Intelligence for Real-Time Interactions. The Processing Systems Layer of the Celeste Opera framework handles the dynamic adaptation and cognitive processing required to create efficient, fluid, and personalized multi-plane reality experiences. This layer is responsible for interpreting user input, adjusting reality layers in real time, and leveraging advanced data models to provide each user with a tailored and engaging experience. The key components within this layer include the Machine Learning (ML) Layer, which houses the Dynamic Layer Adjustment (DLA), Contextual Predictive Modelling (CPM), DNA Rating System (DNA-RS), and the SoulTech neural processing system (NPU). Together, these systems interact seamlessly with the Celeste Quantum DB (CQDB), ensuring that models remain updated and relevant to evolving user needs.
Contextual Predictive Modeling (CPM): Anticipatory Adaptation Engine. Contextual Predictive Modeling (CPM) serves as the anticipatory adaptation engine within the Machine Learning (ML) Layer of Celeste Opera Core, focusing on predicting and adapting to shifts in environmental and user contexts. By leveraging real-time data from various hardware integrations, such as biometric inputs from YAmaker and spatial data from Skowl DS, CPM (Contextual Predictive Modelling) optimizes user experiences by forecasting changes in user behavior or environmental conditions.
   CPM Dynamic Data Integration for Predictive Accuracy: CPM's core functionality revolves around processing multi-source data to refine its predictive models. Data collected from Extranet and Hyper-net Orbs flows into CPM through Celeste Opera's orchestration, allowing for an up-to-date understanding of the user's immediate environment. For example, when Skowl DS detects a shift in weather conditions using LIDAR data, this information is integrated into CPM's predictive framework via EI (Environmental Intelligence) to anticipate necessary adjustments, such as modifying visibility levels or introducing weather-responsive overlays in the user's digital environment.
      Recurrent Neural Networks (RNNs) or Long Short-Term Memory (LSTM) models are employed to capture and process sequential user data, enabling CPM to predict future behaviors based on past interactions.
      Reinforcement Learning (RL) further enhances CPM by continuously improving its anticipatory adaptation strategies through reward-based learning.
   The Neural Processing Unit (NPU) within CPM (Contextual Predictive Modelling) is instrumental in managing this influx of complex data. It processes sensory inputs from YAmaker, translating variations in brainwave activity into actionable insights. The NPU's ability to interpret neural data allows CPM to adjust not just based on the environment but also on the user's mental and physical states.
   CPM Quantum-Assisted Pattern Recognition for Real-Time Adjustments: Quantum capabilities, facilitated by the Hyper-net Orbs and Celeste Opera's quantum processing, enhance CPM's ability to detect subtle patterns in user behavior. Quantum flash transmission enables rapid synchronization of data between CPM (Contextual Predictive Modelling) and the AI Core, ensuring that predictive models remain accurate even as user behaviors evolve. Quantum Machine Learning (QML), such as Quantum Support Vector Machines or Quantum K-Means, is employed to accelerate the pattern recognition process, enabling real-time adjustments even in complex multi-user environments. For instance, during a Dogon LARP mission where multiple participants interact with shared virtual SR environments, quantum entanglement between Hyper-net Orbs allows CPM to anticipate group behavior, optimizing collaborative challenges or narrative branches to maintain engagement levels across all users; furthermore, with persistent data tethering and the CQDB flash large events can be better structured and secured based on predictive modelling of historic data.
      Multimodal Deep Learning ensures efficient integration of different data sources (biometric, environmental, and physical) into CPM's decision-making process, improving the accuracy of predictions based on varied inputs.
   The Data Processing Unit (DPU) supports CPM by managing the volume of data processed during prediction cycles, allowing CPM to focus on pattern recognition and scenario forecasting without being overwhelmed by raw data inputs. This structured approach ensures that CPM can adapt both to macro-scale environmental changes and micro-scale user behaviors, maintaining seamless transitions between reality layers and activities.
   Dynamic Layer Adjustment (DLA): Real-Time Reality Tuning: Dynamic Layer Adjustment (DLA) is the real-time tuning mechanism within the ML Layer of Celeste Opera Core that directly modifies the balance of perception layers and layered realities based on trail components and/or event-based storylines. It allows Celeste Opera to adjust the depth, intensity, and scope of digital experiences based on immediate user needs and feedback, ensuring that each layer is aligned with the user's current context and environment.
      Dynamic Layer Adjustment (DLA) is the real-time tuning mechanism: within the ML Layer of Celeste Opera Core that directly modifies the balance of perception layers and layered realities based on trail components and/or event-based storylines. It allows Celeste Opera to adjust the depth, intensity, and scope of digital experiences based on immediate user needs and feedback.
         Convolutional Neural Networks (CNNs) are used to process real-time visual data, allowing DLA to adjust visual elements of AR or VR layers dynamically based on what the user sees or interacts with.
         Graph Neural Networks (GNNs) help model relationships between different environmental elements, ensuring optimal transitions between AR, VR, SR, and DR layers based on user interactions and environmental changes.
   DLA Adaptive Layer Shifting with CPM and AI Core: DLA works closely with CPM to make fine-tuned adjustments to reality layers. For instance, during a live concert or sporting event, CPM may predict a heightened level of user engagement as excitement builds. In response, DLA can shift from a light AR interface that provides general event information to a more immersive VR experience, where users can access exclusive content like live replays, behind-the-scenes views, or augmented performances, enhancing their connection to the event. This adjustment is facilitated through the AI Core's long-term analysis, which informs DLA of strategic shifts that align with the user's ongoing progress and goals.
   The interaction between DLA and the AI Core is further supported by the LPU (Logic Processing Unit), which handles the intricate logic calculations required for continuous adjustments between different realities and sequences. This enables DLA to fine-tune user experiences dynamically, such as changing the opacity of AR overlays during field missions to ensure that critical real-world elements remain visible while digital guidance remains accessible.
   DLA Power Management for Layer Adjustments: DLA's ability to manage transitions between layers is closely tied to Celeste Opera's quantum energy management systems and Onyx Panther OS management. During periods of high activity, such as multi-user VR simulations or complex SR scenarios, the Onyx Panther OS can divert additional energy resources to support DLA's intensive computational needs. The integration of flexible silver battery technology allows wearables like HiSS to harness and store kinetic energy from user movement, providing a supplementary power source that ensures DLA functions remain operational even during extended activities. DLA also utilizes energy-efficient modes during periods of low user activity. For example, when a user is reviewing static content in a DR setting, DLA can downshift resource allocation, allowing Extranet Orbs to handle basic data caching while reserving power for more demanding operations. This capability ensures that energy and connectivity resources are allocated strategically across the system, maintaining continuous user engagement without unnecessary power drain.
   DLA Synchronized User Experience Across Reality Layers: DLA (Dynamic Layer Adjustment) is designed to maintain the cohesion of digital experiences even as users transition between different layers. The DLA ensures that the narrative threads or interactive elements remain consistent, allowing the user to retain context. This capability is especially important during sequential experiences managed by the Atomic Planner, where each stage of a training or mission scenario builds upon the previous one.
   For example, if a user progresses from a tactical planning session in AR to a live VR mission, DLA ensures that all relevant data—such as terrain maps, objective markers, and teammate positions—are smoothly transitioned into the new reality layer. This ensures that users experience a sense of continuity, making each transition feel like a natural extension of the ongoing scenario. This capability is also applied during social or event-based scenarios managed by the Atomic Planner, where each stage builds upon the user's previous interactions.
   With the integration of advanced processing units, quantum enhancements, and a focus on maintaining a cohesive user experience, both CPM and DLA contribute significantly to Celeste Opera's ability to deliver seamless, adaptive multi-plane realities. These systems ensure that user interactions, environmental conditions, and narrative progressions are synchronized and optimized, allowing Celeste Opera to deliver a truly integrated and dynamic digital experience.
E.g.
After completing the repairs, the Candidate and his team had driven through the desert night in the buggy, the Snake bot deployed ahead of them, scanning for IEDs. As they reached the base of the hills the low hum of the engine became as still as the night air. Early dawn casting faint shadows over the desolate terrain, and the AR trails on their HUDs glowed softly, guiding them through the darkness with night vision feeds from the two skowl drones deployed overhead sending live feeds of crisp detail to their HUDs.
The VRAiT system audibled the objective updates in her calm voice: “objective: install network repeaters, first point: 350 meters, skowl status: aerial scan active, snake bot: deployed for threat detection, threat detection: negative”.
As they moved along the AR trail ahead of them, the Snake Bot slithered silently through the rocky terrain, its sensors working tirelessly to sweep for any underground threats. The CPM (Contextual Predictive Modeling) system fed the intel into the team's HUDs, highlighting key areas of concern, while the Dynamic Layer Adjustment (DLA) continuously tweaked the visual overlays and indicia to guide them along the optimal route.
Her voice again: “snake bot status report: arrived at point one, path clear.” The candidate nodded, his DNA Rating System (DNA-RS) monitored his biometrics, adjusting his HUD display to ensure his focus remained sharp under the night's tension.
As they reached the first relay point, the Candidate planted the orb into the tree about 1 meter from the base, this would give it reliable energy. The relay immediately syncing with their network and relayed to the FOB through the OrbTech relay. A soft pulse of blue light signaled the Orb's activation. First Relay Online
DNA Rating System (DNA-RS): Personalized Experience Optimization. The DNA Rating System (DNA-RS) within the Machine Learning (ML) Layer of Celeste Opera plays a crucial role in personalizing user experiences across various layers of reality, including AR, MR, VR, SR, and DR. By gathering and analyzing user interaction data—such as belt levels, RYG (Red, Yellow, Green) ratings, and explicit or inferred user preferences—DNA-RS customizes content and interactions to suit the user's needs and progression.
   User Interaction Data Integration and Access Management: DNA-RS dynamically adjusts the accessibility of different reality experiences based on the user's belt level, a system that represents their mastery and familiarity with specific content or environments. Higher belt levels unlock advanced content or specialized orbs that require more nuanced interaction capabilities. For instance, in augmented city tours, higher belt levels could unlock complex AR overlays showing hidden historical markers or advanced virtual puzzles, whilst beginners would only see simplified guides.
   This belt-level system is directly tied into the DNA-RS's predictive models, allowing Celeste Opera to tailor the user's experience by adapting the difficulty and depth of content to their current skill level. The RYG ratings further refine this adaptation by capturing user feedback—where green indicates positive, yellow denotes neutral, and red signals dislike. By interpreting these ratings, DNA-RS fine-tunes the user's content preferences and adjusts future interactions to align better with their indicated preferences.
      Collaborative Filtering and Matrix Factorization techniques are used within DNA-RS to recommend content and experiences based on user preferences and behavioral patterns.
      Clustering Algorithms such as K-Means are utilized to group users based on shared behaviors, allowing the system to offer tailored experiences for each user segment.
      Bayesian Networks further enable probabilistic modeling, allowing the system to infer user preferences even when partial data is available, ensuring that DNA-RS continues to provide relevant content.
   Real-Time Experience Tailoring with Machine Learning: The DNA-RS leverages these user inputs as part of a feedback loop with the Dynamic Layer Adjustment (DLA) and Contextual Predictive Modeling (CPM) systems. For instance, when a user explores a new city through an AR tour and repeatedly engages with historical content while marking it with green ratings, the DNA-RS flags this preference for deeper integration into subsequent experiences. This results in the DLA adjusting future AR overlays to prioritize historical sites or immersive SR scenarios that align with the user's indicated preferences.
   The DNA-RS's role extends beyond just enhancing individual experiences—it also informs the overall system's adaptive learning capabilities. By identifying patterns in user engagement across different contexts, DNA-RS contributes to a refined understanding of user behavior that improves Celeste Opera's ability to create highly tailored and engaging multi-plane reality experiences. For example, if DNA-RS detects that certain users prefer outdoor activities during training simulations, it could prompt the Dogon LARP Engine to generate more outdoor-themed narrative elements during group missions.
   Secured Data Management and Energy Efficiency: Data collected by DNA-RS is stored within the Celeste Quantum DB, where quantum flash searches enable rapid retrieval of user profiles and behavior patterns. This ensures that personalization updates can be applied quickly, even during active sessions, providing real-time adjustments without disrupting the user experience. Quantum encryption ensures that user data remains secure during transmission between DNA-RS, the Onyx Panther OS, and the broader AI Core. The energy requirements for running continuous user profile analysis are optimized through DNA-RS's coordination with energy-harvesting systems like HiSS (Holes in Soles System) footwear. As users move through physical spaces, the energy harvested is directed toward sustaining the processing power needed for real-time DNA-RS computations.
SoulTech: Neural Processing and Biometric Integration. SoulTech operates as a specialized neural processing subsystem within the Machine Learning (ML) Layer, designed to interpret and process real-time biometric data from integrated wearable technologies such as YAmaker and Vicci Wear. Its primary function is to ensure that the Celeste Opera can adapt digital interactions based on the user's psychological and neural state, providing a responsive and immersive experience across all perceptive reality layers.
   Neural Processing and Adaptation: At the heart of SoulTech is the Neural Processing Unit (NPU), a dedicated processor for managing complex neural data streams. The NPU within SoulTech is optimized for analyzing brainwave patterns, muscle activity, and other physiological signals, using advanced neural decoding algorithms to extract meaningful insights from these inputs.
      Real-Time Data Interpretation: The NPU processes incoming data from YAmaker's neural sensors, translating signals such as brainwave patterns and muscle contractions into actionable insights. For example, during a virtual training exercise, if the NPU detects an increase in alpha wave activity associated with relaxation, it can trigger adjustments in the virtual environment to increase cognitive challenges, keeping the user engaged and focused. Conversely, elevated beta waves indicating stress can lead to a reduction in task complexity, preventing user fatigue.
      Data Flow Integration with Celeste Opera: The biometric insights generated by the NPU are fed directly into the Celeste Opera system, allowing the AI Core to consider these inputs when adjusting scenarios, training modules, or interactive experiences. This data flow ensures that the user's mental and physical state is always considered in the adaptive processes, creating a personalized and fluid experience.
      Neural Feedback for Interaction: The NPU within SoulTech also enables neural feedback loops, allowing users to interact with digital elements through cognitive commands. By interpreting focus levels or directed thoughts, the NPU can adjust visual overlays or initiate specific actions within the digital environment. This is particularly valuable in hands-free or silent interactions during complex operations or immersive training scenarios, where users need to maintain focus without manually adjusting interfaces.
      Deep Neural Networks (DNNs) are applied to analyze biometric data such as brainwave patterns and muscle activity, providing actionable insights for real-time experience adaptation.
      Autoencoders help preprocess and compress high-dimensional neural data, ensuring efficient integration with the broader system without overloading it with raw data.
   Adaptive Biometric Processing and Energy Efficiency: SoulTech's integration of NPUs with other processing units, such as the Data Processing Unit (DPU) in the Onyx Panther OS, allows for real-time adjustments to user experiences based on physiological data while maintaining energy efficiency across the system.
      Coordinated Data Management: The NPU within SoulTech preprocesses biometric data at the edge, reducing the need for continuous data transmission to the central Celeste Quantum DB. The DPU further refines this data, aggregating it with environmental inputs from Skowl DS or Recon Bots, ensuring that all elements of the user's environment are considered in real-time adjustments. This layered data processing reduces latency, enabling rapid adaptation of digital overlays or training scenarios.
      Energy Optimization through Biometric Awareness: By analyzing user states, such as periods of low physical activity or mental rest, the NPU can signal the Onyx Panther OS to adjust power distribution across the system. For instance, during relaxation phases the SoulTech NPU can reduce power to high-intensity feedback mechanisms in Vicci Wear, conserving energy while maintaining essential sensor functions, as well as stimulating frequency healing to boost recovery.
E.g.
Now that Echo's FOB was synced to the first of three nodes, they continued forward, the AR trail marking the second relay point farther up the ridge. But as they closed in on the second relay point, the Candidate's HUD blinked. The Skowls had flagged something—movement beyond the ridge.
The Candidate quickly opened the Skowl feed, expanding the view in his HUD. Iconic idicia highlighting the point of interest.
Mecha Camp Detected: Analyzing . . .
Zooming in on the feed, the CPM system began running simulations of the camp's activity. A cluster of large, metallic structures appeared on his display, with multiple heat signatures moving in and out of view.
“Hold position,” the Candidate's SoulTech detected the instruction through the YAmaker and silently pushed it to all HUDs, the Atomic Planner picking up and signalling the area to rally. He watched as the Skowls continued to scan the area, they sent up the remaining two Skowls so that all four of their drones were scanning and layering live intel. All Skowl Drones Deployed: Multi-Layered Aerial Scanning Active

Celeste Opera Hardware and Integrations for Multi-Plane Reality Adjustment: The Celeste Opera system integrates a sophisticated array of hardware technologies and devices designed to deliver seamless, multi-plane reality experiences. These hardware systems, including biometric wearables, haptic feedback suits, user interfaces, drones, and autonomous bots, work in conjunction with quantum-enhanced data processing and real-time environmental interaction to create an adaptive and immersive digital landscape. Each piece of hardware, from aerial drones like Skowl DS to wearable systems like Vicci Wear and HiSS (Holes in Soles System), is optimized for interaction with multiple layers of reality (AR, MR, VR, SR, DR) through the Onyx Panther OS.

By leveraging the Onyx Panther OS, the system dynamically adjusts to the user's physiological data, physical movements, and environmental inputs, ensuring continuous engagement, safety, and immersion. The OrbTech infrastructure, including Extranet and Hyper-net Orbs, enables decentralized network communication, low-latency synchronization, and scalable power management, ensuring that these systems remain functional in off-grid or dislocated areas. Together, these integrated hardware systems form the backbone of the personalized, adaptive, multi-plane reality experiences central to the Celeste Opera architecture.
Skowl DS: Aerial Data Collection and Dynamic Environmental Interaction. The Skowl Drone System (Skowl DS) operates as a key aerial intelligence component within the Celeste Opera system, using its array of sensors-including LIDAR, high-resolution cameras, and thermal imaging—to gather real-time environmental data. This data feeds directly into the Onyx Panther OS, which then allocates it for processing to develop Layer adaptations, dynamic environmental adjustments, and real-time decision support.
Skowl Edge-Based Computation for Autonomous Navigation: Skowl DS autonomously adapts its flight path and sensor focus by using on-board edge based processing. The Accelerated Processing Unit (APU) within each drone performs real-time analysis of environmental conditions such as terrain structure, temperature variations, and movement. The drone can navigate around obstacles, adjust to changing weather patterns, and focus its sensors on key areas—all without the need for direct control from the Onyx Panther OS.
   Local Data Processing: Skowl DS minimizes latency by processing LIDAR and thermal data on-board, adjusting its path dynamically. This capability ensures optimal positioning for data collection, especially during time-sensitive operations like search and rescue missions, disaster management, and industrial inspections.
   Quantum-Enhanced Data Relay: Once collected, the data is compressed and transmitted to Hyper-net Orbs via quantum-entangled communication channels. This provides real-time updates to user AR interfaces and supports synchronized team based operations. The Onyx Panther OS dynamically integrates this data to adjust AR/MR overlays, highlighting critical areas such as unstable terrain, environmental risks, or mission-relevant zones.
   Paired Tracking: The Skowl is able to pair with a Vicci suit or device such as a wristlet which allows it to stay with a particular target over large distances.
Skowl Dynamic Mapping and Object Recognition: Skowl DS's Vision Processing Unit (VPU) allows it to conduct detailed object recognition, a crucial function for operations that demand high-level situational awareness.
   Advanced Object Recognition: Using pattern recognition algorithms such as SIFT (Scale-Invariant Feature Transform), the VPU analyzes visual data to identify specific features like heat signatures, structural weaknesses, and moving objects. This capability is critical for detecting survivors in disaster zones, monitoring industrial hazards, surveying large crowds for security, or providing environmental data in disconnected locations.
   Real-Time Integration with AR Displays: Through Neural Processing Units (NPUs) embedded in the Onyx Panther OS, Skowl DS data is integrated directly into user interfaces. AR displays can be updated instantaneously, highlighting critical objects or areas of interest. For instance, when Skowl DS detects a heat signature in a search operation, the NPU adjusts the AR interface to guide users toward the detected location, enabling first responders or field operatives to act swiftly.
Energy Integration for Continuous Operation: Designed for extended missions, Skowl DS uses multiple energy sources to ensure continuous functionality, especially in low power-supply environments.
   Optimized Solar Cells and Kinetic Harvesting: Solar cells with optimized materials for maximum conversion are integrated into the drone's frame to capture energy from sunlight, while kinetic energy harvesting systems convert the drone's movement and air into additional power. These sources are managed by the Onyx Panther OS, which allocates energy to critical functions like sensor arrays and communication modules based on real-time mission requirements. This, along with electron pumps, ensures the drone remains operational even in low-light environments such as forested areas or overcast weather.
Autonomous Bots: Specialized Ground-Level Data Collection and Task Automation. Within the Celeste Opera framework, Autonomous Bots perform crucial ground-based tasks such as terrain mapping, object retrieval, and infrastructure maintenance. These bots expand the Celeste Opera's ability to gather environmental data and interact with physical environments in situations where aerial systems, like Skowl DS, are less effective. Here are a few examples:
   Recon Bot: Environmental Survey and Terrain Mapping. The Recon Bot autonomously conducts environmental scans, creating detailed 3D terrain maps using LIDAR and thermal sensors. This bot functions as a ground-level counterpart to Skowl DS, extending data collection into subterranean or vegetation-dense areas.
   Autonomous Terrain Analysis: Equipped with an APU (accelerated processing unit), the Recon Bot processes LIDAR data on-site, allowing it to immediately adapt to new terrain features or detect elevation changes without needing constant oversight from Celeste Opera. This edge-based processing enables the bot to create detailed 3D terrain models that are relayed back to the Data Processing Unit (DPU) within the Onyx Panther OS, where they are integrated into multi-plane realities for AR/MR adjustments.
   Quantum-Enhanced Syncing: The bot transmits compressed terrain data via Extranet Orbs. By using mesh or quantum repeater networks, the Extranet Orbs ensure secure, real-time data synchronization, even in off-grid or challenging terrains. This allows for instantaneous updates to user environments, facilitating mission adjustments based on current terrain conditions.
   Sensory Applications: These bots can be of various styles; where Snake Bots are designed to slither along the ground for maximum deep ground penetration, ideal for IED and subterranean detection; other bots are more focused on rolling, crawling, or climbing along the ground-level, processing terrain mapping and surface details.
Carrier Bot: Autonomous Transport and Supply Delivery. The Carrier Bot is designed for autonomous transport of equipment, supplies, or samples across difficult terrain.
   Navigation Optimization: With an APU for real-time data processing, the Carrier Bot autonomously determines the most efficient routes through challenging landscapes. This ensures that mission-critical supplies, such as medical kits or technical equipment, are delivered on time, which may also have temperature or containment requirements, enhancing the reliability of off-grid operations.
Maintenance Bot: Infrastructure Inspection and Minor Repairs. Maintenance Bots are essential for infrastructure inspection and automated repairs, ensuring the continuity of operations in worksites or hazardous environments.
   AI-Driven Structural Analysis: The bot's VPU analyzes high-resolution imagery, detecting structural anomalies such as cracks, corrosion, or mechanical stress in physical structures. The DPU within the Onyx Panther OS processes this data, logging it for systematic inspections and facilitating repair interventions.
   Real-Time AR Integration: The maintenance data is overlaid onto AR displays, providing human operators with visual records of repairs and highlighting areas requiring additional attention. This creates a streamlined collaboration between automated systems and human oversight, as well as the bot's integration with LLM technologies to communicate directly with operators, improving efficiency and safety in difficult-to-access environments.
E.g.
The mecha camp was stirring with activity. The Candidate pulled up tactical data on his HUD.
Based on the data collected, the CPM system predicted multiple patrol routes around the camp, while the DLA adjusted the AR overlay to show potential paths forward. He sent the intel to Captain Stone back at the FOB and continued to evaluate their movements.
The Snake Bot continued to slither ahead of them, its sensors lighting up with thermal signatures. It detected an IED buried near the second relay point.
IED Detected: Neutralizing . . .
The Candidate synced to the snake bot's feed and watched as the Snake Bot worked, disarming the explosive with precision. The tension in the air was thick, but the Snake Bot gave the all-clear.
IED Neutralized: Safe to Proceed
The Atomic Planner prompted them “move with caution”, highlighting the pathway to the second objective networking point. As they proceeded the Candidate was reviewing the layered live feeds from the skowl—this might not be a normal patrol.
Just as he was analyzing the movements of the closest mecha, his feed was interrupted.
Snake Bot Alert: Subsurface Movement Detected
The Candidate's HUD updated instantly, projecting a 3D map of the underground tunnels stretching beneath them. The data was layered over the terrain, detecting heat signatures and showing the routes of the movement below.
Great, he thought. We're boxed in.
He knelt down, syncing his HUD with the rest of the team. The SoulTech system, sensing the growing tension, adjusted the HUD displays to keep everyone focused. The Atomic Planner was working with the data from the feeds, visualizing the DLA layers for optimal informed planning. Weighing options, it knew that the situation was becoming evidently dangerous, but if we didn't get that third relay up then we wouldn't be able to monitor this base from the FOB.
Wristlet: Interactive Display and Biometric Data Relay. The Wristlet acts as a portable interface and biometric relay, providing users with control over digital layers and real-time updates with digital interfaces or holographic projections.
   Gesture-Based Interaction and Display Control: Designed to offer tactile control and flexibility, the Wristlet allows users to adjust their experiences within multi-plane realities with simple gestures.
      Holographic Display with Gesture Recognition: The Wristlet includes a holographic display that projects interfaces within the user's line of sight. Gesture recognition technology enables navigation through system menus, adjusting AR overlays, or accessing mission-critical data. These inputs are processed by the LPU within the Onyx Panther OS, ensuring real-time execution of commands with minimal latency.
      Seamless Integration with Onyx Panther OS: Direct synchronization with the Onyx Panther OS allows the Wristlet to display real-time data from systems like Skowl DS, Recon Bots, and Extranet Orbs. Whether accessing environmental scans or biometric alerts, users are always equipped with up-to-the-minute information via the wearable display.
   Biometric Feedback and Real-Time Adjustments: The Wristlet integrates biometric data collected from YAmaker and Vicci Wear, ensuring continuous feedback within the digital environment.
      Heart Rate and Stress Monitoring: Equipped with biometric sensors, the Wristlet tracks key physiological metrics, such as heart rate and skin conductivity. The Onyx Panther OS dynamically adjusts digital layers in response to biometric data received.
      Body Energy: Powered by body heat and kinetic energy harvesting, lessening the load on the overall system.
DMT Tactile Control Ring: Compact Interface for Precision Control. The DMT (Decision Maker Technology) Tactile Control Ring offers users precise interaction capabilities in a discreet wearable form. It provides an intuitive tactile interface, ideal for environments requiring minimal physical movement or high focus.
   Precise Navigation and Control: The Tactile Control Ring allows subtle thumb-operated navigation, enabling real-time adjustments to digital elements without large or visible gestures.
      Tactile Input for Precision Adjustments: Users can scroll through digital interfaces, zoom in on AR elements, or adjust overlay transparency using the tactile area. Inputs from the ring are processed by the LPU (logic processing unit) within the Onyx Panther OS, ensuring that digital modifications occur in real-time with no perceptible lag, particularly in stealth or tactical operations where discrete control is essential.
   Quantum-Efficient Communication and Energy Management: The Tactile Control Ring integrates energy-efficient communication protocols to ensure reliable, low-latency input during extended missions.
      Quantum-Enhanced Data Transfer: The ring utilizes quantum communication to securely relay input data to the Onyx Panther OS. By eliminating input delay, the ring ensures that users can interact with the digital environment swiftly, even when managing complex or resource-intensive tasks.
      Energy Optimization via Extranet Orbs: By managing energy usage through decentralized resources, such as Extranet Orbs, the DMT Tactile Control Ring remains operational throughout extended missions, with minimal need for recharging.
E.g.
The Candidate watched the feeds from the Skowl Drones, all four of them now circling overhead, scanning the ridge and the valley beyond, the DLA and the LSM dynamically mapping and layering them for poignant insights. Their combined layers of aerial surveillance provided a detailed, multi-angled view of the mecha camp. He could see the faint outlines of heat signatures flickering within the metal structures and the slow, methodical movements of their patrols as he switched between feeds using his DMT ring. The feed from the snake bot being fed into the layers to show pockets of activity beneath the camp as well. His HUD continued to update, now showing a model view of the area, the CPM predicting patrol paths, while the Atomic Planner layered a map of possible engagement zones across the terrain.
Snake Bot Update: Subterrain Mecha Patrol Mobilizing.
The Candidate selected the VRAiT operational suggestion from the wristlet display to shift the drones to defensive positioning above, and with a flick of the wrist, The Onyx Panther OS executed the command, and the Skowl Drones adjusted their positions, forming a tighter aerial net around the team.
The Candidate's HUD flashed as the tactical grid came alive with possibilities, the VRAiT working with the Atomic Planner in real time. The CPM system continued running simulations, predicting enemy movements both above and below ground. The DLA adjusted the AR layers, highlighting cover points and possible routes for retreat, indicating that a tactical retreat was currently the best option.
Nothing from the FOB.
YAmaker: Adaptive Biometric Feedback and Neural Integration within Celeste Opera. YAmaker operates as a critical component within the Celeste Opera architecture, allowing for continuous, non-invasive biometric monitoring and real-time adaptation of user experiences across multiple layers of digital realities. YAmaker collects and processes neural and physiological data, ensuring that the user's cognitive and physical state dynamically influences digital environments. This system can be worn externally or via integrated wearables, seamlessly interfacing with other hardware elements managed by the Onyx Panther OS to deliver a personalized, responsive user experience.
   Non-Invasive Biometric Data Collection and Adaptive Feedback Loops: At its core, YAmaker employs a combination of advanced neural sensors and external biometric devices to continuously monitor the user's complete state. Rather than relying on invasive neural technology, YAmaker leverages surface-level sensors, skull to brain waves, and frequency tech to gather data on brainwave activity, heart rate variability, muscle tension, and stress levels. This non-invasive design ensures that users remain comfortable, while still benefiting from real-time adjustments to their immersive experiences.
      Neural Data Processing: YAmaker's sensors collect brainwave activity and neural signals, which are processed by the Neural Processing Unit (NPU) of SoulTech housed within the Onyx Panther OS. This real-time data informs system-wide adaptations.
   Seamless Interaction with Celeste Opera: YAmaker's data flows into the larger Celeste Opera system, enabling seamless integration between the user's biometric state and the adaptive digital layers. This ensures that all elements of the system—whether they are immersive storytelling elements within the Dogon LARP Engine, support from the VRAiT, or strategic mission adjustments managed by the Atomic Planner—respond fluidly to the user's current mental and physical condition.
      Quantum-Enhanced Feedback and Synchronization: YAmaker utilizes Intranet Orbs to relay biometric data securely, using quantum encryption. This ensures that user specific biometric data remains protected during transmission, especially in high-stakes environments such as telemedicine sessions or covert training missions. Through quantum flash transmission, this biometric data is synchronized with ongoing mission operations, enabling real-time adjustments to digital layers and responsive systems based on live physiological input.
   Non-Invasive Control through Neural Feedback Loops: YAmaker's neural feedback capabilities allow for a highly intuitive control interface. By interpreting cognitive signals, users can issue commands or make adjustments to digital elements in real time, without the need for manual input devices. This hands-free interface is particularly valuable during complex, high-focus operations, where hands-on manipulation of interfaces may not be possible.
      Neural Command Interpretation: The Logic Processing Unit (LPU) within the Onyx Panther OS translates neural commands detected by YAmaker into system actions. For instance, in a stealth mission scenario within the Dogon LARP Engine, a user can mentally command the system to reduce visual clutter in their HUD, helping them maintain focus on critical objectives without drawing attention to unnecessary distractions.
   Energy Integration and Power Efficiency: The non-invasive sensors within YAmaker are powered by thermoelectric generators that convert body heat into usable energy. This energy-efficient design allows for extended biometric monitoring without the need for frequent recharging, making YAmaker ideal for long-duration missions or extended training sessions.
Glass Panther: Adaptive Eyewear for Immersive HUD Integration. The Glass Panther suite provides advanced wearable HUD displays, including visors, glasses, and contact lenses, designed for seamless integration with the Onyx Panther OS. These devices enable real-time augmented overlays and visual effects, ensuring the synchronization of digital, augmented, and physical realities for enhanced situational awareness and interaction across all operational environments.
   Glass Panther Visor for Helmet: Augmented Tactical Integration. The Glass Panther Visor offers a robust HUD system integrated into tactical helmets, providing essential overlays in real-time.
      Dynamic HUD Display: Projects mission-critical data, navigation, and environmental analytics through the Onyx Panther OS, without obstructing visibility.
      AR/VR Support: Enables rapid transitions between augmented and virtual realities for tactical maps, biometric data, and holographic simulations.
      Adaptive Visibility and Biometric Feedback: Equipped with auto-tinting for optimal visibility and embedded sensors that monitor vitals, integrating biometric data into HUD for stress monitoring.
   Glass Panther Glasses: Portable HUD for Daily Use. The Glass Panther Glasses deliver HUD functionality in a lightweight, everyday format.
      Transparent HUD & Gesture Control: Displays real-time data overlays while enabling hands-free control via gestures and voice commands.
      Augmented Reality Integration: Supports AR overlays such as navigation aids and productivity tools, fully synced with the Onyx Panther OS.
      Biometric Sensors: Continuously monitor user vitals, allowing adaptive system responses based on stress or fatigue.
   Glass Panther Contact Lenses: Discreet AR Vision. The Glass Panther Contact Lenses offer discreet HUD functionality through micro-displays for subtle and immersive AR experiences.
      Micro-HUD Projection: Projects data directly onto the user's vision, ideal for covert operations.
      Eye-Tracking and Biometric Sensors: Track gaze and physiological indicators like pupil dilation, allowing real-time adjustments to the HUD.
      Full AR Capabilities: Supports AR overlays for mission-critical data, maintaining user engagement without external hardware.
   Quantum-Enhanced Synchronization: All Glass Panther devices use quantum flash transmission for ultra-low-latency data exchange, providing real-time updates through the Onyx Panther OS. This ensures that HUD displays remain fully synchronized with environmental and user inputs across augmented and physical realities.
   Energy Optimization for Wearables. Glass Panther Glasses and Contact Lenses are powered by ultra-efficient micro-batteries to ensure lightweight, long-lasting operation. Managed by the Onyx Panther OS, these devices optimize power for essential HUD functions. The glasses feature wireless charging for continuous use, while the contact lenses rely on low-power circuits to extend battery life without compromising performance.
E.g.
Given the new status of the situation, the team began backing down the hill, the mecha knew they were here but their team of four was severely outnumbered—his HUD began flashing as the Skowls picked up a surge of movement from the mechas. They were advancing now, the display mapping a trail heading straight for their position; subterranean forces moving towards their surface points.
The Candidate checked his weapon, his Vicci suit syncing with the weapon's systems to monitor ammo levels and heat output. “Stay focused,” the soft VRAiT voice said, the Candidate passing the command through the YAmaker system to everyone's HUD. His team—Dalton, Reyes, and Jennings—quickly formed a defensive formation, the Atomic Planner shifting the tactical grid in real time to optimize their positioning.
He knelt down, scanning the terrain. The Snake Bot continued sending data from the tunnels below. The mechas were moving fast, and there was no easy way out. The Candidate took a deep breath as the SoulTech system adjusted his HUD, providing subtle visual cues to help him focus. His adrenaline spiked, but the system kept his nerves steady.
Vicci Wear and HiSS: Adaptive Haptic Feedback and Sensory Immersion. Vicci Wear and HiSS (Holes in Soles System) are wearable systems that enhance user immersion through precise haptic feedback and sensory inputs. Integrated with the Celeste Opera system, these wearables create a multi-plane reality experience where physical sensations align with digital interactions. They enable users to bridge between real-world physicality and digital immersion.
   Real-Time Control of Haptic Feedback: Vicci Wear includes smart suits, gloves, and tactile interfaces that deliver adaptive haptic feedback. The system ensures that physical sensations match virtual experiences, adjusting dynamically based on user actions or environmental changes.
      Dynamic Haptic Adjustments: The Logic Processing Unit (LPU) within Vicci Wear, or connected Intra-net Orbs, manages real-time adjustments to vibration patterns, pressure levels, and thermal feedback across the fabric of the suit. For instance, during virtual strength training, the Onyx Panther OS detects increased exertion through biometric data from the YAmaker and increases the resistance felt by the user, simulating the sensation of lifting heavier weights with the Operational Justfit (OJ) gloves. This capability ensures a responsive feedback loop, enhancing user immersion and reinforcing the realism of the virtual environment.
      Quantum-Enhanced Coordination with YAmaker: The Onyx Panther OS leverages Quantum Processing Units (QPU) to synchronize data from YAmaker with Vicci Wear. When the system detects changes in physiological signals—such as increased heart rate or muscle tension—the Onyx Panther OS modulates haptic feedback to balance comfort with challenge. For example, during high intensity scenarios, the system can reduce haptic intensity to prevent user fatigue, while maintaining immersion in the multi-plane experience.
      Embedded Flexible Power Solutions: Vicci Wear incorporates flexible silver-zinc batteries, which are embedded within the suit's fabric to power its haptic feedback mechanisms, such as vibration motors and heat sensors. These batteries are lightweight and adaptive, ensuring that the suit conforms to the user's body while maintaining a consistent power supply, even during prolonged use.
HiSS (Holes in Soles System) Footwear: Tactile Feedback and Terrain Simulation. HiSS (Haptic and Intelligent Smart Shoes) provides precise location tracking and terrain-adaptive tactile feedback, enhancing the user's sense of presence in augmented and mixed reality environments. HiSS works closely with Vicci Wear to ensure that every step and movement in the physical world is reflected in the digital landscape.
   Terrain-Adaptive Feedback: HiSS (Haptic and Intelligent Smart Shoes) footwear is equipped with pressure sensors and vibration motors, allowing the system to simulate the textures of various surfaces, such as gravel, sand, or concrete. Terrain data gathered by Skowl DS is transmitted to the Onyx Panther OS, which adjusts the intensity and frequency of vibrations in the footwear. This gives users the sensation of walking on different terrains, enhancing their physical connection to the virtual environment.
   Recovery Frequencies: HiSS generates targeted frequencies to the sole of the foot to promote healing and energy distribution.
   Energy Harvesting for Continuous Functionality: HiSS (Holes in Soles System) integrates kinetic energy harvesting, generating power from user movements such as walking or running. This energy is stored within Intra-net Orbs or directed back to Vicci Wear, ensuring both systems remain operational during extended missions. The Onyx Panther OS dynamically manages energy flow between the two systems, balancing input from kinetic energy and the OrbTech.
Integrated Sensory Experience with Celeste Opera: Vicci Wear and HiSS form the sensory bridge between the user and the digital environment, ensuring that tactile feedback, physical interactions, and digital content remain perfectly aligned. This coordination creates a seamless integration between the user's physical actions and the digital world.
   Enhanced Tactile Feedback: Data collected by Skowl DS and Recon Bots is processed by the Onyx Panther OS, which adjusts the AR/MR overlays and sensory feedback provided by HiSS. For example, if the Skowl DS detects a shift in terrain during an exploration mission, the system immediately adjusts the vibration intensity in HiSS to simulate the changing surface conditions underfoot.
   Adaptive Learning in VRAiT: Vicci Wear and HiSS are crucial components in the VRAiT (Virtual Reality Adaptive Integration Training) modules. They allow users to develop muscle memory and physical responses to virtual scenarios through haptic feedback. The Atomic Planner uses data from these wearables to adjust training regimens in real time, ensuring the appropriate level of physical and cognitive challenge for each user. As users progress through training, the system evolves with them, offering a holistic learning environment that combines cognitive and physical development.
E.g.
The mecha are mobilizing. “We need to stall them,” the Candidate thought. He quickly issued commands to the Onyx Panther OS through his wristlet, deploying a set of small, aerial drones to position themselves as proximity charges along the most likely approach routes based on the system-identified paths, the Onyx Panther OS sending each bot the coordinates. His HUD displayed their placement in real-time, syncing with the Snake Bot's underground map to ensure the charges would be effective.
Suddenly, the first mecha broke through the ridge, its massive silhouette illuminated by the faint glow of the AR. The Candidate raised his energy rifle, his HUD locking onto the target. His Vicci suit adjusted the weapon's trajectory based on wind speed, distance, and the CPM's calculated weak points on the mecha's armor.
“Contact 9 o'clock!” Their HUDs swiftly adjusted target tracers and the team unleashed a volley of shots.
The mechas retaliated, their heavy weapons spitting fire into the dark. The Candidate's HUD tracked each incoming projectile, the DLA overlaying warnings, and projected impact points across the terrain. The VRAiT coordinated the team's movements, ensuring they stayed out of the direct line of fire; VRAiT was audible in their ears over the noise of metal and explosions.
But the mechas kept coming, their sheer size and firepower overwhelming. The Candidate gritted his teeth as his suit took a hit, the constriction system activating instantly. His Vicci suit tightened around his torso, Vicci Wear's occlusive wrapping protocols activating to apply pressure to stop the bleeding as his vitals plummeted.
Suit Integrity: 81%
Heart Rate: Elevated
As the pressure increased and the shots continued to fire all around him, the VRAiT system called the DNA-RS for input, then, pulling from the Candidate's Celeste Quantum DB suddenly the familiar voice of Coach Punsky, his old football coach was in his ear: “Get out there, boy, you're the strongest on the field”.
The Candidate pushed through the pain, firing off another round as the Skowls overhead relayed data directly into his HUD, tracking the mechas' every move. But there were too many of them, and his team was being pushed back.
“We're being overrun,” the Candidate thought. “We have to fall back.”
He instructed the team Atomic Planner to prompt the other three to get out of range, displaying new objectives and trails in their HUD.
Objective: Take the buggy and head back to the FOB-IMMEDIATELY Jennings hesitated. “You can't take them alone.”
“Just go!” the Candidate snapped, already preparing the next set of commands for his ground
bots. “I've got a BIP (Blow In Place) system, but I need you clear of the blast radius.” Once in the buggy, Dalton gave the unseen Candidate a tight nod, grabbing the wheel of the buggy. Reyes and Jennings provided cover fire as they retreated, their Skowls remaining over the Candidate's location until the range would call them back to their synced suits. But the Candidate was already moving—deploying his bots strategically around the ridge, laying down charges and preparing to BIP. He deployed the snake bot as a charge to the interior of one of the tunnels, able to move past the mecha undetected.
Just then, a second hit knocked him back, his Vicci suit's constriction protocols kicking in again, this time around his left leg as his vitals dropped further. His breathing was becoming labored, his vision blurring, but the VRAiT system refused to let him stop, the sweet voice of his daughter, echoed through his mind. “Get up, Daddy,” she said “come home.”
He stumbled forward, watching the timer on his HUD tick down, the three additional skowls had pulled off, checking the distance of the buggy his skowl sent its final update—the mechas were closing in, fast.
“Get clear,” he whispered into the comms, his voice barely audible now. He glanced at the BIP system, the detonation sequence ready, charges mapped out-visible over the HUD, and synchronized with his suit.
As the Atomic Planner synced the team's location with the countdown, his HUD displayed the final tactical feed. His vitals were failing, but the VRAiT worked with the SoulTech system to bring one last vision to his mind—the voice of his grandfather now, firm and assuring. “You know what to do, son.”
The Candidate exhaled slowly as the mecha were converging in around him. He pressed his ring.
And as he exhaled “for America”, the mountain came down: the world lit up white.

Celeste Opera System Intelligence and Data Analysis Layer. Further, the Celeste Opera system intelligence and data analysis layer is for integrating behavioral, environmental, and operational insights. The Data Analysis & Intelligence subsystems of the Celeste Opera ML Layer incorporate three core intelligence subsystems—Behavioral Intelligence (BI), Environmental Intelligence (EI), and Operational Intelligence (OI). These subsystems operate in tandem with the Neural Processing Unit (NPU) to provide real-time adaptive feedback to Celeste Opera's core functions (AI Core, VRAiT, Dogon LARP, Atomic Planner, LSM). This integration ensures a dynamically adjusted experience that aligns digital interactions with the user's behavior, environment, and physical activities, all while contributing to the seamless functioning of multi-plane realities.
Behavioral Intelligence (BI): Adaptive Emotional and Cognitive Analysis. BI is the psychological and emotional dimension of the ML Layer, using advanced data analysis methods to interpret the user's cognitive and emotional state. By continuously analyzing biometric data—such as heart rate, skin conductivity, and neural activity—BI adapts the digital experience to match the user's current mental state, feeding SoulTech through the ML Layer. This allows for a personalized adjustment of experience.
   Integration with DNA-RS: BI works closely with the DNA Rating System (DNA-RS), which builds a comprehensive user profile based on both real-time biometric feedback and long-term interaction data.
   Neural Feedback and Adaptation: BI relies on data processed through the NPU, interpreting signals like neural responses detected by YAmaker. This data helps the system to make in-the-moment adjustments, such as altering the visual complexity of a digital environment or modifying the haptic feedback delivered through Vicci Wear. This interplay ensures that the user's mental state directly influences their digital experience, keeping the interface intuitive and the immersion deep.
Environmental Intelligence (EI): Adapting Layers to External Conditions. EI serves as the system's adaptive component for managing user interactions based on their physical environment. This includes the capture and processing of external conditions—like temperature, light, and location—as well as user-specific conditions detected through wearables like HiSS. By synthesizing data from both the user's surroundings and their immediate environment, EI adjusts the presentation of AR, MR, VR, or DR layers to ensure a seamless and contextually appropriate experience.
   Integration with the Layer Synchronization Module (LSM): EI provides the LSM through the ML Layer with real-time data regarding environmental changes, enabling rapid adjustments to digital overlays and visual effects. For example, during an AR LARP session, EI can detect shifts in outdoor lighting and adapt the AR visuals to match, creating a more cohesive blend of real and virtual elements. Similarly, in industrial applications, EI monitors environmental conditions such as air quality or temperature and adjusts the digital interface accordingly to keep users aware of potential safety concerns.
   Wearable Feedback and Sensory Adjustment: Devices like Skowl DS, Vicci Wear, and smart suits provide EI with continuous feedback on user-specific environmental conditions. This allows for personalized adjustments, such as changing the cooling effect of the smart suit when a rise in temperature is detected. The NPU processes these feedback loops, coordinating between EI's data inputs and the tactile adjustments made by wearables, thereby ensuring that physical sensations mirror the digital experience.
Operational Intelligence (OI): Physical Interactions and Tactile Feedback. The OI is focused on interpreting user movements and physical interactions with the environment, using this data to adjust the digital experience in real time. This subsystem not only ensures that user gestures are accurately translated into the digital world but also manages the generation and distribution of power through kinetic energy harvesting, ensuring the system remains functional during extended activities.
   Gesture Recognition and Motion Adaptation: OI captures detailed motion data through integrated sensors, translating user movements into digital actions. For instance, in a virtual sword-fighting scenario, OI detects the user's arm movements and adjusts the virtual weapon's weight and resistance accordingly, creating a realistic sense of handling. The NPU processes this motion data in real-time, aligning it with the system's digital physics engine to create a responsive and natural interaction experience.
   Advanced Tactile Feedback Systems: OI manages the system's non-contact haptic feedback technologies, such as ultrasound wave generators and hard holograms. These technologies create immersive feedback, allowing users to “feel” virtual objects or surfaces without direct contact. For example, when a user interacts with a hard hologram in MR, OI adjusts the ultrasound feedback to simulate the texture and solidity of the object. This precise control over tactile feedback enhances the sense of immersion, making virtual interactions more intuitive and engaging.
   Energy Optimization through Kinetic Feedback: OI also plays a key role in managing the power generated by movement-based devices like HiSS. By tracking user activity, OI ensures that energy harvested from walking or running is efficiently distributed to power the feedback systems or other components of the Celeste Opera system. This allows for longer operation times and reduces the need for external power sources, making the system particularly suitable for remote operations or extended training sessions.
Building on the synergy between these intelligence subsystems, the Celeste Opera system further enhances its capabilities through an unprecedented level of data integration and analysis. The Celeste Opera system is a transformative method and system for creating Dynamic Multiplane Realities, where multiple perception layers are seamlessly integrated and can operate concurrently within a single environment. Powered by the Onyx Panther OS, this innovative system allows users to interact with digital, augmented, mixed, virtual, and simulated realities simultaneously, creating an immersive and highly personalized experience. The system continuously adapts to real-time user preferences, biometric data, and environmental feedback, ensuring a fluid interaction between physical and digital elements.
Moreover, the Celeste Quantum DB, which enables rapid data retrieval through quantum flash searches, allows the system to quickly aggregate and analyze persistent data tethered to specific points of interest, such as locations, topics, or user groups. The data is then mapped into multilayered visualizations that reveal hotspots, behavioral patterns, activity trails, and environmental interactions. This intelligence is used to optimize future interactions, tailor content delivery, and enhance the system's adaptability; furthering analysis-driven strategy and suggestions. Paired with OrbTech networking, the system ensures continuous accessibility across multiple environments and network types, even in off-grid scenarios, where off-grid extranet orbs can be remotely updated through the OrbTech networking system.
By combining multi-plane reality integration with advanced quantum data analysis, adaptive networking solutions, and real-time personalization, Celeste Opera evolves with every user interaction. It provides unparalleled adaptability and intelligent decision-making, all while delivering a cohesive multi-layered experience that spans both the physical and digital realms. This synergy of immersive technology and data-driven intelligence positions the Celeste Opera system as a pioneering solution for the future of dynamic, personalized, and accessible digital experiences.
E.g.
The world was white.
No sound, no movement—just an infinite expanse of light.
Then . . .
Slowly, text began appearing across the whiteness, lines of data scrolling through his vision.
Recording and Uploading Data . . .
Environmental Intelligence (EI): Terrain captured, threat analysis complete. Behavioral Intelligence (BI): Combat decision-making recorded, emotional resilience logged.
Operational Intelligence (OI): Tactical engagement, resource management, and mission execution uploaded.
Uploading to Celeste Quantum DB . . .
Syncing with Extranet Orbs for future training and mission simulations . . .
Data continued to stream past. His movements, his choices, every moment of the mission now captured, stored in the Extranet, ready to be used to train others.
Vitals Stabilizing . . .
Mission: Complete
XP Gained: +14,761
Belt Level: Increased to Onyx
Remaining Suit Integrity: 28%
Heart Rate: Regulating
Team Status: Safe
The data compressed, bundling into a single file: Candidate 325 and then added it to a section called The Pantheon.
For a moment, the world was still.
Then, with a faint hiss, the door opened, and the white became reality. Jackson blinked as his eyes adjusted to the lights coming on the simulator room. The soft, sterile hum of the chamber washed over him. He took a deep breath, removed the YAmaker, and stepped forwards, his Vicci suit relaxing as it powered down.
“Well done, Jackson,” a voice said from across the room.
“Thank you, sir,” Jackson replied, glancing toward the instructor. The man stood next to a console, reviewing the data feed from the simulation. “We'll be able to train the next batch of ground-level bots on this one,” the instructor added, nodding approvingly.
Jackson nodded back, feeling the weight of the mission finally lift as he exited the training simulator. The adrenaline still buzzed faintly in his veins, but it was different now—calmer, knowing it had been a simulation.
As he emerged mid way through a long hall, he walked towards the exit; doors lined both sides, each labeled with a different scenario,
Trauma Recovery
Underground Warfare
Marine Kingdom Insurgency
Marshall Lockdown
AMP Repeater Zombie Outbreak
Subterranean Reptilian Warfare
Polar Vortex
Firestorm Field Medic
The main door at the end of the hall stood ahead, glowing soft blue beneath the sign above it. In thick black letters, it read: Dogon Games—Training You in Less Time.

Further, the present disclosure describes a Celestification System for facilitating tailoring experiences of users. Further, Celestification is a system to redefine and completely redirect the functionality of a computer implemented, technology-based social networking platform. Such that a User of Celeste would be encouraged to leverage their interaction with the computer implemented method/system to augment their own reality in such a way that the User's preferences would be clearly reflected in real time across all active worlds, be it virtual, digital, real, augmented or any other realm of reality capable of responding to imagery adjustments made to the frameworks of perception.

The Celestification system proposes a fully integrated, multi-dimensional, interactive, and dynamic method to engage Users in their own custom tailored world. Where the User will be able to determine their own version of the system through their personal preferences at the moment, adjustable in real time, to the extent of API portals and system operations. Where the User will be able to adjust the active layers of data, imagery, and perception in their own personal world, thereby adjusting the features, elements, and overall system operation as it relates to the Users personal preferences through API and functionality portals represented by visual indicia in real time. This is accomplished through a network of integrated feature-portals staked to a multi-faceted encryption system, adjustable in real time based on the User indications directly, indirectly, and/or inferred, which will be further backed by trustless consensus protocols, smart contracts, deployable algorithms, and decentralized networking.

Celestification uses several integrated methods to tokenize and convert elements of the real world, physical objects, virtual objects, social interactions, digital processes. Furthermore, social contracts and processes such as purchasing products, providing services, networking, exchanging, tracking live activity data and the like; applying sensors and processing units to digitize the information seen or unseen (prediction AI) into data that can be further processed and implemented into a layered multi-dimensional interactive dynamic map-matrix system.

Where the map-matrix system will be superimposed over any visual interface capable of supporting layers of visually indicative information individually or stacked, this is not limited to a geo-spacial map, but rather map as a construct of visual information displays that may interact with one or more layers of datafied elemental information as it relates to the real world and/or virtual world events in real time. Where an event is considered any action capable of detection by the system that can impact the system based on the event detection and subsequent response of computerized event listeners, triggering a series of networked response systems accordingly.

Celestification comprises the technical functionality of a system capable of bringing the real world into the digital realm, and simultaneously impress technological functionality upon the physical environment, in real time, as the User of the system engages with the iconic filtering system programmatic language, essentially an application user interphase for the world.

The Celestification of the Users reality provides the ability to control the analog world and real world environments, based on User preferences, in real time, predicated on points, and belt level. Whereby, the User can engage the system to optimize their circumstances at present through the User selection, activation, deactivation, and/or pin of any iconic filtering element which includes any of an API portal, custom content, gamified element, or functional operation; such that the system will be influenced to operate in a manner, respective to the User's indicated preferences at present.

Celestification enables the User to leverage their environment in multiple realms and/or frames of reality with simultaneous effect as a result of the Celestification of physical, digital, augmented, and virtual elements; as they pertain to the Users indicated preferences. Thereby providing the framework for the User to create custom worlds, networks and elements therein to form axiom map layers that will thereafter be applied in series to a datafied map matrix infrastructure. Where a map will be considered any visual interface capable of displaying one or more layers of visual data based on the system operations as indicated by the User's preferences; map-matrix. Where the visual data will be viewed with or without extensive physical hardware such as mobile devices, laptops, or tablets; rather the visual data can be interacted with, acted upon, or viewed in an augmented real world hybridized reality using the DMT (decision maker technology) suite, digital avatars, and augmented interactive indicia.

The system is targeted to Users capable of interacting with the system in such a way that the system will be able to respond to the User and in doing so generate a custom reality for the User based on their preferences as indicated directly, indirectly, or inferred of the User based on their engagement and interaction with the system. Where their interaction may alter their reality instantaneously, based on real time feedback to any action, event, or data packet of consequence. Where the system can further augment the Users' experience based on data collected from environmental sensors, Beartooth dongle, hardware, and activity data collectors. This may then further allow the User to hybridize their digital and real world realities into their select perspective based on User Preferences, Avatar Interaction, Live Activity Data, and Active Map-Matrix Layers/Portals.

I. Celestified Map-Matrix System: The Celestified map-matrix is used as a canvas to enable the multidimensional layer formation of the Celestification system to superimpose a gameplan of functional elements based on the Users' indicated preferences using dimensional programming and calculations such as spiroidal programming with real time processing. Where the functional iconic data packets can contribute to the interactivity and overall functionality of the system, further according to the Users' specifications and the subsequent system modifications as a result.

The map-matrix system is composed of one or more layers of datafied information and/or functional portals as they are indicated by the User through their direct interaction with the filtering system and/or indirectly through their inferred preferences as understood by their User experience data and activity data. Where map layers can be datafied through three dimensional programming for GPU processing to produce functional node map layers and GUI elements capable of spiroidal rendering dynamics.

Further, this system of data layering allows for the User to visualize the elements of “their world” through a visual indicia map, which is not limited to the static understanding of a map depicting geo-location or the basic understanding of physics. Rather, the map matrix is indicative of the collaboration of visual elements layered into a visual matrix that will indicate a plurality of functions, or otherwise, in a dynamic visual representation of both macro and micro system operations. Where the operations can be interacted with in any of a virtual, visual, physical, augmented, or digital manner, which may be further automated, artificial, simulated, or Else, where potential actions can include any of a prompt, layer, function, element or event to be triggered for the User and/or the system to engage.

Should the engagement matrix be satisfied, the map will produce interactive representation(s) of the backend preferences such that the User will be able to see, hear and/or feel their preferences in real time within the virtual matrix, and/or the physical realm. Allowing for them to simultaneously interact with the digital platform and the real analog world, in real time, based on their preferences for what their worldview should represent.

The Celestification process will allow for the datafied elements of the real world to become digital assets in the system, such that the elements would now be able to be acted upon as a digital element, that can also have real world consequences. This provides a plurality of opportunities to maximize the effect of User data on the system, the datafied elements, the network, and the overall operation, where the User may build out new elements, trigger event listeners, network several event nodes, connect event nodes in a series operation; where a subsequent series of event listers will trigger a multitude of responses, zoom out into Skyview of unlocked locations, drop into zones as an avatar, etc. such that a User can engage the digital reality and real world happenings in simultaneous activity streams of virtual avatar interaction and real world datafication.

Where Celestification signifies a Users ability to create and engage in experiences across multiple realities, with feedback response loops and real time consequences based on gamified governance rewards matrices, as further impacted by the active layers within the map-matrix as determined by any of the User Preferences indicated and/or User system interaction.

II. Opportunistic Datafied Mapping Techniques: Opportunistic datafied mapping allows for the Celestified map-matrix system to prioritize the User experience in regard to how the map may be interacted with. Where a map can be viewed as a gameplan, a game board, a geo map, blueprint, 3d model, a web of nodes, or the like, such that a User would be able to activate data packets that have been dispensed, and/or layer element functionality for optimal User experience and system operation. Where hardware integrations will further enhance the system operation, though is not required to be hardware-centric.

The opportunistic datafied map-matrix system further provides gamified User access to caches of data packets, deep links and node connectivity, trail networks, genie filters, smart API portals, personal augmentation, real time datafication and/or streaming, imbedded packets of information, connection, gamified rewards, challenges and the like, where the User may be able to activate one or more elements through gamification interaction-detection worldwide event listeners and further convert their selection to a functional layer within the map-matrix.

Opportunistic datafied mapping enables elements to be triggered based on opportunity, perception, and/or threshold, where the element may be activated by a predetermined setting, such that a User will either have to satisfy a threshold barrier or interact in a way that the opportunistic element is predicated to operate. In doing so, the map would respond to the Users' interaction beyond direct filtering, such that the Users' interactivity with the system would produce calculable results that may be weighted against the element's opportunity and/or threshold matrix.

Where a User may trigger an element by triggering an event listener to prompt an event to occur, where the User can then receive real time feedback from the system as it relates to the event, and/or technical element operation. A myriad of potential triggers can stimulate an event listener to modify the map matrix based on a User interacting with the opportunistic mapping system, such as geo location, level, network connections, virtual location, or otherwise, where a User can alter their interaction in any manner that may affect the system, which may, in some cases trigger a system response; event.

Further interaction with the system, would provide additional data of physical assets, behaviors, usage patterns, network connections, interpersonal or business relations, preference of use, proof of work, proof of object, proof of space and time, and ultimately predictability matrices as they relate to the User and their preferences, patterns of preference or deduced trajectory of preference. Whereby, the system can link a series of worldwide event listeners, data packets, and smart profile rewards to accommodate, direct, or compliantly adjust the Users' experience according to their smart profile data matrix, which is based on their interaction; direct, indirect, or inferred.

Furthermore, these elements will be linked to events/event listeners that are most suited to the User based on their interaction, preferences, and access level. Where gamified elements will be triggered according to the User's interaction with the system, prompting the User to interact further for gamified rewards of physical assets, virtual assets, access, mood, or otherwise rewarding behavior. Though, they will only be prompted by events that their assigned event listeners are keyed into, whereby the User won't be bothered by events that are not suited to their User preferences or interaction(s); where an event is any point of action, triggered and pushed to a User, without any dependency on physical location, theme or person, though in some cases any of the aforementioned may be involved should it satisfy the Users interaction type/preferences.

Where the events are further determined based on the User active layer matrices, where the layers and activated events are able to save the User data space, and thereby create a faster and more efficient system without the extra junk data floating around that the User is not interested in and/or does not directly benefit the User or the system according to their indicated User preferences. Thereby streamlining the system through constant machine compression to operate more efficiently, even when a User has activated several Layers[Portals/API's/Features/Functions] into their User map-matrix system because the system is only prioritizing that which is necessary to operate or was otherwise indicated directly, indirectly, or inferred based on User preferences.

Any relevant information regarding the Users preference(s) is then relayed to the opportunistic mapping system, where links, nodes, events, data packets, layers, API portals, visual indicia, networks, or other interactive, gamified elements can be adjusted to better suit the User according to their interaction. Providing the User with a visual map matrix, reflective of their patterns of usage, gamified achievements, indicated preferences, activated portals, themes, network choice, connectivity, and preferred use at that time i.e challenges, other Users, trails, iconic indicia, visual indicia, points of action, mood gauge and/or interest currently relevant to the User. Where the User can interact in real time. Further, the User can also stash the map-matrix data in a geo-cache or on a Beartooth dongle to support offline access or future download.

III. Gamified Smart Profiles: Users of a Celestification system implementation will be operating through their User profile, the Celestification of such profiles would enable the User to engage with the system through a process of gamification methods. Whereby the User will be encouraged to interact with the system to gain platform rewards through the incentivization matrix.

As a result, Users will be prompted to engage with system elements to earn incentives that can be tailored to the Users indicated preferences, such that; a User will be able to excel through the system in a manner that is best suited to their personal objectives according to their accomplishments/rewards. In this case, the User may be prompted to follow certain objective pathways that can lead to their advancement through the network, increasing their value within the system.

For example, a Celestified profile would engage with a plurality of gamified system elements such as:

Belt Levels: Indicating a Users overall system rating and the access granted to the User according to their belt level. Belt's are color coded indicators of a Users ability to interact with the system, their performance threshold, and the Users system access. As a User levels up, so does the User's ability to interact with the system, through more portals, features, elements, and increased functionality based on their Belt level.

Feedback Ratings (LOOP): Feedback loops to rank, categorize, and organize User profiles based on the Users' overall effectiveness within the system. Where their effectiveness will be determined by their category, experience/XP (experience points), belt level, or pathway, as it relates to the overall Celestified ecosystem and the Users' interaction accordingly. Feedback loops assist with Real time responsiveness and personalized accuracy.

Rewards: The Gamified Governance system uses a rewards matrix to incentivize User's interaction according to their User preferences, active layers, pathways, etc. Whereby a User will be incentivized to interact with the system to produce a result that will then be rewarded to gamification methods such as points, badges, access, tools, tokens, keys, mission levels, connection, or otherwise gamified methods of incentivization for User interaction. Where these rewards matrices are dynamic and develop actionable elements that can be further aggregated or applied to augment the User experience.

Badges: indicators of User experience, skills, networks, clubs, access, or the like, where a User can earn badges to prove a multitude of forms of their accomplishments. Badges may grant Users access or increase their ratings, or augment their experience through rewards matrices tied to the badge accomplishment(s), unlock special challenges, or hidden keys.

Pathways and/or Trails: Series indicators of nodes to trigger User responsiveness and interaction towards a task, mission, or goal. Where a node series (pathway/trail) can be created by Users (influencers or trail blazers) or by the system as either customized series (pathways) or populated series (trails) that can be pushed to the User or select public respectively. In either case, node series will be micro or macro in scale, where Users can accomplish a short mission, or a complex multi-mission objective, both are gamified with incentives, task markers, ratings, and the like to engage the User throughout the series. Completion of a node series would yield rewards for the User, and where applicable, for the creator (e.g., AD revenue, data mining).

Joux Points and Experience Points: A points system is integrated to track the Users' interaction as they rank up, as other rewards require a higher threshold of achievement, the User will more readily be able to earn points through their interaction, and therefore is measurable with greater frequency. Joux points are indicative of a value system that will be earned, bought, or exchanged, joux can be used as currency or traded for and/or staked as currency in basket currency systems. Whereas, Experience points (XP) are earned for interacting with the system, where Users will gain experience points based on their experience(s). Experience points can be converted to joux at an exchange rate through do not hold a currency value for outside exchange otherwise. Rather, the experience points value is primarily towards contributing to the User's ability to level up, earn rewards, and trade for gamified tools or access.

Potential benefits of Celestified smart profiles would include providing Users with incentives to engage and remain active within the system matrices to increase User productivity, and therefrom, through a series of interconnected rewarding feedback loops allowing user access, wherein user access may pertain to the user's ability to interact with the system in any of the digital, virtual, or physical world realms that the system actively engages in, and wherein the user can be incentivized to level up through accomplishments to increase access to elements such as content and connectivity.

Content: The element of content may pertain to elements such as influencer campaigns and the elements therein, trails and the elements therein, streams, communication elements, as well as access to portals, icons, and dimensional layering capabilities.

Connectivity: The element of connectivity establishes the threshold of the User's ability to connect, network, and interact within the system. The more access the User is awarded, the greater their ability to make connections with the interactive elements of the system such as augmentation, communication, as well as access to projects, funding, workshops, networking opportunities, contracts, zones, caches, and other exclusive content.

By modulating the Users access based on their level of interaction and achievement, the User will be better able to maximize their time, only engaging in what is applicable to them, or indicated by them, or potentially beneficial for their advancement in the system, or otherwise capable of improving the Users personal experience.

Two main elements determining what is unlocked regarding User access are the User's accomplishments and the User's indicated pathway(s). This allows for the User's experience to remain personal to the preferences indicated, which also means that each User can have a different perception of leveling up, and accessibility.

Accomplishments: The Users' accomplishments are determined by their ability to complete an action within the system, whereby an event will be triggered of consequence to said action. This is a responsibility of the incentives and rewards feedback matrix, which applies gamification to the accomplishment-reward feedback system, in real time. Accomplishments may include completing a task, milestone, or challenge, and any elemental feedback therein such as location verification, operation verification, connection verification, and/or the like. For instance, if a User were to accomplish the first three tasks pushed for adding team members to the network, they can achieve a milestone badge like “novice recruiter”; with this accomplishment, the User may also receive access to a communications board that promotes business networking and a free networking seminar streamed to other “novice recruiters”, should the User complete this seminar and network with other people therein the User can achieve a new accomplishment, and so on; increasing their access based on accomplishments.

Indicated Pathways: A pathway is considered a pattern of behavior noted based on the User's interaction and indicated preferences. Such that, a User is to use the system to suit their interests, these interests are liable to align into a recognizable pattern, this pattern can then be categorized based on common trends into a pathway with predictable future momentum and therefore calculated opportunity for upward mobility. For instance, a User may be showing indications that they are interested in technology and development, this User has completed contracts, attended seminars, and networked with other tech-minded people, working themselves into a higher belt level standing and therefore was awarded greater access. Should the system recognize that this Users pattern of use indicates a pathway that is geared towards technology and development, the User can be promoted activities and events that would advance the Users potential future growth; such as attending an exclusive tech conference or being invited to compete in a hackathon or join a novice tech business networking group.

Pathways and Trails: A pathway is an indicated trajectory of the User's interaction. Where a User will be prompted to follow a series of nodes/events “pathway”, wherein the User will happen upon challenges, opportunities, and achievement nodes that the User can interact with to potentially satisfy and continue to move forward thereafter towards the Users objective(s). A pathway is intended to satisfy a Users objective through a series of tasks and milestones, where the Users achievements, interaction, and dynamic profile metrics are recorded, and upon satisfying the threshold to surpass the current node(s), the User will progress to the following in series. If there is more than one option for the User to choose from, upon completing the current node, the User will be prompted to choose their next mission (e.g., task or milestone; where the completion of an indicated challenge, event, or action is required to satisfy a task, and multiple tasks make up categorical milestones, with multiple milestones making up an objective, and one or more objectives contributing to a Users pathway).

The User pathway system will promote their interaction with the system, such that they can receive gamified rewards, unlock new nodes, and decide their own trajectories, whilst still being able to reference the system evaluation metrics on which node would be best suited to the User based on their smart profile data (e.g., their interaction data, recorded User preferences, patterns of use, historical data cache and gamification trajectories). Where for example; a User may satisfy a node in their pathway, and looking to move forward is presented with three potential options (as an example, for there could be one option or a plurality of options), which could be any relevant element event that would prompt User action to satisfy in any of the real worlds, virtual reality, digital world and/or augmented reality node threshold. Upon being presented with the three node-trajectories, the User can select any one of them to learn more about the node's requirements for satisfaction, which can include a description of the node, difficulty level, commitment level, cost, a realm of action, potential embedded rewards (e.g., gamification metrics such as level, badges, joux, themes and the like) and potential benefit, such as how the node will affect the Users objective(s) and/or their User profile, such as their belt level, access or other profile ratings, visually displayed (e.g., in a character development story board tree).

Whereas, a trail is an indicated network of nodes connected by another User (influencer/trailblazer) or the system (as a direct push, embedded trail, or cached/exclusive/hidden trail) for Users thereafter to follow and potentially complete the trail. In the case of User-generated content, the trail is established by a User of higher belt level, often referred to as an influencer or a trail blazer, though this is not required; titles and tags are gamified elements rewarded to Users who focus their engagement on producing User generated content, networking, and have interacted in their pathway(s) enough to satisfy a high enough belt level to earn the title(s), tag(s) and/or badge(s) required for a higher status in the system. Though trails or elements of a trail can be logged by Users without these tags, however, the rewards will not necessarily be provided to them until they are qualified. For Example; three Users would like to generate node content, (1) is a new User who doesn't have the credentials for node establishment, but flags a point of interest for the system to look into/send an influencer to validate, (2) is a business owner, who can verify their business, and post it as a node, with relevant challenges or node actions related to their business, (3) is a well established User with influencer credentials and a high belt level, therefore this User can create entire node series/trails for other Users to follow.—these are three general examples of User standing in node creation of many, and restrictions will be placed depending on the User's level and allowance metrics.

A trail may be indicated as any combination of nodes, connected to produce a node map snake_trail that will be interacted with by the User in series or otherwise. Where a node can pertain to any event; challenges, venues, locations, tasks, objectives, beacons, or any other event that may be detected based on User interaction. Node maps are generated based on trail blazer interaction, where the trail blazer can indicate any node-worthy elements to be implemented into the network of node-events; where an event is indicative of any action detectable by a computer implemented system through integrated event listeners, and/or event handlers. Where difficulty level, commitment level, cost, a realm of action, potential embedded rewards (e.g., gamification metrics such as level, badges, joux, XP, themes, and the like), and potential benefit can be pushed to a User to promote the trail.

Further, Trail Blazers are influencers capable of producing custom content, which may include any actionable events as nodes in a node-event network, producing a node map that can then be applied to one or more of a User map-matrix layers. These trails can be applied to the Users map, where a User will interact with the trail directly as an outing pre-set or allow it to generate as the User crosses the radii trip wire established by the trail in either geolocation, a digital location, or in accordance with a point of threshold (by the Users live activity data, avatar movement, or interaction rewards respectively).

Trail as a pre-set: this indicates a node series of events, activities, and challenges combined into an outing that User(s) will engage in as a mission and/or challenge and/or theme oriented outing amongst one or more Users that may be participating individually or as a group. Where an outing is a series of actionable events, in any of the digital, augmented, or real world elements indicated by the corresponding event node(s).

Trail generated: this indicates that a User may have one or more trails active in their map layers. Such that, the User can receive a push notification, corresponding to an event action as it was triggered by the Users interaction. Where a trigger pertains to a physical, digital, or threshold point of action, such that an event listener would be triggered based on User interaction to generate a prompt for User interaction with the trail node event.

Further, trail blazers will be incentivized for the creation and maintenance of trails. Where a trail node can also include gamified elements such as hidden tickets, tokens, targeted Ads, targeted rewards, completion incentives, purchase-oriented nodes, augmented Ads, games, and/or the like whereby the trail blazer can earn a commission incentive based on the node activity (e.g., the number of participants).

Further, trail blazers and influencers can also be incentivized to push their iconic preferences in addition to their trails, where other Users can download the trail blazer/influencers preference array and trails into the Users preference array/trail layers so that they will download the experience matrix and live the life of said trail blazer/influencer. Again, trail blazers and influencers may receive a commission based on their engagement level and a number of downloads generated by their trail(s) and/or preference array(s).

Further, the aforementioned elements of a trial can be implemented in a real time experience hosted by an influencer, or the creator of the trail whether that is a User, Influencer, or System. Such that the real time experience will provide the Users with a live stream that can be further augmented with integrated stream augmentation features, and/or embedded incentives that can be augmented. Where these features may prompt a User to engage with the Influencer such that the User can provide feedback through a series of actions, indicating their position to the real time experience; for example, a User may be prompted by a geo fence to view a stream relevant to their current location (or the location of their avatar), pushed by an Influencer, should the User choose to engage with this live stream they can, in this example, encounter interactive elements such as RYG lighting, augmented surveys or polls, gamified participation feedback loops and virtual maps, trail incentives and/or augmented smart ADs; targeting the User based on their direct and/or indirect interaction such that their preferences, location or otherwise can trigger an augmented AD.

In terms of activity data, the Celestification system will incorporate datafication protocols to integrate physical elements, experiences, and actions into the virtual matrix within the digital system, moreover providing the physical reality with digital, virtual, holographic, or otherwise technologically generated and/or enhanced elements that may be integrated.

Through the combination of CPU's, GPU's, ALU's and GUI's processed via machine learning, inference engines, compression algos the User will be able to datafy the real world in real time based on their interactions with the aforementioned systems, whereby the User will assist the system in developing a datafied real world. Such that a User would be able to interact with any of the aforementioned systems whilst engaging in an activity such as walking around a city, in doing so, the User would be able to log the physical assets as datafied objects simply through their interaction with the Celestification system and the elements therein.

Providing the User with real time access to assets in the real world through the virtual system, and/or producing feedback of interaction, based on the Users interaction, with said datafied element in the real world, the virtual world, the augmented reality, the digital sphere or otherwise as it pertains to a dynamic system operating in a multitude of realities simultaneously.

Whereby activity data is generated by Users in real space based on their real time interaction as it is detected by the system through direct, indirect, and/or inferred data collection, evaluation, and aggregation, as it relates to their smart profile data matrix including potential impact to their User preferences as they are understood. Whereby, the arithmetic logic that processes instructions (fed by the User interacting with the real world whilst using the Celestification suite), whereby the datafied logic processing will further augment the system with machine learning and gamification rendering suites. Such that the User's interaction with any of the real world, CPUs, GPU's, ALU's, quantum flashes, and GUI's will render the real world data into map-matrix layers capable of powering a dynamic virtual world reality, with streamlined augmentations and machine learning preferences.

Where, activity data will be further enhanced with the integration of hardware devices capable of working within/without the Celestification system, such that the hardware will contribute to datafication, activity data, gamification elements, augmentation elements, avatar control, or the like. Where User activity data will contribute to the User's smart profile, preferences, and/or the system network. Where a User can contribute to the system maintenance, optimization, and/or content creation such as a trail (blazer), influencer, guide, contractor, Productivity Network operative, apprenticeship master, map matrix layers, or otherwise.

Augmentation of the User experience through the Celestification of their environment(s) can be achieved with the incorporation of hardware devices such as those within the suite of Decision Maker Technology (DMT) hardware that is readily adapted to the Celestification system. Such that, the applicable hardware has been designed to produce and detect data based on sensors, activity, observation, evaluation, augmentation, or otherwise, where hardware is capable of developing a world view in real time based on data feedback systems. A world view that may be impacted by

User interaction in the real world or digital/virtual world in real time, where User interaction can be augmented into the real world or datafied into the digital world, producing results and feedback loops in both cases to further incentivize User interaction with gamified governance methods.

In terms of gamification and gamified governance, the gamification of the system operations would further enhance the User experience by increasing their interaction and participation in multiple elements of the Celestification system. The gamification method provides Users with feedback outcomes that ultimately increase their likelihood of engagement. This is further developed with Celestification, through the process of augmented gamified governance. Where the operation of the system is directed, maintained, and optimized through governing techniques based on gamification methods. Such that, a User can be rewarded according to the parameters of the system, and the intended objective as it relates to any indications by the User, their personal preferences, their inferred preferences, or the indicated trajectory of their activity data.

Furthermore, the gamification methods coupled with the inference engines will enable the system to connect on an emotional level to the User, with mood gauges, DNA Rating system, and boredom recognition systems to determine a Users mental availability, and further determining what the User needs; interacting with them in a gamified manner that allows for immediate engagement, based on User generated data and the inferred response analytics. Whereby, a User may indicate personal preferences, intentions, objectives, or interactions through gamified system elements, which the system will then feed back into their smart gamified profile. Thereby providing detailed methods of communication/data transfer between the realms of human emotion via mass comparison machine processing.

Where the Users smart gamified profile will be able to interact with the system, based on User interaction, such that the Users objectives, interactions, daily operations, rewards, and the like can be used to produce gamified results including feedback matrices that will therefrom further augment their User experience based on their direct or inferred preferences and/or interactions such as milestones, badges, belt levels, points, bonus missions, prizes, connections, access and the like. Where Users will receive any of the aforementioned, or feedback elements of the like, based on their interactions where a User will be required to satisfy an activity threshold to unlock the element.

Further, gamified elements can become augmented elements of the digital, and real world environments, indicating that there is a node action of any type and populating the node action(s) accordingly.

Where augmentation of elements, layers, or events will prompt the User to interact with the system through the method of gamified incentivization towards the intent of governing the system operations based on User preferences and activity data. Such that a User will receive system feedback and/or rewards of any type which can further contribute to their overall experience, engagement, and/or opportunities. Where Users will be rewarded for their achievements and potentially restricted otherwise until they have satisfied the threshold to unlock any incentive such as a new level, point of access, location, network, feature, title, bonus, project, payment, invitation, augmentation, skill, or the like. These rewards and feedback matrices can be presented to the User as an augmented element, virtual element, or otherwise, where the User may be able to interact with the system based on visual stimuli/indicia. Such that any of a hologram, projection, color augmentation, movement augmentation, virtual blending, hybridized visual stimuli, illusion, or otherwise iconically indicative of an event detected in the physical, digital, or augmented realities/worlds may be represented (e.g., visual augmentation) and therefrom acted upon to satisfy the system push, prompt, or otherwise. Where a User interaction may include the use of a touch-sensitive holographic, or otherwise augmented display, such that the holographic display can be projected by hardware, or visually stimulated by software that will further incorporate the use of a spacial light modulator, optics, and sensor apparatus or the like, reducing the burden of extensive hardware use.

Further, the gamified governance method is to promote and manage the maintenance of the User preferences and system operations within the Celestification system, where any of the aforementioned will be evaluated as a group/network or individual/node based on the event recorded and stamped in real time, where an event is anything that can be detected by an event listener in the system. This information is then processed to generate feedback mechanisms based on parameters and threshold matrices as they relate to any of the User's indicated preferences, inferred preferences, objectives, or activity data. Gamified governance is a method of providing a system with optimized functionality, tailored to the User, where the User will be prompted to interact with the world, as the User indicated through their interaction.

Moreover, the User will be further able to merge their real and digital worlds into a hybridized model of their preferred lifestyle as indicated through their system interaction. This is a highly customizable system that is built to suit the User based on their real time preferences, such that the User may be able to completely shift their world view based on their real time preferences, through the modification of their indicated preferences such as API portals activated, layers present and/or absent, features active, networks connected and/or disconnected, and gamified features such as augmentations, iconic elements, visual indicia, feedback prompts, and the like to be modified by the User in real time, ensuring that the system remains dynamic to the Users dynamic lifestyle, as an adaptable personal life filter and enhancement tool backed by gamification and governance systems.

Further, Celestification will allow for the interaction with datafied assets and gamified elements. Such that a User may engage with the real world elements and digital, virtual, and/or augmented world elements in real time and/or simultaneously. Whereby, the User interaction with said elements may produce a result that can adjust their view of the system, and/or the User may further adjust their preferential parameters indicating their system preference, which will therefrom affect the datafied assets and gamified elements accordingly. Such that the aforementioned will be impacted by the User's interaction wherein any of the aforementioned will be encased within an API, portal, layer, element, feature, augmentation, or the like.

In terms of seeing the board, the Celestification system will generate a myriad of gamified interactive User interfaces using computer implemented methods of graphical User displays, real time connectivity, OS functionality, and data security. This will require the system to be able to connect to a network, relay signals, and information sharing based on system operations and technical load.

Therefore, due to the demands on the network to be able to function even in remote or isolated areas, the network is capable of on-grid and off-grid, via Bluetooth, 2G, 3G, 4G, 5G, WiFi, Satellite, GNSS, mesh, ad-hoc, Beartooth, etc. As well as through hardware components and/or Beartooth dongles that can be used to connect the User as well as give them the ability to generate their own server/ISP. Alternatively, WiMAX in locations where large numbers of Users require a network connection, or Ether Boxes, can also provide service to a User within their hot zone. Further, people can act as repeaters, these Users may have a higher than normal EMF reading/Bluetooth capacity and are capable of relaying signals through their Bluetooth connectivity (i.e., human antennas), these people will be referred to as AMP-Antennas (AMP-A), where AMP-A may also use antenna incorporated garments, implantable devices, medical chips, etc. such that any User can be incentivized to become a human antenna, repeater and/or a server/ISP where the User will receive an incentive for the service provided to expand and/or enhance the network/connectivity.

Redundancies for network connection will ensure that the User(s) of a

Celestification platform will always have access to data and OS functionality. In the case of a network shortage, data packets can be stored in select geo caches, where a User will retrieve select data based on their preferences and access.

Further, where select nodes will also act as servers, hubs, and/or skyports/etherboxes, thereby providing node-centric connectivity on-demand which will be enhanced by dome hardware (e.g., C-Buckyballs and C-Orbs) where networks will be established on-demand.

Further, larger service redundancies will include providing data centers for User interaction, such as gateways and passports, where Users will be able to access the Celestified network.

In terms of the Celeste platform, Celeste is a computer implemented method of producing an interactive networking experience engine with integrated gamification systems for increased interaction with Users, and management with the gamified governance system built with the Celestification method, system, and matrix.

The Celestification of any system is productivity and challenge oriented, with gamified rewards matrices to increase User engagement and objective maintenance. Where the celestification of any asset, event, or realm would take datafied objects, actions, or essences and integrate said data into a visual map-matrix, where a map-matrix indicates a multi-dimensional layered matrix of visually indicative data such that a User will engage with a multitude of system operations, through these layers, in a visual, iconic and/or otherwise augmented display. Where the visual display may be viewed within a mobile device, without a mobile device, as a projection, soft hologram, or through a GUI displayed within hardware devices that provide heads up display augmentation. Celeste will be able to connect the User to their own custom world, where they can interphase with technology systems, modify their reality and enhance their experience through trans-world interactions, such that they may project digital reality onto the real analog world, and datafy the real world into interactive assets within their virtual digitized realm.

Through enabling Users to customize their environment to suit their personal preferences across several layers of lifestyle engagement such as people, places, services, things, activities, events, challenges, travel, diet, health, weather, etc. Celeste is providing a new system for networking (social, digital, physical). Where the end User is able to leverage the system to suit their personal preferences on-demand in real time with gamified response matrices.

Celeste will allow the User to effectively modify the system operation, through their interaction both directly and indirectly to leverage the number and variety of system operations, portals, feedback loops, and operational features that are active and/or inactive and/or satisfied and/or unsatisfied at any instance in time. Thereby, modifying the platform to suit them in any design, functionality, features, augmentation, connection, focus, network, objective, program, layering capabilities, portal access, security, storage, data, and the like, where the User will adjust any system feature such that their world(s) are unlike any other (i.e., each User can customize their own world(s) to suit their User preferences and User interaction in real time).

Further, that the User's world is not relegated to digital or virtual reality, that the experience the User indicates/creates through their interactions will ultimately yield real world results. Where real world results may include hard holograms where User(s) can interact with digital elements, tangibly realized in the real world.

Further, that the real world results will be relevant to or affected by gamification systems, such that gamified feedback loops will augment or be augmented by the real world elements. Where a User's smart profile will experience alterations based on gamification system elements, which may further alter the User's experience by adjusting the preferences, and all subsequent layers therein, which may alter the virtual, digital, augmented environment(s) of the User's map-matrix. Such that the User's world will now be affected by new features, restrictions, or abilities based on the gamified feedback according to their system interaction directly, indirectly, or as detected. Affecting their network load.

The Celeste system will create a multi-dimensional layered mapping matrix that accommodates a plurality of actions, events, system operations, and pathways, bringing augmented trans-world connectivity and dynamic real time interaction. Where real time personalization of the system operations, display, and system potentiality through an iconic filtering system is capable of shifting the bounds and capabilities of the platform to suit a User, specific to their User preferences. Where everyone is able to be in their own realm, determined by their smart profile, capable of instantaneous alteration based on the User's interaction with any of the system elements, particularly as it relates to their User preferences; affecting the system operations by way of API portals, functionality, features, elements, levels, layers, networking, connection, etc. Where everyone is interconnected in a network, connected to the real and virtual worlds simultaneously, through the lens of their own world view point capable of real time alteration with integrated gamification feedback loops.

The Celeste operating system is an example of the Celestification system and the implementation methods therein as they pertain to a dynamic socio business networking system with multi-layered matrix mapping and gamified governance maintenance parameters according to system optimization and User preferences.

### I. Celeste User Preferences

Celeste will integrate a Celestification User preference system, where the system operations will be altered to suit the User according to their preferences as they are indicated directly, indirectly, or inferred. Such that a User of Celeste will be able to personalize their own custom world across real, virtual, physical, and augmented reality dimensions according to their preferences in real time.

Direct: A User will directly interact with the system by way of the iconic language and/or visual indicia displayed in the genie filter system, the map, the mood gauge, the RYG light system, and the visually indicated zones, elements, and actionable features. Where a User can select one or more options, depending on the parameters of the visual indicia to satisfy a threshold of selection and thereby produce an actionable result.

Where the genie filter will populate iconic indicia communicating a variety of API portals that can be activated or inactivated by User interaction; the map will populate a variety of visual indicia that can be selected or otherwise interacted with by the User to produce an actionable result such as opening a portal, generating activity data, or connecting;

the mood gauge provides a variety of activity-generated polling questions based on User activity data and event detection, where the User will interact with the mood gauge to alter system elements such as theme, presets, connectivity, team strings, or otherwise interactive data manipulation indicators based on the Users mood at present;

the RYG light system will indicate directly to the system whether a User rejects, likes, or accepts any element applicable to User evaluation; visually indicated zones, elements, and actionable features will be populated in any applicable layers across real, virtual, and/or augmented realities where a User can interact with applicable visual indicia to activate, inactivate, stake, open, connect, tokenize reserve or other methods of actionable results based on the Users interaction. Further, Users can download influencers User preference settings, whereby their results will be modeled after the selected influencers User preferences. This is relevant to a User that may want to experience a location or dynamic event through the eyes of their favorite influencer, or for the savvy business entrepreneur whom would like to learn from the references of an experienced businessman, etc.

Indirect: A User will interact with the system indirectly based on their smart gamified governance profiles, geo location, patterns of use, pre-sets, purchases, activity data, and the like. Where a User will increase their access to system elements, features, promotions, networks, and the like based on indirect interaction through their (past) achievements, actions, patterns of Use, ratings, points, experience points (XP), integrated hardware, unlocked elements/locations, portal and feature settings including pre-sets.

Inferred: A User's interaction will be inferred based on their User history, smart profile, gamification metrics, social network comparables, or otherwise deduced methods of data collection, aggregation, processing, and conclusion based on understood User preferences. Where the User's preferences will be inferred to further enhance their experience through generation, leads, prompts, features, or gamification element activation. Where elements of AI, machine learning, neural networks, and deep learning will be used to develop a system innerstanding of predictable User behavior based on historic and inferred User behavior.

Real time adjustment allows for the User to adjust the system operations on demand within the boundaries of their User profile access level. Where a User will be able to completely alter their world view as they require, in real time, such that a Users map interface can take on different roles, functionalities, and views on-demand as the User interacts with the system, or at pre-set scheduled times.

For example, a User may have pre-set for when they are at work and when they are finished with their work day. These pre-set can incorporate more functional, educational, essential and productivity leveraging API's during the work day, and convert to more social, networking, and personal post completion of their workday; the User may also have a weekend pre-set if they do not work weekends, where they would have different API's and functionality pre-programmed. Further, this User may have a day off that is outside of the usual bounds of their pre-sets (ie. a random Tuesday) the User could then interact with the preferences system directly to indicate the world view that they would like for today, overriding their usual pre-set (e.g., workday).

This system ensures that the User will be able to control the functionality of the system in real time, based on their current User preferences. Where the preferential selection(s) is recorded, processed, and relayed to the system. Where the activation or deactivation of API portals and functionality settings can be adjusted to suit the User according to the User's indicated preferences. This is possible due to the layered map-matrix system, where the “map” is a visual display of the indicated preferences and the subsequent layer activation accordingly. Such that, a layer is a representative of a code/data packet, API, functionality, active feature; synced hardware, sensors, networks, etc. where the User can alter system functionality.

Further, the User preferences matrix is a visually indicative series of selections, displays, and results. Where the User can interact with or without hardware tethered GUI, insofar as the User is able to visually interact with the system and the results thereof. Where a User may be able to view the system as a projection, hologram, hallucination-beyond hardware such as mobile devices or any form of hardware capable of connection and visual GUI such as screens, glass, AR, VR, hologram, projection, visual augmentation or the like. Ensuring that the User is able to interact with the system without needing to be explicitly tethered to a mobile device and the screen vortex that existing systems rely so heavily on upon.

Rather, Celeste will connect Users to their environment without needing to rely on their mobile devices. Whereby, Celeste will be able to link Users to the system through wearables, augmentations, projections, datafication of assets, and trans-world connectivity. Though the system can still operate on a mobile device, tablet, or other hardware.

### II. Celeste Hardware Compatibilities

Decision Making Technology (DMT) is a series of hardware designed to operate with Celestification protocols for real time activity data. Wherein the hardware devices can operate in tandem, in synchronicity, or individually within the Celeste system. The DMT will be a series of techniques designed to aid the User in real time, whether in the real world, augmented reality, or the virtual world.

Beartooth dongle: The Beartooth dongle may be incorporated to increase the User's connectivity and system functionality. Where the Beartooth dongle will be used to provide network service, an alternate power source, micro servers, micro data centers, power stations, where the User will be able to source energy from available sources such as zero point energy, body energy, electron pump, ether EMF, toroidal energy, etc. Moreover, the Beartooth dongle will be able to operate off-grid, through mesh networks and node matrices as the data will be secured, encrypted, zip compressed, for streamlined data transferability.

Further, Beartooth dongles may be used to communicate and process data pertaining to API keys and functional features, to the extent that the Beartooth dongle can communicate with the system towards training AI via machine learning, neural network, and deep learning protocols. Whereby, the AI system will be able to learn User states and preferences based on system interaction in real time or stored within the Beartooth dongle and/or node, allowing for the system to be able to perceive emotion, through engagement with real time adjustment (e.g., via User preferences, mood gauges, genie filter) moving ANI further towards AGI and ASI systems (Artificial Narrow Intelligence, Artificial General Intelligence, and Artificial Super Intelligence respectively). Where Beartooth dongles will further interact with sensor data as it relates to system matrices, operations, or adjustment which can further provide access to unsupervised data learning, resulting in Artificial Intelligence becoming less Artificial and more humanistic a true random functionality opens a dynamic realm of the realm of computational possibilities.

HISS: The Holes in Soles System (HISS) describes customizable footwear with a plurality of integrations and possible functions. HISS footwear will be integral to location data, beacons, and trail movement, where a User may be engaged in a trail or form or travel, either to produce or interact with either, the Users HISS will be able to confirm and verify their location and/or travel based real time live activity data metrics. Further, HISS can be used to design, interact with or augment the Celeste smart map or map layers, such that a User will apply their generated activity data to their interaction with the map where a trail, beacon, pin, ping, zone, or the like require verification of User location or movement. Further, HISS will affect the radii system, code zone system, or determine the User's interaction with any of the productivity or business networking features, APIs, and/or augmentations, to the extent of a digital avatar.

The HISS System interacts with smart axiom map layers by creating pathways and storing location data to map out zones, enhances production, increases security and safety, aids with the User's health and the like. The HISS is the smart footwear solution to a plurality of problems such as; hazardous work environments, activity performance tracking, high impact training, podiatry-connected meridian status, energy and toroidal circulation, security and safety, extreme environments, environmental conditions, difficult terrain, i.e don't step there, location mapping, travel competitions, verification systems, and the like.

Skowl: The eyes in the sky, integrating a two phase system, the first being the active component and the second, the relay and data collection system to establish overhead views, live streams, mapping data, live activity data, ping triangulation, beacon tracers, and the like.

Where by utilizing several aerial mobility components, satellite connectivity, solar, aerial imagery, li-dar, geographic layering, measurements, identification of any notable detection, and the like, the system can integrate large amounts of activity data directly into the Celeste System. Further systems integrated into the Skowl will include Governance from Above Tracking Systems (GAT Systems) whereby the Skowl will observe via the eye in the sky system (SkyView), as well as the location of all project-relevant static and dynamic components (Captains View). Where the User will be able to interact with these systems to access the live activity data, and data associated with the applicable systems according to the collection and operation of the Skowl.

Where additional functions can include SkyView data application, situational awareness, gameplan, and operations tracing, screen mirroring, HUD display integration, gamification governance control, and the gamified feedback therein such as visual indicia, belt level, meters, rewards, badges, access. Where augmentation development, adjustment, distribution, and/or utility will be applied through visually augmented, holographic, and/or projection display(s) of visual indicia such as iconic language, zones, probability, and/or any other data collection within the map displays, interconnective relay of data and/or system functionality amongst approved and interlaced components within the system. Where the data will be visually displayed on a screen, off screen, in 2D, 3D, 4D, by means of device, attachment, projection, and/or hologram, where a hologram will be projectable as a soft or hard hologram, such that the Skowl can project a physically tangible environment for User(s) to interact with. Where the hologram-reality can be applied to create Zones, augmented environments, or domes where Users can interact with each other, or the system, such that the interaction may include an augmented event, or series of events, actions, challenges, etc that can incorporate the development of holographic or otherwise augmented environments, assets, and operations. Where the User will be able to physically interact with augmented, projected, or holographic features capable of receiving sensor feedback, where the aforementioned may interact with touch-data.

Skowl can be controlled by integrated and synced hardware operated by a User with an approved and validated Belt Level. Live streams can be accessed, with augmentations visible dependent on the User's access level/belt level. Augmentations may be interacted with in either or all applicable realms.

Shot Caller: The operator's gameplan system, combining low-high tech dongle which will further incorporate a multiplicity of system technology and hardware integrations whereby the User will have access to any and/or all functions of the system even in extreme conditions.

The Shot Caller device can operate as a fully operational device, as an extreme device whereby a secondary screen can be operated to conserve battery. Further, the Shot Caller will be converted to be used as a location beacon, a network component, a communications device as well as establishing and manipulating events, pathways, travel, outings, gameplans, situation operations, and the like. Further, the Shot Caller has a plurality of settings, functions, modes, and the like to ensure that it is always ready for any environment, challenge, or lifestyle, even for the more extreme. Further, the Shot Caller can be used to project holographic GUI's for User interaction with the touch sensitive holographic elements, which could alternatively be displayed in heads up display, or otherwise augmented interactive visual displays.

The Shot Caller will incorporate projection, hologram, augmentation, HUD through device sync. Where a User may have the shot caller dongle, wristlet, ring, low-high tech phone augmentation, or head attachment to provide system support and operation functionality.

Dome Tech: Connecting Users to the system through Celeste Orbs and/or Celeste Bucky Balls according to the User's network demand. Where dome tech integrations can provide network connectivity through nodes strategically placed to provide the User(s) in zones, on trails, attending events, interacting with the environment or otherwise with system connectivity, where the User may require connectivity to interact with, by, or for the Celeste system. Such that, a User will come across a zone trip wire, or a radii, where the User will be prompted to check in, update, connect, or otherwise, where a base camp action is concerned (i.e., any action that will allow the User to ground their system version in order to tool up, update and revitalize their OS).

Celeste Orbs: link to an orb node to acquire information, instructions, directions, network connectivity, event themes or supporting data, hidden data packets, as well as linking to Wayvee off-grid communications and encrypted mesh networking.

Celeste Bucky Balls: are micro networks, where Users will be able to access extranet data, preserved with version control repositories that can be contained within encrypted zip data packets. Where a User will be able to update data online via Bucky Ball storage repositories, where an encryption key or other form of security wall may be required to access the contents.

AMP-A (AMP antennae): A mobile network of nodes to support Bluetooth connectivity and real time network relays. Where an AMP-A node indicates a User that has a particularly high ability to relay network signals and/or interact with Bluetooth connectivity. Allowing for said Users to be incorporated into the node map of networked signal repeaters. These Users will be incentivized to act as signal boosters, relay points, or Bluetooth assets.

### III. Celeste Layers

### I. Celeste Layers-API Integrations

API portals are customizable, based on User preferences, they are targeted to what the User indicates and leave out everything they don't. The windows of tech are too large and don't allow for User specificity, customization, or control.

Celeste is providing a wide variety of precise API rapidly programmable portals for Users to engage, and interact with according to their real time User preferences. The precision and focus of API portals allow for Users to modify their world view by way of modifying the technical functionality of the system through interacting with the User preferences matrix, as it pertains to the API portals, system elements, and functional features available to the User.

Celeste uses the axiom layering system to integrate a variety of features, functionalities, and operational portals such as APIs, based on User preferences, in real time. Where the User will activate any number of available system elements to adjust the system functionality to suit their current preferences. API integrations of Celeste are targeted towards Celeste User experience optimization, streamlining, business networking, international productivity and collaboration, connectivity, integrated purchases, gamification, augmentation, and the like, where the User will have a personalized system operation.

Integrated APIs can include the following systems among others operating in the frontend, middle, and/or the backend of the system.

### I. Live Action Data

Celeste incorporates a variety of active data elements, where activities, challenges, happenings, and live data will be layered into the system operations through gamified governance. This can be through system generation, User interaction, hardware integration, sensor reception, and/or asset datafication. Where a User will engage one or more of the aforementioned elements, or similar, to produce a computer readable result, based on datafication, reception, processing, and databasing the element, including emotion. Where said data may be Used for machine learning, where the system will be able to collect information from the User based on their interaction that will be fed back into the system. Where collected and/or inferred data will contribute to future decisions in the system as they pertain to the User and their interaction. Where further, Beartooth dongles will be Used to provide micro data centers according to User interaction.

Sky View: An exclusive feature for Users to view live action data remotely. If a User has unlocked a location then they will be able to access the live streams and sky view oversight, where a User will be able to see what's happening, and who's here in a location they have unlocked, even if they are not currently at that location. SkyView allows the User to essentially zoom-out to the bird eye view, as in an open world game interface, where the User will be able to view and explore from afar, where Users will also be able to drop their avatar into the location to access the location data and view streams, etc. Further, Users will be able to interact with the virtual location through challenges, happenings, connections, activities, and the like, where Users may engage the map layers and interact with the location through their digital/virtual reality; their avatar.

Challenges: Celeste will incorporate a challenge matrix into the User's activity matrix, if activated, this will populate a variety of challenges generated by the system, by influencers, by other Users, or by backend/third parties to incentivize the Users engagement. Challenges can be populated within map layers, pushed between Users, included within game pathways, embedded within trails, promoted across the network, or locked in exclusive geo caches/data mines.

Where a challenge can yield User rewards based on their interaction with the challenge elements. Should a User come across a challenge zone, they will be prompted to interact with said challenge elements to earn gamified feedback rewards for challenge completion. Further, if a User encounters a challenge embedded within or associated with a trail, the User will be prompted to interact with the said challenge as an auxiliary element or necessary element to the completion of the current trail endeavor. Further, should a User discover a challenge hidden or locked, the User will have to unlock the challenge, which can require a form of challenge in itself or access parameter, once the challenge is unlocked, the User can then engage with the exclusive challenge which, upon completion, the User can be able to publish/monetize/integrate into a trail as a public challenge.

The challenge matrix is elemental to the gamification system, where Users have proposed a variety of challenges, being tasks, to complete for incentives and rewards, which can further be applied to all areas of productivity and business networking, enhancement, skills and training, and any elemental function that can require an incentive for the User to complete a task, upgrade their profile or the like.

Challenges can be pushed in the digital, virtual, or augmented realities, as well as triggered in the real world with or without augmented interactive elements, where a User can be prompted to interact with a physical challenge, virtual challenge, or augmented challenge in real time through a digital portal, and/or real world reaction where the reaction can be verified through capture (video, image, stream), sensor and/or datafication.

Happenings: Integrated real time networking zones generated in the virtual or real world realms to engage User interaction with any of a theme, intention, network, objective or functional element, which may or may not include one or more API. Where Users can interact with the zone according to their User preferences and zone parameters, such that a User may be triggered or prompted to engage in a happening based on their location in the digital or real world, their network, their activated map layers, and/or API portals. Further, the happening can include a zone, a challenge, an action, and/or an event, where a User may be prompted to engage in a live game, live stream, networking event, activity, poll, or otherwise interactive gamified networking.

Happenings can integrate other system API's/active layers according to the happenings parameters, such as Waevee mesh networking, dome tech, challenges, live streams, User generated content, games, betting, or otherwise, where the User will be prompted to engage the happening such that the system, network or happenings element may be impacted and can produce a feedback result (loop) to the Users gamified smart profile. Where the smart profile can be augmented, or augment the system operations according to the live activity data and the system interaction therein.

Zones: Celeste zones are indicated based on parameters set by the zone creator, this may be applicable to the digital display, virtual realm, or in the real world—where a physical zone is digitally established based on spacial parameters set within the virtual world, for Users to engage in the real world. Where the node maps will indicate the parameters of the zone-based on the settings of the zone, a particular number and orientation of nodes will be green lit for operation leaving a yellow buffer zone to establish the perimeter and a red zone for exclusion.

Green Zones are the active area of the zone, within these boundaries the zone events will occur. Where an event is any actionable element such as challenges, networks, activities, games, happenings, and the like. Should this zone be transferred to the physical world, the zone will be covered by a form of network connection such as WiMAX, dome tech, or relays.

Yellow Zones are the buffer zone, where Users will be notified of zone boundaries in either entering or exiting the parameters of the zone. In a physical zone, this can be viewed as a trip wire; for Users moving near a zone, upon reaching a yellow boundary, they will be notified of a zones existence (should they satisfy the system qualifications for User interaction with the said zone (e.g., they have the applicable layer(s) activated, they have the appropriate access/belt level, etc. . . . ). Likewise, once in the (green) zone, should the User make contact with the yellow boundary they will be notified that they are leaving the said zone.

Red Zones are the inactive area around a zone, or effectively the standard operation zone (where non-zone events occur at all other times).

Zones will be considered public, exclusive, or hidden. And each of the zone varieties will be interacted with differently according to the User's system parameters (e.g., preferences and access).

Public Zones are displayed, and may even be promoted in the system display, should the User have the appropriate layers activated to see such elements within their world view. e.g., If a zone is targeted to a public pick up basketball game, where Users can play, spectate and place bets on the game in a “15 hr basketball zone” the User may only see this information should they have layers that pertain to sports, activities, entertainment, parks, or group events turned on.

Exclusive Zones are only populated for Users that satisfy the necessary qualifications to be included in the said zone such as belt level, pathway, team network, or the like. e.g., If a zone is targeted to tech entrepreneurs “byte, bots and business”, only Users that have indicated an interest in tech and business entrepreneurship are likely to be notified of said zone, and in this case, only Users with a belt level above orange and at least two team connections will be notified to ensure that the zone remains on a certain level.

Hyper-exclusive zones may further require that the User be a part of an X-Club in order to gain entry.

Hidden Zones are secrets to be discovered within the system, in virtual or real world environments, where a user may come across a happening zone, challenge zone, or the like during their interaction with the digital and/or real world node matrix. Hidden zones can be found in trails, or simply attached to one or more nodes and the User would have to discover the zone through exploration and interaction. e.g., a User is walking in a city and discovers a geocache of data describing a historical event that occurred in this location, by discovering and unlocking this zone the User has the opportunity to engage with the zone and interact with the gamified trail to learn more, If this is the first User to discover said zone, then they will be able to publish the trail and potentially monetize it for themselves based on other User engagement.

For clarity, a zone can also be independent of the real world and physical locations, so long as there are set parameters for User interaction and a theme or objective of said interaction applied to a space in time. e.g., a user is interacting with Celeste from their home, their avatar is moving through a node map and discovers a group of Users logged into a virtual space, upon reaching the yellow zone of this space the user is notified that this is a social zone where Users are watching a live stream and push a notification to the User to determine whether they would like to enter the zone “Smooth Jazz and Chill”. If the User says yes, they will be moved into the green zone and therefore able to interact with the other avatars and zone elements therein.

Zone functionality can be enhanced with system network magnifiers such as network/service providers to connect everyone within the designated zone. This can be accomplished by using hardware devices that can power ISP, Ether Boxes, C-Orbs, C-Bucky Balls, or networks using AMP-A repeaters.

Celeste Streams: An interactive streaming platform. Whereby, viewers will not be relegated to simply watching content, or leaving comments. Rather, Celeste Streams will allow Users to interact with each other, stream providers, third party actions, and the backend system with streamlined actionable elements layered over the stream in real time turning analog reality into a database able object, class, instance oriented dynamic search engine.

Where an action is considered an element populated that may require a form of participation on the part of the User that will determine the Users position through their act; resulting in any, or all of altering their smart profile based on progressive aggregate data of User history, altering the action in a way such that the action was intended, and/or an element that can affect the stream in such a way that the action was intended. Thereby, altering the stream in either a passive or direct manner depending on the intent of the action that was pushed and acted upon by one or more viewers. Moreover, potentially altering the User's profile based on their preferences or decisions indicated by their actions.

Effectively, bringing streaming into the viewer's world, and the viewers into the stream; merging digital content with real world connection through integrated trans-dimension actionable content. As, the Celeste Streams system would have a vast array of applications across several industries, bringing live streaming into partitioned realms for effective User interaction. This would allow for a wide variety of stream providers, and interconnected linking of actionable elements.

Elements of the Celeste Streams system would allow for stream providers or system operations to push interactive elements (actions) out to any User capable of reception; this could apply to Users that are currently viewing the stream, Users with their stream pings set to on, and/or Users within the applicable radii. Such that; If a User is actively viewing a stream then they will be prompted towards the actionable element; If a User is an avid viewer, not currently viewing, but has ping notifications turned on, then the User will be alerted to an actionable element relevant to their ping specifications; If a User is within a radii either by physical location or digital connection then they can then be informed of actionable elements relevant to their personalization specifications.

Moreover, User interaction can be custom tailored to the User. Whereby, a

User can specifically adjust their preferences in the iconic filtering system in their profile; indicating the content and specifications of their User preferences when considering their User experience. Else, the User's known data will be considered based on their previous use and predictable actions. Thereby, producing a personalized User matrix without the need for extensive filtering or searching on the User's behalf; providing content tailored to their interests and thus their own personal network for their specific interests; both indicated and inferred.

These networks or microcosms of personal interaction provide the system with relevant networking data to further customize the system based on User networks and interaction as it relates to actionable interests and programmable predictability/machine learning.

Therefore, with smart profile adjustment; the system will be able to segment the content and minimize any potential delay as it relates to stream delivery or actionable content. The backend User matrix will optimize the User experience and system operations with predictable programming and personalized filtration of content, actions, and networks. Creating virtual microcosms of each Users preferences of interaction. And populating a gamified iconic User experience based on interactive visual indicia.

Applications that may be considered viable for interactive streaming on Celeste Stream would be integrated through real time channels promoting the interconnectivity of tethered networking to live streams. Else, the User would be able to interact with elements of streams that are no longer live, as actionable content that is not restricted by time parameters may still populate for actions that do not have a limit on interaction time or otherwise. Therefore, a user can interact, or experience lives streams and/or streams that are no longer live, thus creating a simulation.

For example; a premier unveiling of an automotive company's latest model is streamed live, this event is scheduled for a set time of 13:20 and said to run for 1 hour and 10 minutes. During this time, live viewers that check-in to the live stream is able to see the primary unveil, they are given a tour of the product and the company representative is scheduled to speak for the last 15 minutes. Throughout this, the viewers will be able to interact with the stream through live voting, ratings, and communication around their personal opinions on the first look at this product, they could also use an AR filter to adjust the color; their action(s) will be recorded in data and populated visually on the platform and the company representative may even interact with their comments or voting data directly during his speech. As a bonus for checking-in to the live event, Users who watched and interacted live are entered into a lottery and one of the live viewers will be chosen for an early model giveaway of the product. Now, a viewer that watches after the live stream is no longer live (post 14:30) then that User will be able to interact with the voting, opinion, and AR actions, though they will not be entered into the time sensitive lottery.

In both live and post-live streams, the data collected from actionable content will continue to populate in real time; meaning that the actions will continue beyond the live debut of the stream, allowing for perpetual data aggregation. This applies to all actions aside from those with restrictions; such that they were tied to an element of the live stream specifically, such as the time restriction. Though, it could also be affected by a location restriction, level restriction, special keys, or the like.

Actionable content will be considered differently depending on the application of the stream. As, Celeste Streams will be able to integrate into a multitude of industries spanning business, entertainment, and personal. Though in essence, any actionable element can be considered a prompt for participation on the part of the Users in such a way that the sender may collect or interact with the receiver.

Senders can be at least one of (1) the stream content creators, (2) a stream sponsor, (3) the operating system, (4) authorized Users.

Receivers can be any of (1) a User viewing the stream live, (2) a User viewing the stream post-live, (3) a verification bot, (4) a User being prompted to join the live stream through a push notification ping of actionable content.

Actionable Arenas are without limitation though can include any of (1)

Entertainment-Debates, (2) Entertainment-Social, (3) Entertainment-Challenge, (4) Entertainment-Production, (5) Entertainment-Strategy, (6)

Training and Apprenticeships, (7) Education and Development, (8)

Business, (9) Meetings, Conferences and Think Tanks, (10) Beauty and

Fashion, (11) Competition, (12) Athletics-Personal, (13) Athletics-Professional, (14) Purchase and Shopping, (15) Auctions, (16)

Management, etc. The actionable arenas are considered without limit as they represent the areas of life that we participate in.

Therefore, the formula to determine actionable arenas is effectively evaluating the level of action and interaction that each event can present when streamed over any applicable device to a User that may or may not be viewing live, though expecting regardless to interact with the feed in a real time manner as it relates to the content populating the stream. Thus, the proposal the system is charged with is to populate each arena with content that engages the User personally.

This method can be viewed as a series of push sequences, generated specific to the content, User, or realm, capable of engaging the User in the content in a personal and interconnected manner. Either to the content directly or to a third party, other Users, or the network as a whole.

Whereby, the system will allow for content to layer upon the stream in real time with the stream progression as an on-demand element, automatic element or User propelled element. Giving the stream a multi layered dimensionality of engagement.

Layerable elements that could be used include functions that provide or collect data in the form of User generated data based on their response (or lack thereof) to actionable elements in an Arena. Where an arena is simply a zone that can contain any of, a stream, a viewer, and an actionable element.

Potential elements can include any of (1) votes, polls, and surveys, (2) pathways, (3) Purchasing, (4) Betting, (5) Bidding, (6) AR elements, (7) Icebreakers, games, and social engagement elements, (8) Puzzles, (9) Skill Verification, (10) Upload, (11) Trails, (12) Communication, (13) Evaluation, (14) Interactive Graphics, Charts or Visual Elements, etc. The actionable elements are considered any component that can be layered onto a stream to increase viewer engagement between real and virtual worlds through augmented gamification.

Whereby actionable elements can be acted upon such that the User would be able to engage with the stream, media, event, creator, network, or system in such a way that the User experience may be better optimized to yield a more personal microcosm of their custom world.

Proposed in this system is a platform capable of effectively merging real worlds with virtual worlds, and/or real worlds with real worlds through a virtual world portal. Through which Users will be able to actively engage in a multitude of environments in real time, of direct consequence; without actually physically needing to be present. Thereby, connecting Users to a myriad of worlds in multiple realms through the connectivity of Celeste Streams hosting of Actionable Arenas that may provide Users access to interact in industries, events, or lifestyles.

The system is composed of a computer-based method of operation for the backend and frontend systems including a processing unit and database, a connection between devices that will allow for the transfer of data in real time, an action-triggered ping system of prompts, a smart filtering system for the personalization of the User experience based on direct or indirect system adjustment, a series of sensor-based elements to merge virtual and real worlds that can also lend itself to AR operability, push feedback loops, aggregate data layering over visual media streams, augmented gamification of visual media forms, smart profile gamification with iconic language and level systems, backend filtering optimization among others.

### II. Points Management

Celeste will have an array of commerce and financial portals to suit the User based on their preferences, encrypted and secured on the blockchain with trustless consensus. Where a User can use their joux points to interact with a variety of portals which may then interact with other portals.

Joux: A points metric system that allows users to purchase, exchange, and sell, as a trustless decentralized ledger backed by proof of work, proof of space and time, proof of object, and/or proof of protocol. Where Joux can be earned, assets tokenized, rewarded, or bought. Joux balance is recorded in the User's profile and may be accessed within APIs or used as a medium for purchasing, exchange, or pledge. Joux has a relative value to other currencies and can be exchanged for said currencies within a currency basket exchange system, logged on the blockchain with trustless consensus smart contracts. Further, Joux can be placed in cold storage or an encrypted key. Joux uses proof of work productivity smart contract systems to mine for work productivity and actionable results.

Numera: Numera is a financial network and exchange platform. Where Users can stake, exchange and move assets based on a basket currency system. Where Users may hold a variety of valued currencies including hard assets, digital currencies, standard fiat currencies, stocks, etc. Where Users will be able to exchange assets across multiple platforms with ease using the joux points system to purchase and sell assets within the User's designated basket. Where a User can have a basket of currencies considered of highest value (to the User or the system based on user preferences or evaluation protocols respectively) that can be leveraged to purchase, sell, trade, stake or put. Where Users can interact with any of the Celeste integrated APIs, features, and/or system operations that may require the use of joux points, moreover, the User would have the ability to convert their earned joux points into a stake in any of the Users basket options. Thereby allowing the User to earn joux points through gamified achievements and convert their joux into the ability to complete in-app purchases, or stake into any of their basket options, or place a put in

Numera Bets, or use within any applicable Celeste API (e.g., co-op), etc.

Numera is secured with blockchain technology, trustless consensus protocols, smart contracts, and chaos encryption with version control protocols and User loc-step security chain protocols, where the User's preferences indicate their security preferences.

Further, Numera will also have a bet integration, which will allow Users to stake a set amount of currency on a real time bet, where the bet can be any scenario or situation that may produce one or more outcomes that could yield a profit should the User stake well. This may be amongst Users within a Numera group or based on real time events detectable by the system. Further, the Numera Bet system will allow for Users to gamify any situation with more than one potential outcome such that a user can create a single bet, recurring bet, or a tournament, where Users may place a put according to their selected potential outcome, where the winner(s) will collect once the result is determined. Should there be an anomaly, and none of the potential options became the result, each User will retain their original put with no User gaining or losing any points.

Users can engage with three tiers of betting by placing (put) their points in any of a Single Bet (on the spot bet pushed to public or private groups with a minimum time to engage), Recurring Bet (bets that occur at regular intervals or otherwise known times, pushed to public or private groups with a minimum time to engage, though may be placed in advance, pertaining to the same bet category/qualifiers), Tournament (large network bets that can be public or private, can be of the same qualifiers or of different categories and are likely to produce a variety of potential results across more than one category and/or qualifier—where a category pertains to the type of bet activity and a qualifier indicates the bet parameters which may include the level/access of Users intending to place their put).

Purchase: An integrated smart shopping API that allows users to augment their shopping experience with integrated gamified elements, smart basket, and influencer gift systems. Where Users can ‘download’ smart baskets based on an image, advertisement, theme, package, or the like, such that a User can indicate any of the aforementioned, and the smart basket will find the items for purchase, composing a basket of elements from the indicated source. Further, the User can be able to view live streams of items, where the User may be able to interact with the product, and/or the influencer that may be modeling or testing the product, which may further be expanded to product launches or major developments.

Users can also create influencer gift sets, where they will have baskets specifically for other people to purchase for them as gifts, ensuring that when someone would like to buy a gift for someone, they will find the right product(s) and the right specifications (e.g., size, color, etc). This feature can be embedded on Users' social media profile(s) such that they can promote their purchase influencer gift basket(s) for others to gift them, or contribute to (not purchasing the entire basket).

Further, this can be extended to projects and developments where purchasing materials would be required.

co-op: Networked project funding and management system for communities, groups, and businesses, where a co-op may be made up of two or more Users that pay in at regular intervals, with the exception of one interval per contributor, designated as the (each) User's payout time. On their payout time, the User will receive the cumulative total of the pay-in for that interval by all other contributors who accept the indicated payee for that interval. The payout intervals are determined/assigned by a lottery at the onset of the co-op cycle, designating one contributor per interval to receive the full payout instead of paying in. This allows for communities, private groups, startups, and businesses to generate funding for projects/progress, in the case of higher value business networks, larger capital can be circulated through a co-op without requiring a third party system. Co-op allows for projects to source funding, or even multiple projects to be self funded in a collaborative manner of financial exchange and funding initiatives.

### III. The Business Network

Celeste will promote and facilitate business networking amongst Users, where Users can be incentivized to connect, network, collaborate, hire or contract with others based on business objectives or other productivity enhancement features. Moreover, where influencers can push data packets of their version (control); User preferences or interaction interface, trail(s), or experience(s), such that it may lend itself to the promotion of business and productivity oriented networking throughout the system.

CoNex: Integrating systems to facilitate essential business travel, networking, and workcations. Where Users can access exclusive networking locations in virtual rendezvous hubs or physical locations, such that a User will be able to actively engage in business and productivity based networking opportunities based on their access level (belt/smart profile). Further, Users will be able to connect their productivity score and skill set to determine their potential eligibility to participate in a workcation. CoNex enables Users to connect and network around business and productivity, travel, training, and work, based on their User smart profiles, User access/belt level, and User preferences, where Users will be able to interact with the CoNex networking system in virtual reality with their avatar, augmented reality or the physical real world.

Workadore networked productivity hubs will be accessible to Users with suitable validators. Workadore locations will be themed for specific interests and functionalities. They will be physical locations or virtual locations, and verified businesses can become workadore hubs in the network.

The Perfect Butler System: Celeste will promote a personalization matrix within the system to enable users to customize their User experience through interacting with the visual indicia/iconic language to determine their User preferences. The Perfect Butler AI System ensures that the User will have access to all of the comforts and amenities whilst traveling, ready on arrival and on-demand. Where the User's preferences may indicate the services that they would like once they have arrived at their intended destination. Such that, a User can indicate directly through an iconic filtering system (e.g., genie filter, mood gauge, DNA rating scanning system) or respond to system notifications based on an inferred understanding of the User likely preferences based on past interaction/machine learning. Where a User will have all of the services and amenities they desire ready on arrival, on-demand, and tailored to the User throughout their travel, or even without the necessity of travel; Users will be able to activate The Perfect Butler System and thereby trigger the smart services matrix to suit their User preferences.

On-demand services can be hired individually or through team matrices, where the user can select one or more services based on their User preferences, example API's will connect service providers from systems such as:

ArmCandy can provide access to a variety of Virtual Assistants and Personal Assistants, on-demand, with a wide variety of skills and industry specialization(s) as well as personal cooks, maid service, home caretakers, etc., where Users will be able to interact with ArmCandy and plan outings in the ArmCandy gameplan to attend events, explore, learn, engage, or otherwise as it pertains to gamified networking.

VEDI (Voyages Experiences Destinations International) can provide access to a variety of on-demand security and transport packages of one or more service providers including stationary, mobile, and ambulatory security, as well as motorcades, private transport, up armoured vehicles, copters, planes, jets, boats, submarines, yachts, hovercraft, airships and the like. Further, providing access to international essential business travel assistance to connect Users to a variety of transport, experiences, activities and tours, security, guides, and otherwise essential elements of travel. VEDI will incorporate all forms of land, sea, and air travel available to the user on-demand. Further, the User will also be able to access services such as security, guides, drivers, interpreters, and the like on demand.

A rider can provide the on-demand delivery of products to the User personally or to their destination ahead of time, pre-delivery of the products will ensure that the User has what they indicated upon arrival.

The rider can also provide personal shoppers and people to set up basics such as a phone chip for an international traveler upon arrival.

Business Essentialization: Celeste will assist in promoting businesses and integrating businesses into the system through a process of business essentialization. Whereby, businesses will be datafied to enable physical and digital businesses to become included in augmented business networking systems. Where the augmentation of datafied businesses can then be interacted with by Users through gamified governance matrices, such that the business will be able to operate through Celeste portals and respond in real time to physical and digital interaction. This will ensure that businesses may evolve to suit the new world demands for essentiality. Where businesses may suit User demands through technology-enhanced operations, where Users can interact with businesses and their products or services in a real time and gamified manner. Further, businesses will be identified through visual indicia such as iconic language or color codes, where businesses may indicate their industry, services, or accessibility through visual indicia for ease of search via smart networking displayed visually.

Gamified forms of advertising will be possible with the Celeste business essentialization system, where augmented businesses will be able to advertise within trails, zones, events, streams, influencer campaigns, augmented/virtual shopping, and API. Such that a user can interact with the system and may be prompted towards a business based on gamified advertising that is suited to the User based on their known preferences. These ADs can be augmented, pop-ups, gamified interactive elements, microgames, sponsorships, influencer streams, iconic language/visual indicia, and the like.

Further, Users will be able to modify the business database based on their own version control protocols, where User preferences can determine the version control, branching, and therefore the visible data. Further, Users will be able to download copies of influencers User preferences as it relates to their feed, or the system can generate a feed based on User interaction/machine learning.

### IV. The Productivity Network

Celeste will incorporate the Productivity Network (PN) which will primarily be Used to manage all teams, tasks, projects, and objectives with remote viewing, progress management, verification systems, and live streaming capabilities among others. The PN will incorporate real time monitoring of any productivity-oriented task, system, or team where the User may have a vested interest in viewing said data. The data will be streamed live with augmented verifications, communications, indicators, and notifications, further, it will also be storable, where a User will be able to view the data at a later time.

Celeste Service Engine: Digital agency with codified profiles, such that the skills and accomplishments are paramount to all other data, where backend systems will be able to sort and evaluate profiles and push them accordingly with coded/binary identifiers. Further, Celeste Service Engine will use games, challenges, puzzles, and other gamification techniques to test, evaluate and interview potential Celeste service providers, where applicants will be evaluated and graded based on their interaction with the gamification system. The essentialization of skilled service providers can be verified through a digital hiring agency such as Celeste Service Engine where skilled service providers are verified and datafied with smart contracts that may be logged on a blockchain ledger.

LionCloud: Incorporating a remote management system with augmented live streaming and verification systems. LionCloud will allow Users to view their projects, properties, or investments from anywhere through live streaming or record. Where Users can have access to progress meters, video, and photo verification relating to projects, developments, or logistics relevant to the User. Further, Users acting as project managers, overseers, owners, or investors will be able to view the project/property progress in real time with live streams, remote viewing, bots, and hardware assisted augmentations, insofar as the ability to maneuver an avatar to discover project progress and communicate with team members, where the avatar may or may not be linked to hardware such as a bot or drone.

Celeste Symphony: Promotes productivity via a series of productivity platforms, focused on various avenues of productivity systems capable of connecting investors, project developers, visionaries, contractors, skilled laborers, apprentice laborers, administration/HR, specialists, consultants, lawyers, etc. to develop small and large projects from inception to completion. Celeste Symphony will be able to provide real time monitoring with remote access, all based on the User's belt level, where a project investor will have different access than a team leader, or a skilled laborer, etc. Celeste Symphony will use augmented systems to train, perform, manage, monitor, and otherwise indicate parameters for progress and completion of tasks, milestones, and objectives as they relate to the overall mission/development/project, such that visual indicia can be used to guide the User in training, performance, communication, etc. Further, gamified governance includes funding, payment, rewards, and feedback; where Users can gain experience points, upgrade their level, earn new badges and skills through real world productivity augmented with gamified governance, connecting with applicable hardware and software systems.

### II. Celeste Layers-Profile Parameters

Celeste layers can be further determined by the Users profile, User history, and system interaction based on past use, patterns of use, and logged User data. Whereby the User can alter their system based on their profile metrics and personal activity data. Gamification of the User's profile, their interaction, and the gamified governance thereof can determine layer elements, event nodes, and activity functionality based on the User's profile parameters. Where profile parameters may change over time based on system operations and User achievement feedback loops.

Gamified Governance: User profiles in Celeste will be enhanced with gamification, and managed through gamified governance features. Whereby a User may be directed within the system to interact in a manner that is most suited to their backend profile through incentivization and game pathways.

Users will be rewarded for their interaction, and incentivized to interact, this can include guided incentivization matrices, where a game path can encourage a User to achieve certain tasks according to their incentivization matrix.

Gamification features are any generated event that would entice the user to interact with the system based on rewards feedback systems. Gamified governance uses these features to direct, manage and encourage the User to participate in game paths according to the system parameters, objectives, and User preferences. Gamification of a Celeste Users profile can include the incorporation of elements such as ratings, levels, achievement badges, objectives/missions, experience points (XP), achievement rewards, unlocking rewards, joux points, and the like. These features can be applied to User mission objectives, game paths, network connections, points, and increased element availability through earning the ability to unlock features, portals, keys, services, views, hardware integrations, games, connections, and the like.

Where gamification brings the User into the virtual world, and gamified governance pushes the games out to the real world, Celeste is using gamification systems and protocols to enhance the Users experience and in doing so increase User engagement and real time interaction.

Leveling Up: Celeste Users will be graded, at least in part, on a belt level system, where users will be incentivized to increase their belt level. Gamification elements will feedback into the belt level system, where users will be rewarded based on their system interaction/accomplishments.

A great number of belts are possible, tiered in succession based on an increasing value weighted within the system; based on metrics as they relate to the operation of the system. Whereby, the difficulty to achieve the threshold of completion to transition to the following belt in the series increases according to the belt level parameters. Such that a User may be required to complete a series of tasks and/or satisfy set parameters so that they will graduate from their current belt level to the next in the series.

Moving up in belt levels is incentivized within the system through feedback rewards mechanisms such as increased access, more features, greater points matrix, more network opportunities,

Teams: Formation of productivity, social or business teams with other

Users that may be a part of one or more of your networks, or can be a service team member, and therefore is integrated into your team network that pertains to service providers within your networking matrix. Where Users will be able to link teams to their smart profile, such that a team may be able to participate, communicate, collaborate and/or compete. Where Users can use these teams to network and connect internationally, including sharing and creating data.

Further, Users can have service teams available to them, where teams and networks of service providers the user has previously engaged with, or system generated suggestions based on user preferences and past use can populate within a designated team network associated with the User. This allows for streamlined access to familiar and suggested service providers, saving the User time when traveling or working.

Further, teams can be used to engage in competitions, challenges, and activities. Where team members may be associated based on a common goal or interest, such that the team members may be required to work together or against each other to satisfy a team objective, which further may include a betting feature, gamified points matrix, or other gamification feedback systems.

Further, teams can generate associations that may incorporate financial structures, data sharing, project development, competition, cooperation, or any other form of team-oriented connection. A team can be incorporated into the Users API matrix, and/or the Users API(s) can be incorporated into the Users team matrix. Such that, a User will be able to engage with team members, view their data, or otherwise track, trace or interact with them based on gamified governance matrices.

### III. Celeste Layers—System Operation

The Celeste system takes the overall effect of integrating multiple API portals and elemental features to augment the system functionality based on User preferences in real time. Where a User can alter the system operation based on their User interaction, activation/deactivation of map layers, and engagement in visual indicia and/or the virtual, digital, augmented, and real world elements that may trigger an event based on the detection and response of an event listener to yield a dynamic and interactive personalized experience-centric life enhancement business networking system.

LiSTN: An intricate series of event listeners, and even moderators that trigger response loops based on User interaction and potential trigger factors. Where the system can incorporate the functionality of LiSTN to maintain real time worldwide dynamic responsiveness across the digital and real world dimensions. As well as maintaining a key role to ensure augmentation is projected and received in real time, that the interactive responsiveness is detected and processed in real time, and that the User is pushed the following action series according to the prior interaction in real time. Thereby allowing the system augmentative responsiveness to be seamless and the actions thereafter to yield real time streamlined system action. LiSTN can also be used for command control and trigger operations where applicable.

Gamified Governance: An overarching engagement system that incentivizes the user to interact with the many facets of the system to gain rewards, whilst providing the system with real time datafication of User psychology, based on User interaction and User preferences. Whereby, the system may learn emotional and psychological responsiveness based on the constant User preference data feed. Gamified Governance allows for the system to objectify intentions and streamline pathways with incentives that provide the User with functional game elements such as rewards feedback loops, terrain manipulation, storylines (pathways, missions, trails), geocache data packets, etc

Rewards LOOP: Providing Users with gamified profiles that will incorporate feedback loops to adjust their gamification elements in real time. Where User's ratings, joux/points, experience points, badges, titles, level, and access keys can be adjusted according to their successes and/or failures during their system interaction. Where governors will be placed on the User depending on their gamification metrics, adjusting their access to new tools, portals, locations, elements, and layers (where layers determine the system's overall functionality).

Terrain Manipulation: Allowing Users to adjust their world view based on their User preferences in real time, where Users can layer the system operations in such a way that the environment reflects the User preferences visually and in functionality. Where the terrain is constructed into a visual representation of layered node matrices and the functional elements therein. Users can also zoom out and drop into other locations that they have unlocked using the Sky View feature, where the User will be able to view the Live Activity Data in the selected locations, where Users can also use an avatar to interact with the selected unlocked location (explore, challenges streams, etc).

Storyline: Creating trails, pathways, and missions for Users to follow and interact with. Where a User can follow their own system-generated storyline based on User interaction/indication/preferences, or a content creator's storyline such as a trail, pathway, or mission published by an influencer, trailblazer, or project developer. Storylines can be macrocosms of tasks and challenges, which will be pushed as featured challenges or tests, or storylines can be overarching character development for the User where they may increase their skills, complete tasks, and compete for resources based on their interaction with their personal storyline. In either case, the User, system, or other Users may place bets for, or against the User's ability to achieve any selected storyline (even something as simple as losing 10 kg this month), where Users may place bets based on the active storyline(s).

FireCloud: Providing Users with a base camp where they can access data caches, such that Users can download, upload or otherwise update their data, tool up, kit up, modify version control, exchange or trade their assets, log new skills or otherwise update the hard copy of the User's profile/map-matrix, their access or how they view the system when operating offline. FireCloud creates a gameplan matrix, for Users to rewrite their playbook for offline operations, where they will be able to access what they want and operate as they need, even when offline. Where Users will be able to push data packets, and/or discover data packets. Where data packets are indicative of pre-sets, logged User matrices, or otherwise composed of data indicative of a Users experience, stored in FireCloud for future access with either private or public keys depending on the access/privacy settings indicated.

Domes (Dome Tech): Tech integrations that will provide access to data, networks/connectivity, events, actions, or the like. Where Users can engage a C-Orb, C-Buckyball, or AMP-A repeater to achieve any of the aforementioned system operations. Such that a User will either enter the sphere of a dome (e.g., a zone with a C-Orb dome), where the Users experience will become augmented by the functionality of the C-Orb, such that new networks, connections, other Users, challenges, activities, etc can be pushed to the User for their potential interaction within the dome, or the User can activate a dome tech through selective action, where a User will intentionally engage an available dome tech element to augment their gamified experience, such that the user may participate in activities, or otherwise interact with data therein. Where a User could participate in a gamified experience, with feedback loops, point matrices, and governance systems, within a select dome, such that the User would be in an augmented game radii facilitated by dome tech which can be integrated with hardware elements, network connectivity, streaming, etc. where a dome game may have parameters to the physical location (e.g., radii) and/or the virtual location (e.g., interaction). Further, where a dome game can have a script or series of event nodes/listeners with trigger wires based on threshold responsiveness. Where domes may be further enhanced or extended should a User engage one or more AMP-A repeaters.

These basic elements, among others, contribute to the gamification, moreover, the gamified governance of the industry and everything that it touches, be it the gaming industry, tourism, content sharing, streaming, browsing, data storage, business networking, fintech, productivity networking, and processing, etc.

The Celestification system creates a dynamic trans-world environment that spans over digital and real world realms with interactive gamified system features. The system integrates a diverse array of detection and response systems to feed into time feedback loops that determine User interaction and rewards matrices. Where a User is able to create, modify and exist in their own custom world spanning over digital and real world environments, connecting with digital and real world people, places, and things. These actions can be detected and projected into an interactive augmented real world simulation, where each user is in control of their own reality. This system allows for these interactive experiences to occur because of the extensive streamlining and the key integral features that ensure that each Users impact on server host load, networking, data usage, and system requirements is lessened to facilitate efficient operations in real time with minimal energy and data usage. Thus, allowing for extensive real time functionality without the burden on the system through compartmentalization and customization of system application operations.

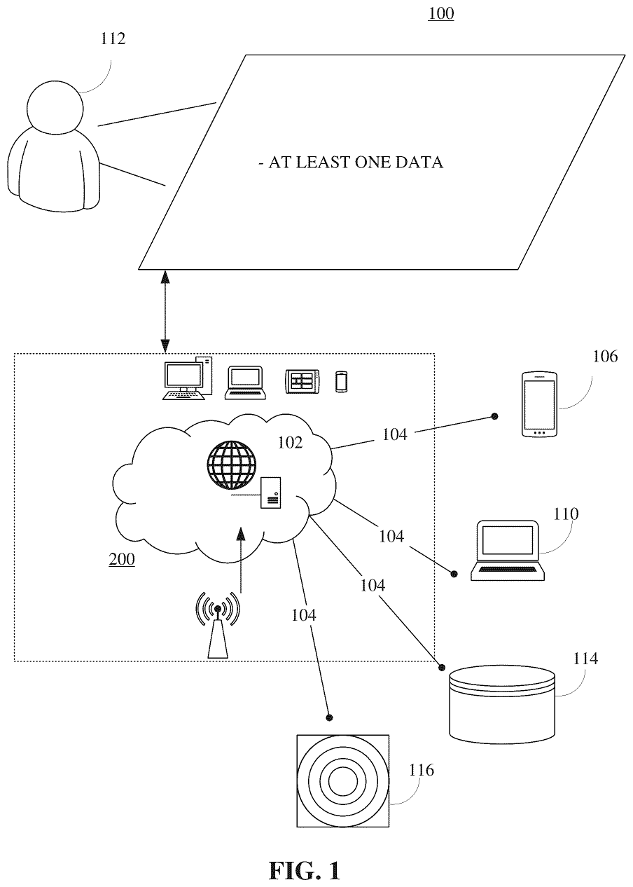

FIG. 1 is an illustration of an online platform 100 consistent with various embodiments of the present disclosure. By way of non-limiting example, the online platform 100 to facilitate tailoring experiences of users may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

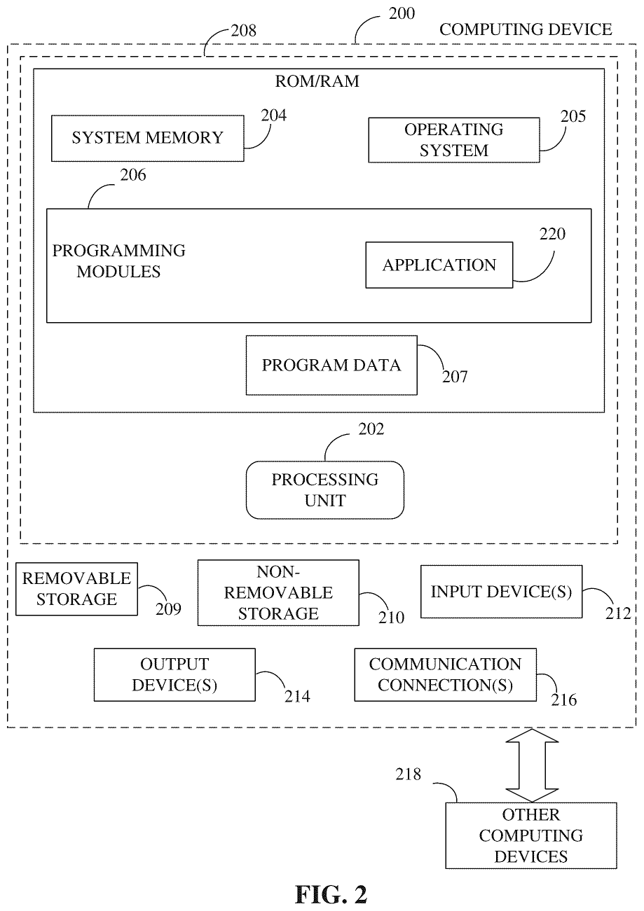

With reference to FIG. 2, a system consistent with an embodiment of the disclosure may include a computing device or cloud service, such as computing device 200. In a basic configuration, computing device 200 may include at least one processing unit 202 and a system memory 204. Further, the at least one processing unit 202 may include at least one classical processing unit and at least one quantum processing unit. Further, the at least one quantum processing unit employs one or more quantum processing technologies. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing modules, machine learning modules, etc. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases (such as classical databases, quantum databases, etc.) as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

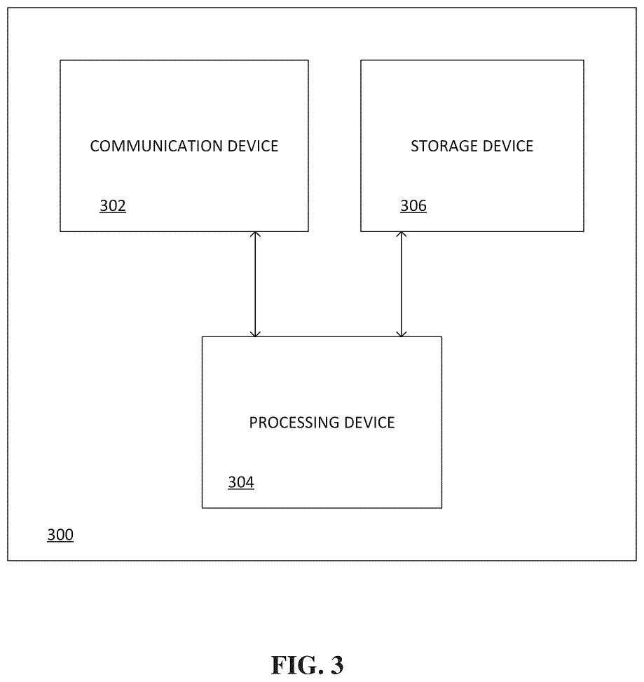

FIG. 3 is a block diagram of a system 300 for facilitating modifying experiential environments based on user preferences, in accordance with some embodiments. Accordingly, the system 300 may include a communication device 302, a processing device 304, and a storage device 306.

Further, the communication device 302 may be configured for performing a step of receiving one or more interaction data of one or more interactions of a user in relation to one or more experiential environments of two or more experiential environments from one or more user devices.

Further, the processing device 304 may be communicatively coupled with the communication device 302. Further, the processing device 304 may be configured for performing a step of analyzing the one or more interaction data. Further, the processing device 304 may be configured for performing a step of determining two or more user preferences associated with the user based on the analyzing of the one or more interaction data. Further, the processing device 304 may be configured for performing a step of provisioning two or more content corresponding to the two or more experiential environments based on the two or more user preferences.

Further, the storage device 306 may be communicatively coupled with the processing device 304. Further, the storage device 306 may be configured for performing a step of storing the one or more interaction data and the two or more user preferences.

In some embodiments, the one or more user devices may include one or more interaction detecting sensors. Further, the one or more interaction detecting sensors may be configured for generating the one or more interaction data based on capturing the one or more interactions of the user.

In some embodiments, the analyzing of the one or more interaction data may include analyzing the one or more interaction data using one or more machine learning models. Further, the determining of the two or more user preferences may include inferring the two or more user preferences based on the analyzing of the one or more interaction data using the one or more machine learning models.

In some embodiments, the one or more interaction data may include one or more historical interaction data. Further, the one or more historical interaction data may include one or more historical interactions of the user in relation to the one or more experiential environments. Further, the analyzing of the one or more interaction data may include analyzing the one or more historical interaction data. Further, the determining of the two or more user preferences may be further based on the analyzing of the one or more historical interaction data.

In some embodiments, the one or more interaction data may include two or more direct indications of the two or more user preferences of the user. Further, the analyzing of the one or more interaction data may include identifying the two or more direct indications of the two or more user preferences. Further, the determining of the two or more user preferences may be further based on the identifying.

In some embodiments, the processing device 304 may be configured for performing a step of determining one or more imagery adjustments for a framework of perception of the two or more experiential environments based on the determining of the two or more user preferences. Further, the provisioning of the two or more content corresponding to the two or more experiential environments may include modifying the two or more content corresponding to the two or more experiential environments based on the one or more imagery adjustments.

In some embodiments, the processing device 304 may be configured for performing a step of adjusting two or more layers in the two or more experiential environments based on the two or more user preferences. Further, the provisioning of the two or more content corresponding to the two or more experiential environments may be further based on the adjusting. Further, the two or more layers may include one or more of two or more data layers, two or more imagery layers, and two or more perception layers.

In some embodiments, the communication device 302 may be configured for performing a step of receiving one or more environmental sensor data from one or more environmental sensors. Further, the one or more environmental sensors may be configured for generating the one or more environmental sensor data based on capturing one or more environment characteristics of an environment associated with the user. Further, the processing device 304 may be configured for performing a step of analyzing the one or more environmental sensor data. Further, the determining of the two or more user preferences may be further based on the analyzing of the one or more environmental sensor data.

In some embodiments, the communication device 302 may be configured for performing a step of receiving one or more activity data of one or more activities of the user from one or more activity detector devices. Further, the one or more activity detector devices may be configured for generating the one or more activity data based on detecting an activity of the user in relation to the one or more experiential environments. Further, the processing device 304 may be configured for performing a step of analyzing the one or more activity data. Further, the determining of the two or more user preferences may be further based on the analyzing of the one or more activity data.

In some embodiments, the communication device 302 may be configured for performing a step of receiving one or more conditions associated with the one or more interactions from the one or more user devices. Further, the processing device 304 may be configured for performing a step of analyzing the one or more conditions. Further, the determining of the two or more user preferences may be further based on the analyzing of the one or more conditions.

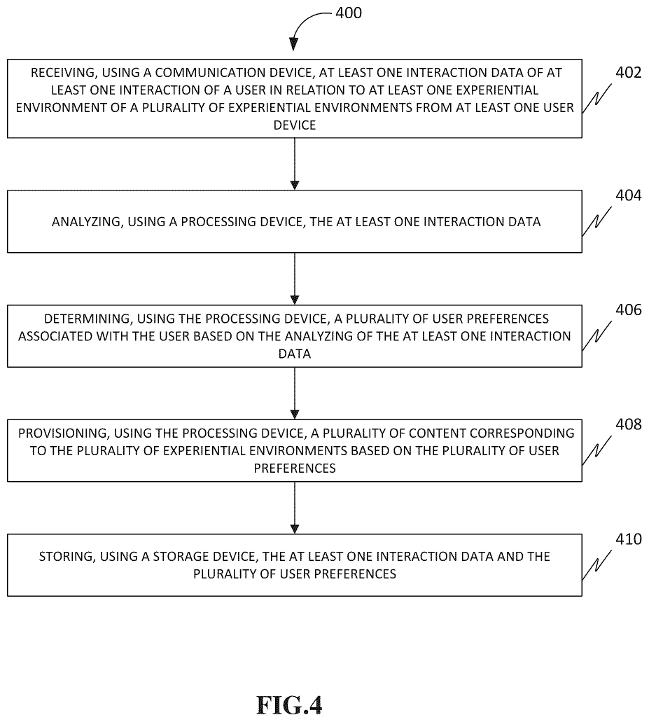

FIG. 4 is a flowchart of a computer implemented method 400 for facilitating modifying environments based on user preferences, in accordance with some embodiments. Accordingly, the computer implemented method 400 may include a step 402 of receiving, using a communication device, one or more interaction data of one or more interactions of a user in relation to one or more experiential environments of two or more experiential environments from one or more user devices. Further, the or more experiential environments may include worlds, be it virtual, digital, real, augmented, or any other realm of reality. Further, the computer implemented method 400 may include a step 404 of analyzing, using a processing device, the one or more interaction data. Further, the computer implemented method 400 may include a step 406 of determining, using the processing device, two or more user preferences associated with the user based on the analyzing of the one or more interaction data. Further, the computer implemented method 400 may include a step 408 of provisioning, using the processing device, two or more content corresponding to the two or more experiential environments based on the two or more user preferences. Further, the two or more content may include elements of the real world, physical objects, virtual objects, social interactions, and digital processes. Further, the computer implemented method 400 may include a step 410 of storing, using a storage device, the one or more interaction data and the two or more user preferences.

In some embodiments, the one or more user devices may include one or more interaction detecting sensors. Further, the one or more interaction detecting sensors may be configured for generating the one or more interaction data based on capturing the one or more interactions of the user.

In some embodiments, the analyzing of the one or more interaction data may include analyzing the one or more interaction data using one or more machine learning models. Further, the determining of the two or more user preferences may include inferring the two or more user preferences based on the analyzing of the one or more interaction data using the one or more machine learning models.

In some embodiments, the one or more interaction data may include one or more historical interaction data. Further, the one or more historical interaction data may include one or more historical interactions of the user in relation to the one or more experiential environments. Further, the analyzing of the one or more interaction data may include analyzing the one or more historical interaction data. Further, the determining of the two or more user preferences may be further based on the analyzing of the one or more historical interaction data. Further, the one or more historical data may include user interaction data, recorded User preferences, patterns of use, historical data cache, and gamification trajectories.

In some embodiments, the one or more interaction data may include two or more direct indications of the two or more user preferences of the user. Further, the analyzing of the one or more interaction data may include identifying the two or more direct indications of the two or more user preferences. Further, the determining of the two or more user preferences may be further based on the identifying.

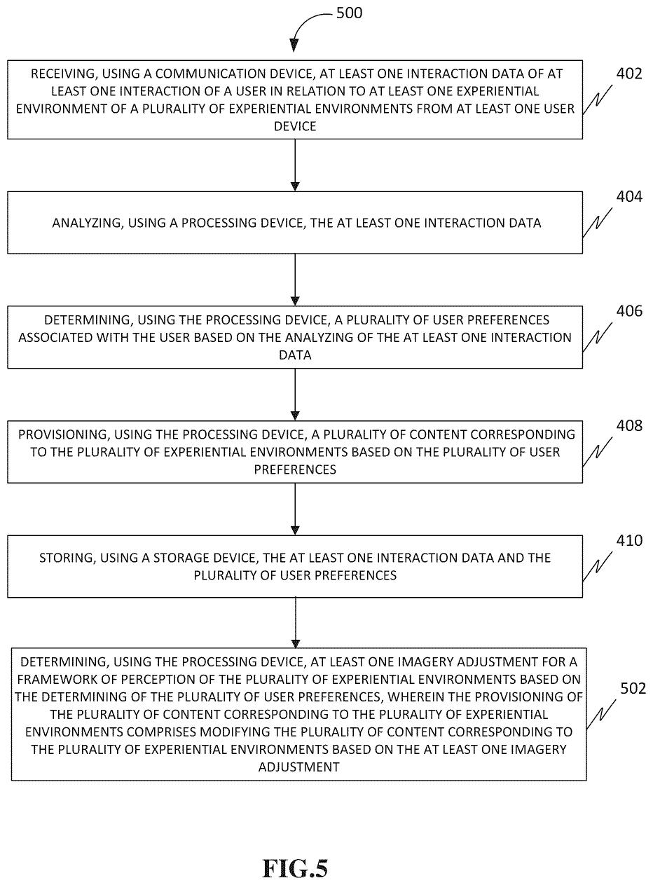

FIG. 5 is a flowchart of a computer implemented method 500 for facilitating modifying experiential environments based on user preferences, in accordance with some embodiments. The steps 402-410 have explained in detail in conjunction with FIG. 4 above. Further, the computer implemented method 500 may further may include a step 502 of determining, using the processing device, one or more imagery adjustments for a framework of perception of the two or more experiential environments based on the determining of the two or more user preferences. Further, the provisioning of the two or more content corresponding to the two or more experiential environments may include modifying the two or more content corresponding to the two or more experiential environments based on the one or more imagery adjustments.

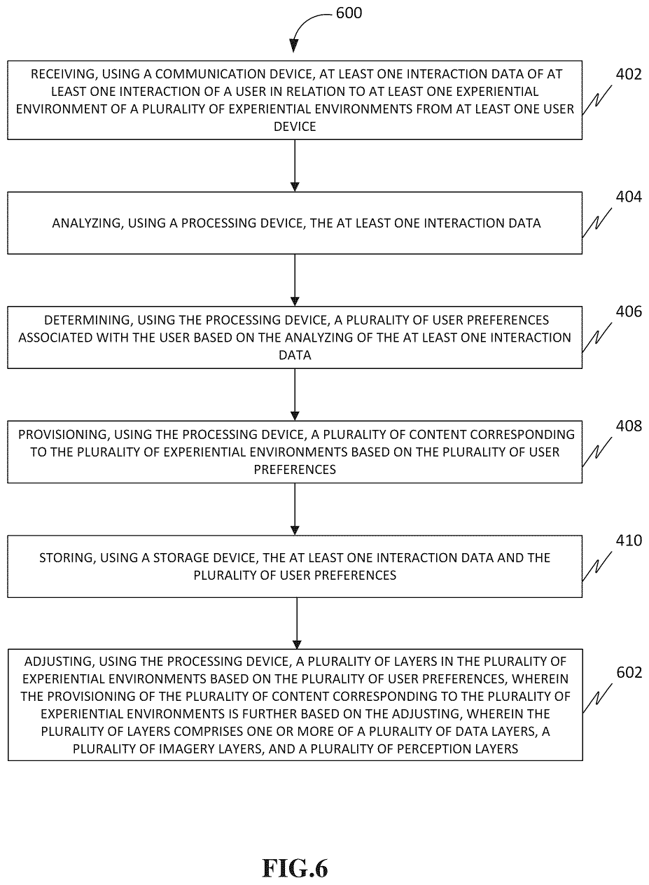

FIG. 6 is a flowchart of a computer implemented method 600 for facilitating modifying experiential environments based on user preferences, in accordance with some embodiments. The steps 402-410 have explained in detail in conjunction with FIG. 4 above. Further, the computer implemented method 600 may include a step 602 of adjusting, using the processing device, two or more layers in the two or more experiential environments based on the two or more user preferences. Further, the provisioning of the two or more content corresponding to the two or more experiential environments may be further based on the adjusting. Further, the two or more layers may include one or more of two or more data layers, two or more imagery layers, and two or more perception layers.

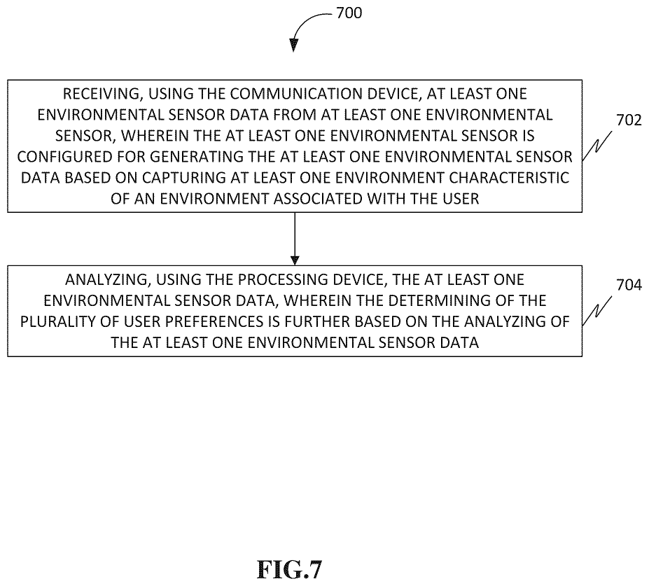

FIG. 7 is a flowchart of a computer implemented method 700 for facilitating modifying experiential environments based on user preferences, in accordance with some embodiments. Further, the computer implemented method 700 may include a step 702 of receiving, using the communication device, one or more environmental sensor data from one or more environmental sensors. Further, the one or more environmental sensors may be configured for generating the one or more environmental sensor data based on capturing one or more environment characteristics of an environment associated with the user. Further, the computer implemented method 700 may include a step 704 of analyzing, using the processing device, the one or more environmental sensor data. Further, the determining of the two or more user preferences may be further based on the analyzing of the one or more environmental sensor data.

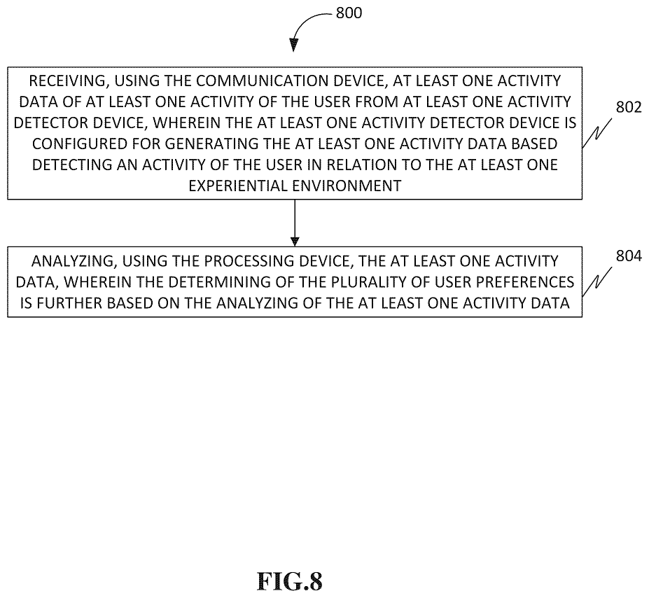

FIG. 8 is a flowchart of a computer implemented method 800 for facilitating modifying experiential environments based on user preferences, in accordance with some embodiments. Further, the computer implemented method 800 may include a step 802 of receiving, using the communication device, one or more activity data of one or more activities of the user from one or more activity detector devices. Further, the one or more activity detector devices may be configured for generating the one or more activity data based on detecting an activity of the user in relation to the one or more experiential environment. Further, the computer implemented method 800 may include a step 802 of analyzing, using the processing device, the one or more activity data. Further, the determining of the two or more user preferences may be further based on the analyzing of the one or more activity data.

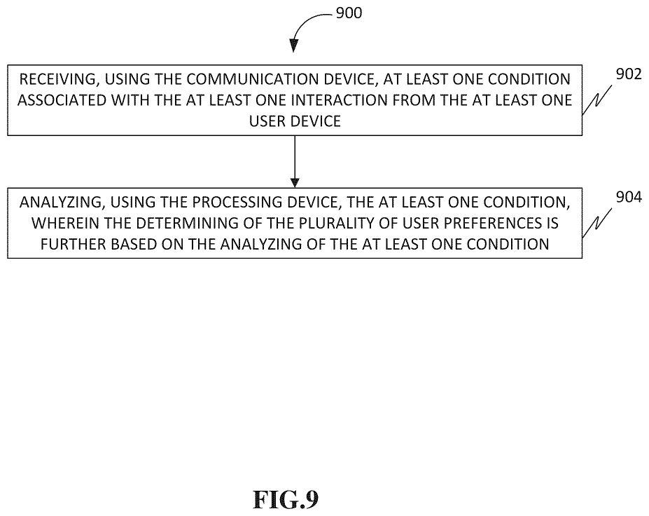

FIG. 9 is a flowchart of a computer implemented method 900 for facilitating modifying experiential environments based on user preferences, in accordance with some embodiments. Further, the computer implemented method 900 may include a step 902 of receiving, using the communication device, one or more conditions associated with the one or more interactions from the one or more user devices. Further, the one or more conditions may include circumstances. Further, the computer implemented method 900 may include a step 904 of analyzing, using the processing device, the one or more conditions. Further, the determining of the two or more user preferences may be based on the analyzing of the one or more conditions.

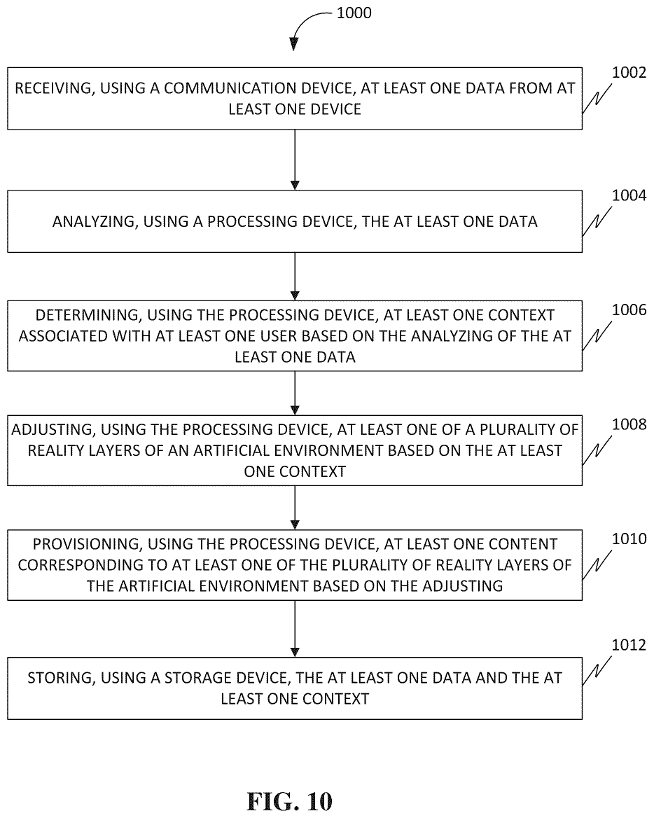

FIG. 10 is a flowchart of a method 1000 for facilitating tailoring experiences of users, in accordance with some embodiments. Further, the method 1000 may include a computer implemented method, a method associated with Celeste Opera system, Celeste Opera method, etc. Further, the method 1000 may facilitate modifying of environments. Further, the method 1000 may include a step 1002 of receiving, using a communication device, at least one data from at least one device. Further, the at least one data may include a multi dimensional data. Further, the at least one device may include one or more user devices, one or more computing devices, one or more client devices, one or more wearable computing devices, etc. Further, the at least one data may include at least one data stream streamed by the at least one device. Further, the at least one data may include a biometric data (such as heart rate data associated with a heart rate of the at least one user, neural activity data associated with a neural activity of the at least one user, skin conductivity data associated with a skin conductivity of the at least one user, etc.), an environmental data (such as temperature data of a temperature of a real environment of the at least one user, light data associated with a lighting in the real environment, location data of a location of the real environment, etc.), a physical activity data (such as user movement data of movements made by the at least one user, gesture data of gestures made by the at least one user, etc.), etc. Further, in an embodiment, the receiving of the at least one data may include receiving the at least one data from the at least one device in real time. Further, the receiving of the at least one data from the at least one device may include collecting the at least one data from the at least one device. Further, in an embodiment, the at least one device may be configured for generating the at least one data. Further, in an embodiment, the at least one data may be stored in the at least one device. Further, in an embodiment, the at least one data may include one or more interaction data of one or more interactions of the at least one user in relation to an artificial environment provisioned to the at least one user, and one or more environment data associated with a real environment of the at least one user.

Further, the method 1000 may include a step 1004 of analyzing, using a processing device, the at least one data.

Further, the method 1000 may include a step 1006 of determining, using the processing device, at least one context associated with at least one user based on the analyzing of the at least one data. Further, the at least one context may include a preference of the at least one user, a behavior of the at least one user, an environment factor of a real environment, etc. Further, the at least one context may include a user context, an operation context, an environmental context, etc.

Further, the method 1000 may include a step 1008 of adjusting, using the processing device, at least one of a plurality of reality layers of an artificial environment based on the at least one context. Further, the plurality of reality layers may include an augmented reality (AR) layer, a mixed reality (MR) layer, a virtual reality (VR) layer, a digital reality (DR) layer, a simulated reality (SR) layer, etc. Further, the plurality of reality layers corresponds to the artificial environment and/or overlay associated with at least one of Augmented Reality (AR), Mixed Reality (MR), Virtual Reality (VR), Simulated Reality (SR), and Digital Reality (DR), that interacts with the at least one user. Further, the artificial environment may include a multi-planed reality. Further, the artificial environment may include one or more experiential environments, one or more generated environments, one or more computer-generated environments, etc. Further, the adjusting of at least one of the plurality of reality layers may include coordinating, adapting, transitioning, synchronizing, activating, orchestrating, etc., at least one of the plurality of reality layers. Further, the adjusting of at least one of the plurality of reality layers may include adjusting one or more content of at least one of the plurality of reality layers, a complexity of at least one of the plurality of reality layers, a state of at least one of the plurality of reality layers, etc. Further, in an embodiment, each of the plurality of reality layers may be characterized by at least one of an interaction level and an immersion level. Further, the adjusting of at least one of the plurality of reality layers aligns at least one interaction of the at least one user with the artificial environment based on at least one a preference and a requirement (such a need) associated with the at least one user. Further, the adjusting of at least one of the plurality of reality layers may include adjusting at least one of an immersion level and an interaction level of at least one of the plurality of reality layers. Further, at least one of the immersion level and the interaction level corresponds to an intensity of an immersion and an interaction of the at least one user with the artificial environment. Further, the adjusting of at least one of the plurality of reality layers adjusts the experience of the at least one user in the artificial environment. Further, the adjusting of at least one of the plurality of reality layers may include adjusting at least one of the plurality of reality layers in real time.

Further, the method 1000 may include a step 1010 of provisioning, using the processing device, at least one content corresponding to at least one of the plurality of reality layers of the artificial environment based on the adjusting. Further, the at least one content may include a virtual object, a digital object, a simulated object, an interactive object, etc. Further, the at least one content may include a virtual element, a digital element, a simulated element, an interactive element, etc. Further, in an embodiment, the provisioning of the at least one content corresponding to at least one of the plurality of reality layers may include provisioning the at least one content corresponding to at least one of the plurality of reality layers on at least one additional device. Further, the at least one additional device may include a user device, a computing device, a client device, a display device, a head mounted device (HMD), a head-up display device, a headset, etc.

Further, the method 1000 may include a step 1012 of storing, using a storage device, the at least one data and the at least one context.

Further, in some embodiments, the at least one device may include a plurality of devices. Further, a first device of the plurality of devices may include at least one first sensor. Further, the first device may be worn by the at least one user. Further, the first device may include a wearable (such as Yamaker, Hiss wearables, Vicci wear, etc.), an exosuit, a wristlet, etc. Further, the at least one first sensor may include a movement sensor, a motion sensor, a physiological sensor, a biometric sensor, a galvanic response sensor, a heart rate sensor, an electroencephalogram (EEG) sensor, a microphone, a camera (such as an infrared camera, a visible light camera, an ultraviolet camera, an X-ray camera, a multispectral camera, etc.). Further, the at least one first sensor may be non invasive sensor. Further, the at least one first sensor may be configured for generating at least one first sensor data by detecting at least one activity of the at least one user. Further, the at least one activity may include a physical activity (such as motions, movement, etc.), a neural activity (such as brainwave activity), an emotional activity (such as skin conductance), a cognitive activity, a speech (such as voice tone), a facial activity (such as microexpression), etc. Further, a second device of the plurality of devices may include at least one second sensor. Further, the second device may be a drone (such as Skowl DS drones). Further, the drone may be a static and/or capable of aerial movement, ground movement, etc. Further, the drone may include an aerial drone, a ground drone, etc. Further, the at least one second sensor may include an environmental sensor, a temperature sensor, a humidity sensor, a light sensor, a Light Detection and Ranging (LIDAR) sensor, a camera, an ultrasound sensor, etc. Further, the at least one second sensor may be configured for generating at least one second sensor data by detecting at least one environment characteristic associated with a real environment of the at least one user. Further, the at least one environment characteristic may include a temperature, a humidity, a lighting, a terrain, a pressure, etc. Further, the at least one environment characteristic an environmental input, an environmental condition, etc. Further, the at least one data may include the at least one first sensor data and the at least one second sensor data.

Further, the at least one device may include at least one energy harvesting unit, at least one energy storage unit, and an energy management unit. Further, the at least one energy harvesting unit may be configured for generating electrical energy by harvesting at least one energy. Further, the at least one energy harvesting unit may include at least one of a device and an element for harvesting the at least one energy. Further, at least one of the device and the element may include a photovoltaic panel, a wind turbine, a piezoelectric generator, a thermoelectric generator, etc. Further, the at least one energy may include solar energy, wind energy, kinetic energy, thermal energy, etc. Further, the at least one energy storage unit may be electrically coupled with the at least one energy harvesting unit. Further, the at least one energy storage unit may be configured for storing at least one amount of the electrical energy based on the generating of the electrical energy. Further, the at least one energy storage unit may include a battery, a capacitor, an ultracapacitor, etc. Further, the energy management unit may be electrically coupled with the at least one energy storage unit. Further, the energy management unit may be configured for supplying at least one portion of the at least one amount of the electrical energy for at least one operation based on at least one energy allocation associated with the at least one operation. Further, the energy management unit may include at least one processing unit. Further, the at least one processing unit may be configured for executing at least one algorithm. Further, the at least one algorithm may include an adaptive power distribution algorithm. Further, the at least one operation may include a communication operation, a data transmission operation, a data collection operation, a data processing operation, an activity monitoring operation, an environment monitoring operation, etc. Further, the at least one operation may be associated with the at least one device, the communication device, the processing device, the storage device, etc.

Further, in some embodiments, the receiving of the at least one data from the at least one device may include receiving the at least one data using at least one communication method through at least one communication network device comprised in at least one communication network from the at least one device. Further, the at least one communication method may include quantum flash. Further, the at least one communication method may include a transmission method employing quantum entanglement principles. Further, the at least one communication network device may include at least one node. Further, the at least one node may include a decentralized data node, an internal node, an external node, a decentralized node, etc. Further, the at least one communication network may include a decentralized network, an internal network, a private network, a controlled network, etc.

In further embodiments, the method 1000 may include a step of selecting, using the processing device, the at least one communication network from a plurality of communication networks based on at least one constraint. Further, the receiving of the at least one data using the at least one communication method through the at least one communication network device comprised in the at least one communication network may be based on the selecting of the at least one communication network.

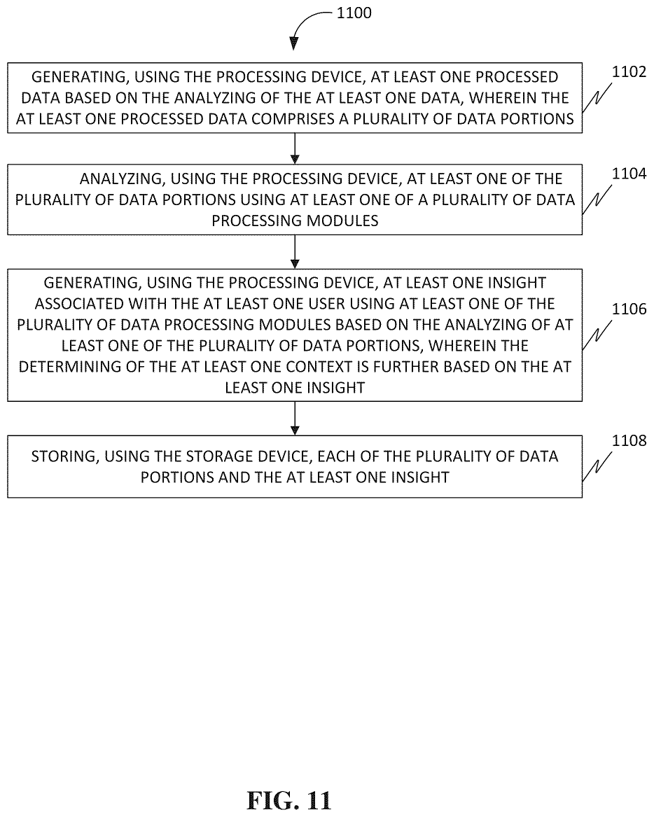

FIG. 11 is a flowchart of a method 1100 for facilitating tailoring experiences of users, in accordance with some embodiments. Accordingly, the method 1100 may include a step 1102 of generating, using the processing device, at least one processed data based on the analyzing of the at least one data. Further, the at least one processed data may include a plurality of data portions. Further, each of the plurality of data portions may be associated with a specific data type. Further, the analyzing of the at least one data may include preprocessing, organizing, segmenting, classifying, etc. of the at least one data.

Further, the method 1100 may include a step 1104 of analyzing, using the processing device, at least one of the plurality of data portions using at least one of a plurality of data processing modules. Further, each of the plurality of data processing modules may be associated with a specific type. Further, a data processing module of a type analyzes a data portion of a data type corresponding to the type of the data processing module. Further, the plurality of data processing modules may include a subsystem, etc. Further, the plurality of data processing modules may be comprised in a machine learning (ML) layer. Further, the plurality of data processing modules may include a Behavioral Intelligence (BI), an Environmental Intelligence (EI), an Operational Intelligence (OI), etc. Further, the plurality of data processing modules may be artificial intelligence (AI) modules, machine learning (ML) modules, etc.

Further, the method 1100 may include a step 1106 of generating, using the processing device, at least one insight associated with the at least one user using at least one of the plurality of data processing modules based on the analyzing of at least one of the plurality of data portions. Further, the determining of the at least one context may be based on the at least one insight. Further, the at least one insight may include BI insight, EI insight, OI insight, BI inputs, EI inputs, OI inputs, etc. Further, the adjusting of at least one of the plurality of reality layers may include adjusting at least one of the plurality of reality layers using a layer synchronization module (LSM). Further, the LSM may implement the at least one insight for the adjusting.

Further, the method 1100 may include a step 1108 of storing, using the storage device, each of the plurality of data portions and the at least one insight.

Further, in some embodiments, the plurality of data portions may include a first data portion associated with at least one behavioral state of the at least one user, a second data portion associated with an environment state associated with the at least one user, and a third data portion associated with at least one interaction of the at least one user in relation to at least one of the plurality of reality layer of the artificial environment. Further, the behavioral state may include a cognitive state, a neural state, a mental state, an emotional state, etc. Further, the environment state may include an environmental condition of the real environment.

Further, in an embodiment, the analyzing of at least one of the plurality of data portions using at least one of the plurality of data processing modules may include analyzing the first data portion using a first data processing module (such as BI) of the plurality of data processing modules. Further, the analyzing of at least one of the plurality of data portions using at least one of the plurality of data processing modules may include analyzing the second data portion using a second data processing module (such as EI) of the plurality of data processing modules. Further, the analyzing of at least one of the plurality of data portions using at least one of the plurality of data processing modules may include analyzing the third data portion using a third data processing module (such as OI) of the plurality of data processing modules.

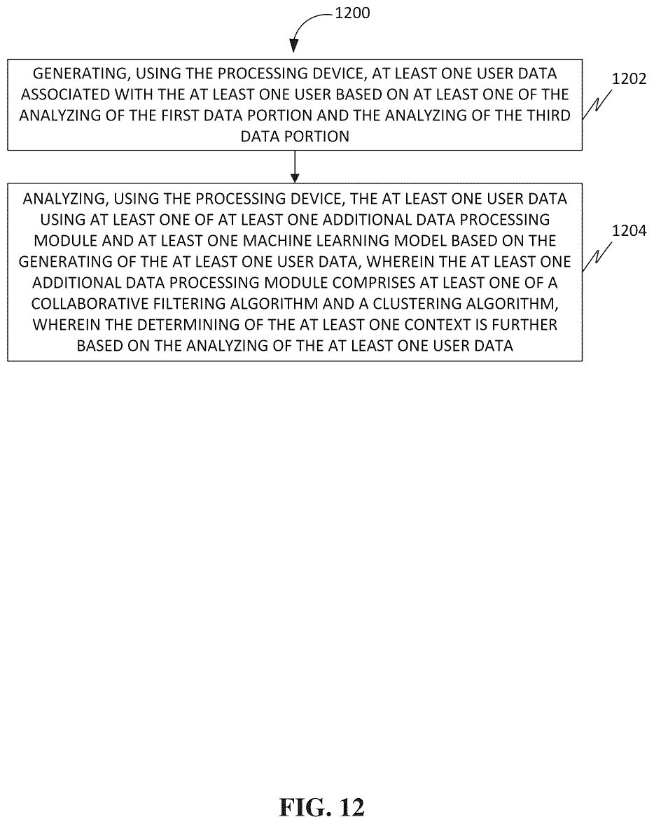

FIG. 12 is a flowchart of a method 1200 for facilitating tailoring experiences of users, in accordance with some embodiments. Accordingly, the method 1200 may include a step 1202 of generating, using the processing device, at least one user data associated with the at least one user based on at least one of the analyzing of the first data portion and the analyzing of the third data portion. Further, the at least one user data may include an emotional data, a cognitive data, a user interaction data, a feedback data, a behavioral data, etc. Further, the feedback data may include a physical feedback, an emotional feedback, a behavioural feedback, etc.

Further, the method 1200 may include a step 1204 of analyzing, using the processing device, the at least one user data using at least one of at least one additional data processing module and at least one machine learning model based on the generating of the at least one user data. Further, the at least one additional data processing module may include at least one of a collaborative filtering algorithm and a clustering algorithm. Further, the determining of the at least one context may be based on the analyzing of the at least one user data. Further, the at least one additional data processing module may include DNA Rating System (DNA-RS). Further, the at least one machine learning model may include a recurrent neural network model, a long short-term memory (LSTM) network model, a generative machine learning model, a graph neural network model, etc. Further, the at least

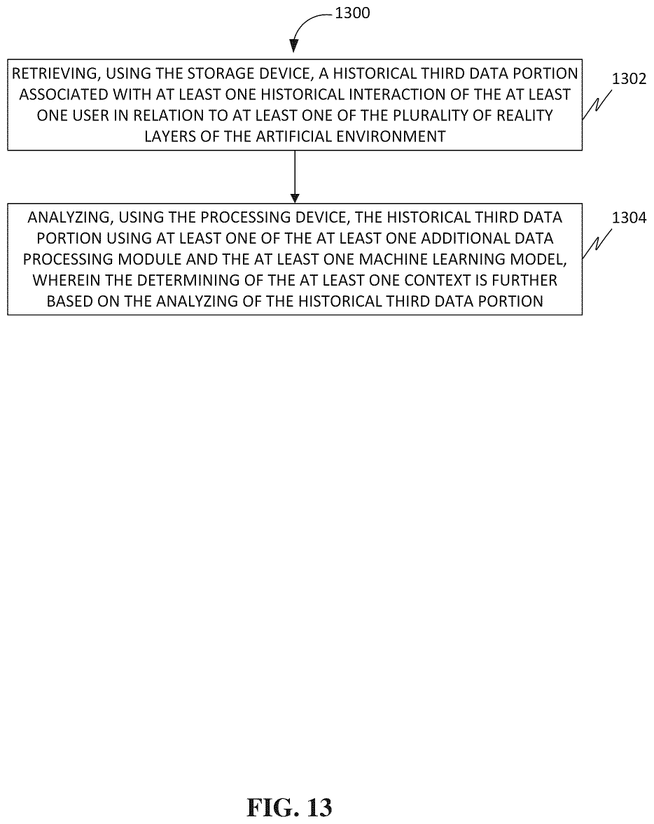

FIG. 13 is a flowchart of a method 1300 for facilitating tailoring experiences of users, in accordance with some embodiments. Accordingly, the method 1300 may include a step 1302 of retrieving, using the storage device, a historical third data portion associated with at least one historical interaction of the at least one user in relation to at least one of the plurality of reality layers of the artificial environment. Further, the historical third data portion may include an interaction history of the at least one user.

Further, the method 1300 may include a step 1302 of analyzing, using the processing device, the historical third data portion using at least one of the at least one additional data processing module and the at least one machine learning model. Further, the determining of the at least one context may be based on the analyzing of the historical third data portion. Further, the at least one machine learning model may be configured for predicting one or more potential interactions of the at least one user, simulating the one or more potential interactions, and predicting one or more outcomes for the one or more potential interaction. Further, the determining of the at least one content may be based on the one or more outcomes and the one or more potential interactions.

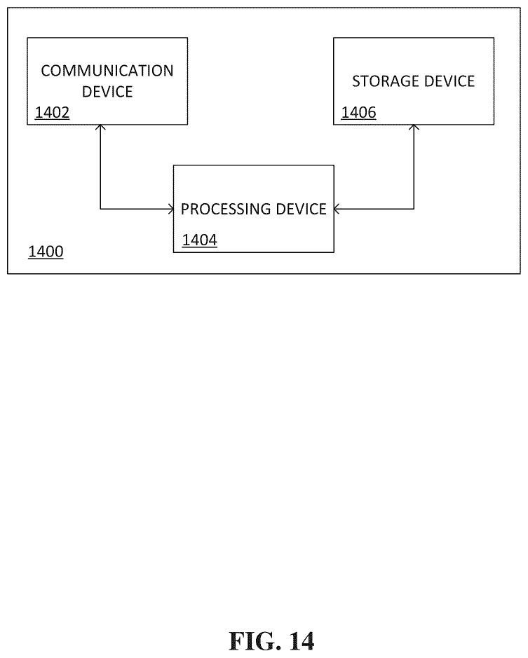

FIG. 14 is a block diagram of a system 1400 for facilitating tailoring experiences of users, in accordance with some embodiments. Further, the system 1400 may include Celeste Opera system. Further, the system 1400 may include a quantum cloud. Further, the system 1400 may include a communication device 1402, a processing device 1404, and a storage device 1406.

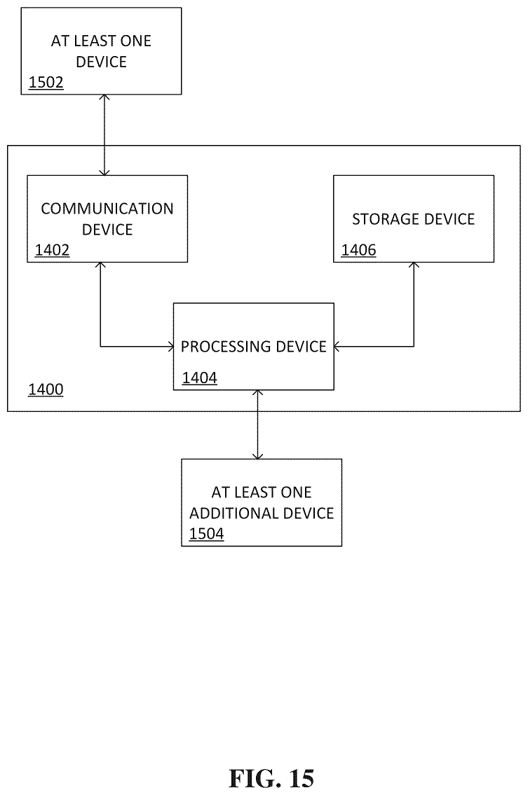

Further, the communication device 1402 may be configured for receiving at least one data from at least one device 1502, as shown in FIG. 15.

Further, the processing device 1404 may be communicatively coupled with the communication device 1402. Further, the processing device 1404 may be configured for analyzing the at least one data. Further, the processing device 1404 may be configured for determining at least one context associated with at least one user based on the analyzing of the at least one data. Further, the processing device 1404 may be configured for adjusting at least one of a plurality of reality layers of an artificial environment based on the at least one context. Further, the processing device 1404 may be configured for provisioning at least one content corresponding to at least one of the plurality of reality layers of the artificial environment based on the adjusting. Further, in an embodiment, the provisioning of the at least one content corresponding to at least one of the plurality of reality layers may include provisioning the at least one content corresponding to at least one of the plurality of reality layers on at least one additional device 1504, as shown in FIG. 15. Further, the at least one additional device 1504 may include a user device, a computing device, a client device, a display device, a head mounted device (HMD), a head-up display device, a head set, etc. Further, the processing device 1404 may include at least one quantum processing unit, at least one classical processing unit, a neural processing unit (NPU), etc. Further, the at least one quantum processing unit employs at least one quantum algorithm for the analyzing of the at least one data.

Further, the storage device 1406 may be communicatively coupled with the processing device 1404. Further, the storage device 1406 may be configured for storing the at least one data and the at least one context.

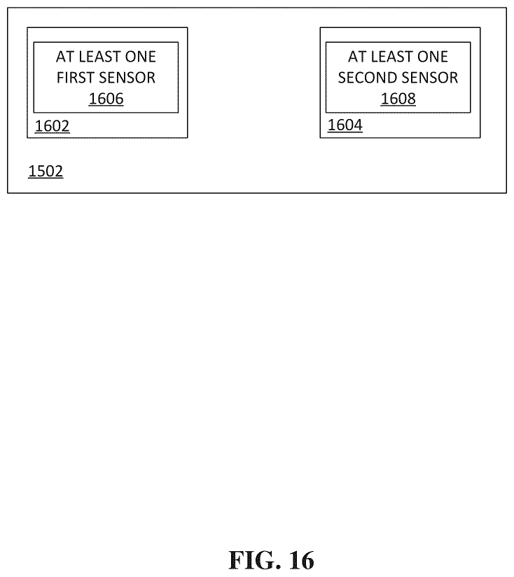

Further, in some embodiments, the at least one device 1502 may include a plurality of devices 1602-1604, as shown in FIG. 16. Further, a first device 1602 of the plurality of devices 1602-1604 may include at least one first sensor 1606, as shown in FIG. 16. Further, the at least one first sensor 1606 may be configured for generating at least one first sensor data by detecting at least one activity of the at least one user. Further, a second device 1604 of the plurality of devices 1602-1604 may include at least one second sensor 1608, as shown in FIG. 16. Further, the at least one second sensor 1608 may be configured for generating at least one second sensor data by detecting at least one environment characteristic associated with a real environment of the at least one user. Further, the at least one data may include the at least one first sensor data and the at least one second sensor data.

Further, in some embodiments, the processing device 1404 may be further configured for generating at least one processed data based on the analyzing of the at least one data. Further, the at least one processed data may include a plurality of data portions. Further, the processing device 1404 may be configured for analyzing at least one of the plurality of data portions using at least one of a plurality of data processing modules. Further, the processing device 1404 may be configured for generating at least one insight associated with the at least one user using at least one of the plurality of data processing modules based on the analyzing of at least one of the plurality of data portions. Further, the determining of the at least one context may be further based on the at least one insight. Further, the storage device 1406 may be further configured for storing each of the plurality of data portions and the at least one insight.

Further, in an embodiment, the plurality of data portions may include a first data portion associated with at least one behavioral state of the at least one user, a second data portion associated with an environment state associated with the at least one user, and a third data portion associated with at least one interaction of the at least one user in relation to at least one of the plurality of reality layer of the artificial environment.

Further, in an embodiment, the analyzing of at least one of the plurality of data portions using at least one of the plurality of data processing modules may include analyzing the first data portion using a first data processing module of the plurality of data processing modules. Further, the analyzing of at least one of the plurality of data portions using at least one of the plurality of data processing modules may include analyzing the second data portion using a second data processing module of the plurality of data processing modules. Further, the analyzing of at least one of the plurality of data portions using at least one of the plurality of data processing modules may include analyzing the third data portion using a third data processing module of the plurality of data processing modules.

Further, in an embodiment, the processing device 1404 may be configured for generating at least one user data associated with the at least one user based on at least one of the analyzing of the first data portion and the analyzing of the third data portion. Further, the processing device 1404 may be configured for analyzing the at least one user data using at least one of at least one additional data processing module and at least one machine learning model based on the generating of the at least one user data. Further, the at least one additional data processing module may include at least one of a collaborative filtering algorithm and a clustering algorithm. Further, the determining of the at least one context may be further based on the analyzing of the at least one user data.

Further, in an embodiment, the storage device 1406 may be further configured for retrieving a historical third data portion associated with at least one historical interaction of the at least one user in relation to at least one of the plurality of reality layers of the artificial environment. Further, the processing device 1404 may be further configured for analyzing the historical third data portion using at least one of the at least one additional data processing module and the at least one machine learning model. Further, the determining of the at least one context may be further based on the analyzing of the historical third data portion.

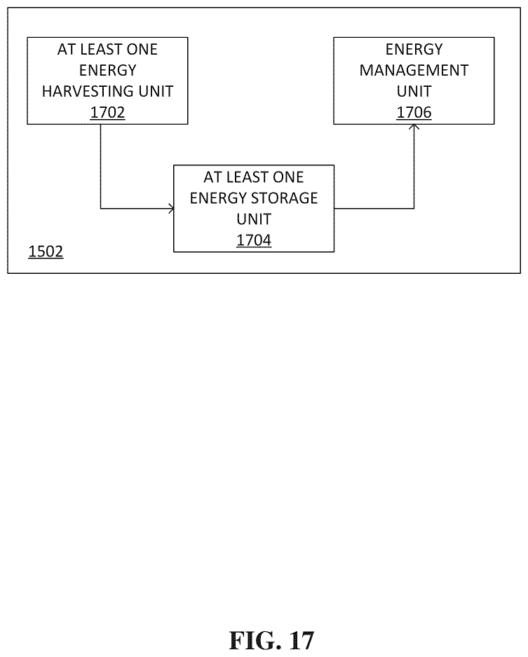

Further, in some embodiments, the at least one device 1502 may include at least one energy harvesting unit 1702, at least one energy storage unit 1704, and an energy management unit 1706, as shown in FIG. 17. Further, the at least one energy harvesting unit 1702 may be configured for generating electrical energy by harvesting at least one energy. Further, the at least one energy storage unit 1704 may be electrically coupled with the at least one energy harvesting unit 1702. Further, the at least one energy storage unit 1704 may be configured for storing at least one amount of the electrical energy based on the generating of the electrical energy. Further, the energy management unit 1706 may be electrically coupled with the at least one energy storage unit 1704. Further, the energy management unit 1706 may be configured for supplying at least one portion of the at least one amount of the electrical energy for at least one operation based on at least one energy allocation associated with the at least one operation.

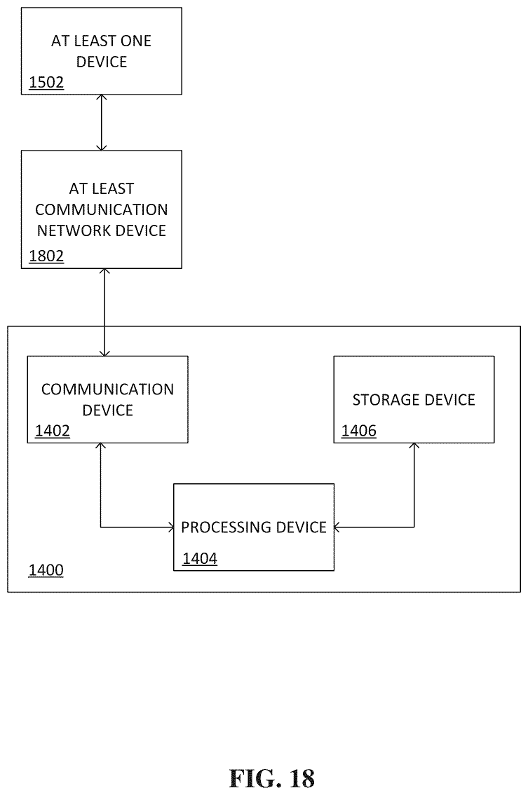

Further, in some embodiments, the receiving of the at least one data from the at least one device 1502 may include receiving the at least one data using at least one communication method through at least one communication network device 1802, as shown in FIG. 18, comprised in at least one communication network from the at least one device 1502.

Further, in an embodiment, the processing device 1404 may be further configured for selecting the at least one communication network from a plurality of communication networks based on at least one constraint. Further, the receiving of the at least one data using the at least one communication method through the at least one communication network device 1802 comprised in the at least one communication network may be based on the selecting of the at least one communication network.

FIG. 15 is a block diagram of the system 1400, in accordance with some embodiments.

FIG. 16 is a block diagram of the at least one device 1502, in accordance with some embodiments.

FIG. 17 is a block diagram of the at least one device 1502, in accordance with some embodiments.

FIG. 18 is a block diagram of the system 1400, in accordance with some embodiments.

Although the present disclosure has been explained in relation to its preferred embodiment, it is to be understood that many other possible modifications and variations can be made without departing from the spirit and scope of the disclosure.

What is claimed is:

1. A method for facilitating tailoring experiences of users, the method comprising:
receiving, using a communication device, at least one data from at least one device;
analyzing, using a processing device, the at least one data;
determining, using the processing device, at least one context associated with at least one user based on the analyzing of the at least one data;
adjusting, using the processing device, at least one of a plurality of reality layers of an artificial environment based on the at least one context;
provisioning, using the processing device, at least one content corresponding to at least one of the plurality of reality layers of the artificial environment based on the adjusting; and
storing, using a storage device, the at least one data and the at least one context.

2. The method of claim 1, wherein the at least one device comprises a plurality of devices, wherein a first device of the plurality of devices comprises at least one first sensor, wherein the at least one first sensor is configured for generating at least one first sensor data by detecting at least one activity of the at least one user, wherein a second device of the plurality of devices comprises at least one second sensor, wherein the at least one second sensor is configured for generating at least one second sensor data by detecting at least one environment characteristic associated with a real environment of the at least one user, wherein the at least one data comprises the at least one first sensor data and the at least one second sensor data.

3. The method of claim 1 further comprising:
generating, using the processing device, at least one processed data based on the analyzing of the at least one data, wherein the at least one processed data comprises a plurality of data portions;
analyzing, using the processing device, at least one of the plurality of data portions using at least one of a plurality of data processing modules;
generating, using the processing device, at least one insight associated with the at least one user using at least one of the plurality of data processing modules based on the analyzing of at least one of the plurality of data portions, wherein the determining of the at least one context is further based on the at least one insight; and
storing, using the storage device, each of the plurality of data portions and the at least one insight.

4. The method of claim 3, wherein the plurality of data portions comprises a first data portion associated with at least one behavioral state of the at least one user, a second data portion associated with an environment state associated with the at least one user, and a third data portion associated with at least one interaction of the at least one user in relation to at least one of the plurality of reality layer of the artificial environment.

5. The method of claim 4, wherein the analyzing of at least one of the plurality of data portions using at least one of the plurality of data processing modules comprises:
analyzing the first data portion using a first data processing module of the plurality of data processing modules;
analyzing the second data portion using a second data processing module of the plurality of data processing modules; and
analyzing the third data portion using a third data processing module of the plurality of data processing modules.

6. The method of claim 5 further comprising:
generating, using the processing device, at least one user data associated with the at least one user based on at least one of the analyzing of the first data portion and the analyzing of the third data portion; and
analyzing, using the processing device, the at least one user data using at least one of at least one additional data processing module and at least one machine learning model based on the generating of the at least one user data, wherein the at least one additional data processing module comprises at least one of a collaborative filtering algorithm and a clustering algorithm, wherein the determining of the at least one context is further based on the analyzing of the at least one user data.

7. The method of claim 6 further comprising:
retrieving, using the storage device, a historical third data portion associated with at least one historical interaction of the at least one user in relation to at least one of the plurality of reality layers of the artificial environment; and
analyzing, using the processing device, the historical third data portion using at least one of the at least one additional data processing module and the at least one machine learning model, wherein the determining of the at least one context is further based on the analyzing of the historical third data portion.

8. The method of claim 1, wherein the at least one device comprises:
at least one energy harvesting unit configured for generating electrical energy by harvesting at least one energy;
at least one energy storage unit electrically coupled with the at least one energy harvesting unit, wherein the at least one energy storage unit is configured for storing at least one amount of the electrical energy based on the generating of the electrical energy; and
an energy management unit electrically coupled with the at least one energy storage unit, wherein the energy management unit is configured for supplying at least one portion of the at least one amount of the electrical energy for at least one operation based on at least one energy allocation associated with the at least one operation.

9. The method of claim 1, wherein the receiving of the at least one data from the at least one device comprises receiving the at least one data using at least one communication method through at least one communication network device comprised in at least one communication network from the at least one device.

10. The method of claim 9 further comprising selecting, using the processing device, the at least one communication network from a plurality of communication networks based on at least one constraint, wherein the receiving of the at least one data using the at least one communication method through the at least one communication network comprised in the at least one communication network is based on the selecting of the at least one communication network.

11. A system for facilitating tailoring experiences of users, the system comprising:
a communication device configured for receiving at least one data from at least one device;
a processing device communicatively coupled with the communication device,
wherein the processing device is configured for:
analyzing the at least one data;
determining at least one context associated with at least one user based on the analyzing of the at least one data;
adjusting at least one of a plurality of reality layers of an artificial environment based on the at least one context; and
provisioning at least one content corresponding to at least one of the plurality of reality layers of the artificial environment based on the adjusting; and
a storage device communicatively coupled with the processing device, wherein the storage device is configured for storing the at least one data and the at least one context.

12. The system of claim 11, wherein the at least one device comprises a plurality of devices, wherein a first device of the plurality of devices comprises at least one first sensor, wherein the at least one first sensor is configured for generating at least one first sensor data by detecting at least one activity of the at least one user, wherein a second device of the plurality of devices comprises at least one second sensor, wherein the at least one second sensor is configured for generating at least one second sensor data by detecting at least one environment characteristic associated with a real environment of the at least one user, wherein the at least one data comprises the at least one first sensor data and the at least one second sensor data.

13. The system of claim 11, wherein the processing device is further configured for:
generating at least one processed data based on the analyzing of the at least one data, wherein the at least one processed data comprises a plurality of data portions;
analyzing at least one of the plurality of data portions using at least one of a plurality of data processing modules; and
generating at least one insight associated with the at least one user using at least one of the plurality of data processing modules based on the analyzing of at least one of the plurality of data portions, wherein the determining of the at least one context is further based on the at least one insight, wherein the storage device is further configured for storing each of the plurality of data portions and the at least one insight.

14. The system of claim 13, wherein the plurality of data portions comprises a first data portion associated with at least one behavioral state of the at least one user, a second data portion associated with an environment state associated with the at least one user, and a third data portion associated with at least one interaction of the at least one user in relation to at least one of the plurality of reality layer of the artificial environment.

15. The system of claim 14, wherein the analyzing of at least one of the plurality of data portions using at least one of the plurality of data processing modules comprises:
analyzing the first data portion using a first data processing module of the plurality of data processing modules;
analyzing the second data portion using a second data processing module of the plurality of data processing modules; and
analyzing the third data portion using a third data processing module of the plurality of data processing modules.

16. The system of claim 15, wherein the processing device is further configured for:
generating at least one user data associated with the at least one user based on at least one of the analyzing of the first data portion and the analyzing of the third data portion; and
analyzing the at least one user data using at least one of at least one additional data processing module and at least one machine learning model based on the generating of the at least one user data, wherein the at least one additional data processing module comprises at least one of a collaborative filtering algorithm and a clustering algorithm, wherein the determining of the at least one context is further based on the analyzing of the at least one user data.

17. The system of claim 16, wherein the storage device is further configured for retrieving a historical third data portion associated with at least one historical interaction of the at least one user in relation to at least one of the plurality of reality layers of the artificial environment, wherein the processing device is further configured for analyzing the historical third data portion using at least one of the at least one additional data processing module and the at least one machine learning model, wherein the determining of the at least one context is further based on the analyzing of the historical third data portion.

18. The system of claim 11, wherein the at least one device comprises:
at least one energy harvesting unit configured for generating electrical energy by harvesting at least one energy;
at least one energy storage unit electrically coupled with the at least one energy harvesting unit, wherein the at least one energy storage unit is configured for storing at least one amount of the electrical energy based on the generating of the electrical energy; and
an energy management unit electrically coupled with the at least one energy storage unit, wherein the energy management unit is configured for supplying at least one portion of the at least one amount of the electrical energy for at least one operation based on at least one energy allocation associated with the at least one operation.

19. The system of claim 11, wherein the receiving of the at least one data from the at least one device comprises receiving the at least one data using at least one communication method through at least one communication network comprised in at least one communication network from the at least one device.

20. The system of claim 19, wherein the processing device is further configured for selecting the at least one communication network from a plurality of communication networks based on at least one constraint, wherein the receiving of the at least one data using the at least one communication method through the at least one communication network comprised in the at least one communication network is based on the selecting of the at least one communication network.
